(19) United States
(12) Patent Application Publication
(10) Pub. No.: US 2014/0327862 A1
(43) Pub. Date: Nov. 6, 2014

(54) FERROELECTRIC LIQUID CRYSTAL COMPOSITION AND FERROELECTRIC LIQUID CRYSTAL DISPLAY DEVICE

(71) Applicant: DIC CORPORATION, Tokyo (JP)

(72) Inventors: Kazuaki Hatsusaka, Kita-adachi-gun (JP); Toru Fujisawa, Kitaadachi-gun (JP); Kazunori Maruyama, Kita-adachi-gun (JP); Isa Nishiyama, Kitaadachi-gun (JP)

(73) Assignees: DIC CORPORATION, Tokyo (JP); DIC CORPORATION, Tokyo (JP)

(21) Appl. No.: 14/358,251

(22) PCT Filed: Nov. 14, 2012
(86) PCT No.: PCT/JP2012/079506

§ 371 Date: Jul. 7, 2014

(30) Foreign Application Priority Data
Nov. 15, 2011 (JP) 2011-249742
Feb. 6, 2012 (JP) 2012-022977

(51) Int. Cl. G02F 1/135; C09K 19/02; C09K 19/34; G02F 1/1335

(52) U.S. Cl. CPC G02F 1/1354; G02F 1/133528; C09K 19/0225; C09K 19/3458; C09K 19/3444; G02F 2001/1355
USPC 349/100; 252/299.01; 252/299.61

(57) ABSTRACT

The present invention relates to a ferroelectric liquid crystal composition and a ferroelectric liquid crystal display element.

The present invention provides a ferroelectric liquid crystal composition and a ferroelectric liquid crystal display element using this ferroelectric liquid crystal. The ferroelectric liquid crystal composition of the present invention contains at least one liquid crystal compound and has a chiral smectic C phase, and when the ferroelectric liquid crystal composition is sandwiched between substrates, a layer normal direction of the chiral smectic C phase is 80° to 90° with respect to the substrate surface.

According to the ferroelectric liquid crystal composition and the ferroelectric liquid crystal display element of the present invention, since an alignment restoring ability is excellent, the present invention is useful for application in which a pressing force is repeatedly applied.

### TECHNICAL FIELD

The present invention relates to a ferroelectric liquid crystal, composition useful for a ferroelectric liquid crystal display element and to a ferroelectric liquid crystal display element.

### BACKGROUND ART

Since being superior to a general nematic liquid crystal in terms of quick response performance, a ferroelectric liquid crystal (FLC) has been actively studied after a surface-stabilized FLC (SSFLC) was proposed by Clark and Lagerwall.

Although the ferroelectric liquid crystal is a liquid crystal which has spontaneous polarization and which shows ferroelectric properties, it has been known that a liquid crystal having a permanent dipole moment in a direction perpendicular to a molecular long axis direction forms a chiral smectic C (hereinafter abbreviated as “SmC*”) phase, even if being averaged in total, the permanent dipole moments cannot be counteracted to each other, and the spontaneous polarization is generated, so that the ferroelectric properties are shown. Hence, as the ferroelectric liquid crystal, a liquid crystal having a SmC* phase has been frequently used. In addition, instead of imparting optical active group (chirality) to a smectic liquid crystal molecule, the SmC* phase may also be obtained by addition of an optically active compound, and an optical active compound having no liquid crystal properties (no liquid crystal compound) may also be used. In this case, a host liquid crystal showing a smectic C (hereinafter abbreviated as “SmC”) phase, which is not a chiral compound, is generally used.

In the SmC* phase, among smectic phases each having a layered structure, an alignment direction of a liquid crystal molecule has a predetermined tilt with respect to the layer normal. In addition, an angle (azimuth angle) inclined with respect to the layer plane is slightly shifted by each layer, and hence the molecular alignment generates a helical structure.

In SSFLC, a liquid crystal is aligned (homogeneous alignment) using a substrate processed by a parallel alignment treatment so that the layer normal is parallel to a substrate surface of a cell, and the thickness of a liquid crystal layer is decreased, so that the helical structure is released, and the possible range of the azimuth angle is restricted to two ways. Accordingly, the bistability is obtained by a surface stabilized alignment, so that a black-white binary display having a memory characteristic can be obtained. However, in the case of a liquid crystal TV, a high-quality full-color display is difficult to realize because of the bistability, and also in a production process, when a liquid crystal heated to a high temperature is sandwiched between substrates and is then cooled into a SmC* phase, the interlayer distance is reduced since the tilt is generated, and hence a chevron structure in which a layer plane is bent to form an approximately V shape appears, so that a zigzag defect is liable to occur (see Non-Patent Literature 1). In addition, since having an inferior pressure resistance, the SSFLC has a very serious problem in that when a display element is pressed by a finger, a layer structure is destroyed and is not self-restored.

In order to overcome the problem that the full-color display cannot be realized by the bistability, a distorted helix (or deformed helix) ferroelectric liquid crystal (DHFLC) which does not restrict the possible range of the azimuth angle has also been known (see Non-Patent Literature 2). In this method, the helical pitch of FLC is sufficiently decreased as compared to the thickness of the liquid crystal layer between substrates, and although a uniaxial birefringence having an axis in a helix axial direction is obtained by no voltage application, the birefringence is changed since the shift from the helical sequence of the liquid crystal alignment gradually occurs by voltage application, so that continuous gray scale display can be obtained. However, in the DHFLC disclosed in Non-Patent Literature 2, since the layer is perpendicular to the substrate surface, that is, since the layer normal direction is approximately parallel to the substrate surface, there has been a problem of viewing angle of the display element.

As a method to improve the viewing angle of a nematic liquid crystal display element, new display methods, such as an in-plane switching (IPS) method and a vertically alignment (VA) method in which a vertically alignment treatment is performed on a substrate so as to enable liquid crystal molecules to be aligned approximately perpendicular to the substrate surface (homeotropic alignment), have been practically used. The vertically alignment method is a method to improve the viewing angle in which although an electric field in a direction perpendicular to the substrate is used, the vertical alignment of liquid crystal molecules is used. In addition, IPS is a method to improve the viewing angle by switching horizontally aligned liquid crystal molecules using a lateral electric field in a direction parallel to the substrate.

As examples in which those methods are applied to DHFLC, Non-Patent Literatures 3 and 4 have reported a liquid crystal display element in which an in-plane electrode formed of a pair of comb electrodes is disposed on a lower-side substrate, and a lateral electric field is applied to DHFLC in which liquid crystal molecules are approximately vertically aligned by using an vertically alignment layer.

In addition, in Non-Patent Literature 5, an optical modulator has been reported in which while a lateral electric field is applied to DHFLC in which liquid crystal molecules are approximately vertically aligned, light incidence of laser light for readout is performed from various directions. However, in a smectic C liquid crystal and a chiral smectic C liquid crystal, since liquid crystal molecules are characterized to form a layer structure while being tilt-aligned, even if the vertically alignment layer is used, the liquid crystal molecules are not aligned perpendicular to the substrate surface, and although a matter to be aligned perpendicular to the substrate surface should be the layer normal, the control of the layer normal of the smectic liquid crystal has not been studied at all.

### CITATION LIST

### Non-Patent Literature

[Non-Patent Literature 1] Chenhui Wang and Philip J. Bos, “5.4: A Defect Free Bistable C1 SSFLC Display”, SID 02 Digest, 2002, p. 34 to 36

[Non-Patent Literature 2]J Funfschilling and M. Schadt, “Fast responding and highly multiplexible distorted helix ferroelectric liquid-crystal displays”. J. Appl. Phys., October 1989, vol. 66, No. 8, p. 3877 to 3882

[Non-Patent Literature 3] Ju Hyun Lee, Doo Hwan You, Jae Hong Park, Sin Doo Lee, and Chang Jae Yu, “Wide-Viewing Display Configuration of Helix-Deformed Ferroelectric Liquid Crystals”, Journal of Information display, December 2000, vol. 1, No. 1, p. 20 to 24

[Non-Patent Literature 4] John W. McMurdy, James N. Eakin, and Gregory P. Crawford, “P-127: Vertically Aligned Deformed Helix Ferroelectric Liquid Crystal Configuration for Reflective Display Device”, SID 06 Digest, 2006, p. 677 to 680

[Non-Patent Literature 5]A. Parfenov, “Deformation of ferroelectric short-pitch helical liquid crystal by transverse electric field: Application for diffraction-based light modulator”, Applied Physics Letters, December 1998, vol. 73, No. 24, p. 3489 to 3491

### SUMMARY OF INVENTION

### Technical Problem

In recent years, application of touch panel type display elements has been increasingly expanded, and in the case in which a touch panel electrode (switch) is incorporated in a liquid crystal display element, even if a pressing force is repeatedly applied to a liquid crystal layer, an excellent alignment restoring ability has been desired. In addition, in optical elements, such as an optical path switching element, a wavelength conversion element, and an energy conversion element, in order to improve the reliability, an excellent pressure resistance has also been desired.

The present invention has an object to provide a ferroelectric liquid crystal composition having an excellent alignment restoring ability and a ferroelectric liquid crystal display element.

### Solution to Problem

After intensive research on physical properties of various ferroelectric liquid crystal compositions was carried out by the inventors of the present application to overcome the above problems, it was found that when the layer normal direction of a Sm*C phase is controlled, even if a pressing force is applied to a substrate, and the interlayer distance of the smectic phase is partially or entirely contracted thereby, the helical structure of the Sm*C phase can be maintained by the restoring ability thereof as long as the layer structure is maintained, and hence, the present invention was made. The present invention provides, in a ferroelectric liquid crystal composition which has a chiral smectic C phase and which contains at least one type of liquid crystal compound, a ferroelectric liquid crystal composition characterized in that when the ferroelectric liquid crystal composition is sandwiched between substrates, a layer normal direction of the chiral smectic C phase with respect to the substrate surface is 80° to 90°. In addition, the present invention also provides a ferroelectric liquid crystal display element using the ferroelectric liquid crystal composition described above.

### Advantageous Effects of Invention

Since having an excellent alignment restoring ability, the ferroelectric liquid crystal composition and the ferroelectric liquid crystal display element of the present invention may also be effectively used for application in which a pressing force is repeatedly applied.

### DESCRIPTION OF EMBODIMENTS

### <Ferroelectric Liquid Crystal Composition>

A ferroelectric liquid crystal composition of the present invention can be obtained in such a way that when a liquid crystal compound, a chiral compound, and the like, which will be described later, are blended together and sandwiched between substrates, preparation is performed so that a layer normal direction of a chiral smectic C phase is inclined by 80° to 90° with respect to the substrate surface. In the present invention, the layer normal is defined as the normal line to a smectic layer (layer) formed of a ferroelectric liquid crystal composition. Although it has been known that the layer of liquid crystal is swayed by thermal motion, in this embodiment, when a ferroelectric liquid crystal bulk in a display element is averagely observed by x-ray and/or retardation measurement, the layer normal may be perpendicular to the substrate.

In the ferroelectric liquid crystal of the present invention sandwiched between substrates, when the layer normal direction of the Sm*C phase is 80° to 90° with respect to the substrate surface, even if the interlayer distance of the Sm*C phase or the distance between the substrates is partially or entirely contracted by a pressing force applied thereto, the restoring ability can be maintained without destroying the layer structure. That is, in a liquid crystal optical element using the ferroelectric liquid crystal composition of the present invention, when a pressing force is applied to the substrate, since the direction of the force is approximately perpendicular to the layer normal, it is believed that the helical pitch is decreased while the layer structure is maintained. When the pressure is released, since the ferroelectric liquid crystal composition of the present invention has an inherent helical structure which is determined by the type and addition amount of a chiral compound and the temperature, the same state as the state before the pressure application in which the layer distance is determined in association with the helical pitch is restored. In addition, in either case of pressure application or pressure release, since the direction of the force is perpendicular to the layer normal, the force is applied in a direction in which defects, such as dislocations and disinclinations, of liquid crystal are not generated, so that the layer structure is not distorted thereby.

On the other hand, when the layer normal direction is inclined with respect to the substrate surface, since molecules present between the layers are overlapped with each other, and the volume thereof is decreased, the layer structure is destroyed, and the helical structure cannot be maintained while the layer structure is maintained. Hence, some ferroelectric liquid crystal composition may have no alignment restoring ability generated by a restoring ability of the helical pitch distance.

In the present invention, although being 80° to 90°, the layer normal direction with respect to the substrate surface is preferably 85° to 90° and more preferably 88° to 90°.

In order to enable the helical structure of the ferroelectric liquid crystal composition not to be released in the cell, the helical pitch of the chiral smectic C phase sandwiched between the substrates is preferably equal to or less than the cell gap. As selective reflection which is determined in association with the helical pitch used for the display element, a wavelength of 500 nm or less is preferable. In addition, depending on the application, the selective reflection may be at 760 nm to 5 μm. Furthermore, the selective reflection is preferably at a wavelength which cannot be recognized by human eyes. From this point of view, a selective wavelength of 360 to 400 nm is preferably for a short pitch, and a selective reflection at 760 to 830 nm is preferable for a long pitch. When the ferroelectric liquid crystal composition is used for an optical element, the selective reflection preferably corresponds to a signal wavelength and is not limited to the above wavelengths.

In a process for manufacturing a liquid crystal display element, in order to charge a liquid crystal between substrates without generating any alignment defects, a phase transition from a nematic phase to a smectic phase is preferably performed by slow cooling. For this purpose, a phase sequence of isotropic liquid-chiral nematic phase-smectic A phase-chiral smectic C phase (ISO-N*-SmA-SmC*) or a phase sequence of isotropic liquid-chiral nematic phase-chiral smectic C phase (ISO-N*-SmC*) is preferably expressed. In this case, another phase, such as a blue phase (BP), at a higher temperature side than that of a nematic phase may also be expressed, and for example, a phase sequence of isotropic liquid-blue phase-chiral nematic phase-smectic A phase-chiral smectic C phase, or a phase sequence of isotropic liquid-blue phase-chiral nematic phase-chiral smectic C phase may be mentioned. In addition, a liquid crystal which expresses a phase sequence of isotropic liquid-chiral smectic C phase (ISO-SmC*) may also be used.

In order to increase the tilt angle of a liquid crystal compound, a smectic A phase is preferably absent in the phase sequence, and as a concrete example, INC (ISO-N*-SmC*) or IC (ISO-SmC*) may be mentioned.

In order to obtain a preferable alignment, the pitch of a chiral nematic phase or a chiral smectic C phase may be increased as long as possible. For this purpose, as a pitch canceller which is an additive to cancel the pitch, at least two types of chiral compounds having different chiralities are preferably used in combination so as to increase the pitch by canceling the pitch. In this case, it is preferable to select compounds having the same sign of spontaneous polarization so as not to cancel the spontaneous polarizations therebetween, or even if the signs of spontaneous polarizations are opposite to each other, it is also preferable to use a compound having a large spontaneous polarization value and a compound having a small spontaneous polarization value in combination to obtain a sufficient difference in spontaneous polarization therebetween. In addition, in accordance with desired selective wavelength and intensity of the spontaneous polarization, at least two chiral compounds are preferably appropriately used in combination in consideration of the direction of the helix of a chiral nematic phase or a chiral smectic C phase and the direction of the spontaneous polarization. In addition, it is also preferable to select a chiral compound so as to obtain a sufficiently excellent alignment without performing pitch cancellation as described above. In addition, an additive which suppresses the change in pitch caused by temperature is also preferably added.

The ferroelectric liquid crystal composition of the present invention is a ferroelectric liquid crystal composition which contains at least one type of liquid crystal compound and which has a Sm*C phase and is preferably used to be sandwiched between substrates of an optical element such as a ferroelectric liquid crystal display element. The optical element may be either a display element or a non-display element, and in the case of a display optical element, for example, this ferroelectric liquid crystal composition may be used for a liquid crystal television, a liquid crystal monitor, a tablet PC monitor, a mobile phone monitor, a measuring instrument monitor, a monitor for an entertainment good, such as pachinko, a ticket vending machine monitor, an automatic vending machine monitor, a monitor for a home appliance, such as a remote controller, a water heater, a rice cooker, or an air conditioner, a digital signage, point of purchasing advertising (POP), an electronic time table, an electronic display board, an electronic price tag, an electronic black board, an electronic notebook, an electronic textbook, an electronic book, or an electronic medical card. In addition, in the case of a non-display optical element, for example, this ferroelectric liquid crystal composition may be used for a light path switching element, a wavelength conversion element, an energy conversion element, or an UV, an IR, a near IR, a far IR, a visible light, or an electron beam wavelength conversion element, or may also be used as an electronic material for a resister, a capacitor, a transistor, an electron/hole transport layer, or the like.

In the present invention, the ferroelectric liquid crystal composition is characterized in that even if a pressing force is applied to the substrate, the change in helical structure of the Sm* phase is small. Hence, although being able to be used for an optical element to which no external force is applied, the ferroelectric liquid crystal composition of the present invention is preferably used for a display optical element, such as a touch panel, which is configured so that an external force is applied thereto.

The ferroelectric liquid crystal composition used in the present invention may contain a chiral compound (dopant) in a host liquid crystal (host liquid crystal), and furthermore, a monomer (polymerizable compound) which realizes a polymer stabilization may be arbitrarily added.

In order to fix the state in which the liquid crystal is aligned by an alignment layer or the like without causing any alignment defects, the phase transition is preferably performed at least from a nematic phase to a smectic phase by slow cooling, and the substrate surface of a liquid crystal cell to be used is more preferably flat. In addition, in the case in which a monomer is added, the monomer is required to be polymerized while being placed in a network or a dispersed state in a liquid crystal phase, such as a nematic phase or a smectic phase. Furthermore, in order to avoid the formation of a phase separation structure, the content of the monomer is preferably decreased, and in order to form a polymer between liquid crystal molecules while the liquid crystal is aligned, the content and composition of a precursor of the polymer is preferably adjusted. In addition, in the case of photopolymerization, an UV exposure time, an UV exposure intensity, and the temperature are preferably adjusted so as to form a net-shaped polymer without generating liquid crystal alignment defects. By the use of the ferroelectric liquid crystal composition as described above, an optical element having high reliability against a pressing force can be obtained, and in particular, in the case of a display element, a liquid crystal display element which has a low drive voltage, which can perform a halftone display, which has a high reliability against a pressing force, and which also has a high contrast can be obtained.

### <Liquid Crystal Compound>

As a liquid crystal compound used as the host, a liquid crystal compound represented by the following general formula is preferable.

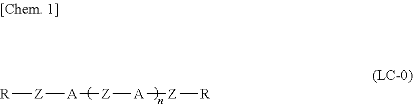

(In the formula, R each independently represent a linear or a branched alkyl group having 1 to 18 carbon atoms, a hydrogen atom, or a fluorine atom, at least one —CH₂— group of the alkyl group may be substituted by —O—, —S—, —CO—, —CO—O—, —O—CO—, —CO—S—, —S—CO—, —O—SO₂—, —SO—O—, —O—CO—, CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN group;

Z each independently represent —O—, —S—, —CO—, —CO—O—, —O—CO—, —O—CO—O—, —CO—N(R^{a})—, —N(R^{a})—CO—, —OCH₂—, —CH₂O—, SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, CH═CF—, —CF═CF—, —C≡C—, —CH═CH—CO—O—, —O—CO—CH═CH—, or a single bond, and R^{a} of —CO—N(R^{a})— or —N(R^{a})—CO— represents a hydrogen atom or a linear or a branched alkyl group having 1 to 4 carbon atoms; and

A each independently represent a cyclic group selected from a phenylene group, a cyclohexylene group, a dioxolanediyl group, a cyclohexenylene group, a bicyclo[2,2,2]octylene group, a piperidinediyl group, a naphthalenediyl group, a decahydronaphthalenediyl group, a tetrahydronaphthalenediyl group, or an indanediyl group, at least one —CH═ group in the ring of the above phenylene group, naphthalenediyl group, tetrahydronaphthalenediyl group, or indanediyl group may be substituted by a nitrogen atom, one —CH═ group or at least two —CH₂— groups which are not adjacent to each other in the ring of the above cyclohexylene group, dioxolanediyl group, cyclohexenylene group, bicyclo[2,2,2,2]octylene group, piperidinediyl group, decahydronaphthalenediyl group, tetrahydronaphthalenediyl group, or indanediyl group may be substituted by —O— and/or —S—, at least one hydrogen atom of the above cyclic group may be substituted by a fluorine atom, a chlorine atom, a bromine atom, a CN group, or a NO₂ group or by an alkyl group having 1 to 7 carbon atoms, an alkoxy group, an alkyl carbonyl group, or an alkoxy carbonyl group, at least one hydrogen atom of each of which may be substituted by a fluorine atom or a chlorine atom, and

n represents 1, 2, 3, 4, or 5.)

In addition, liquid crystal compounds (LC-I) to (LC-III) represented by the following general formulas are preferable.

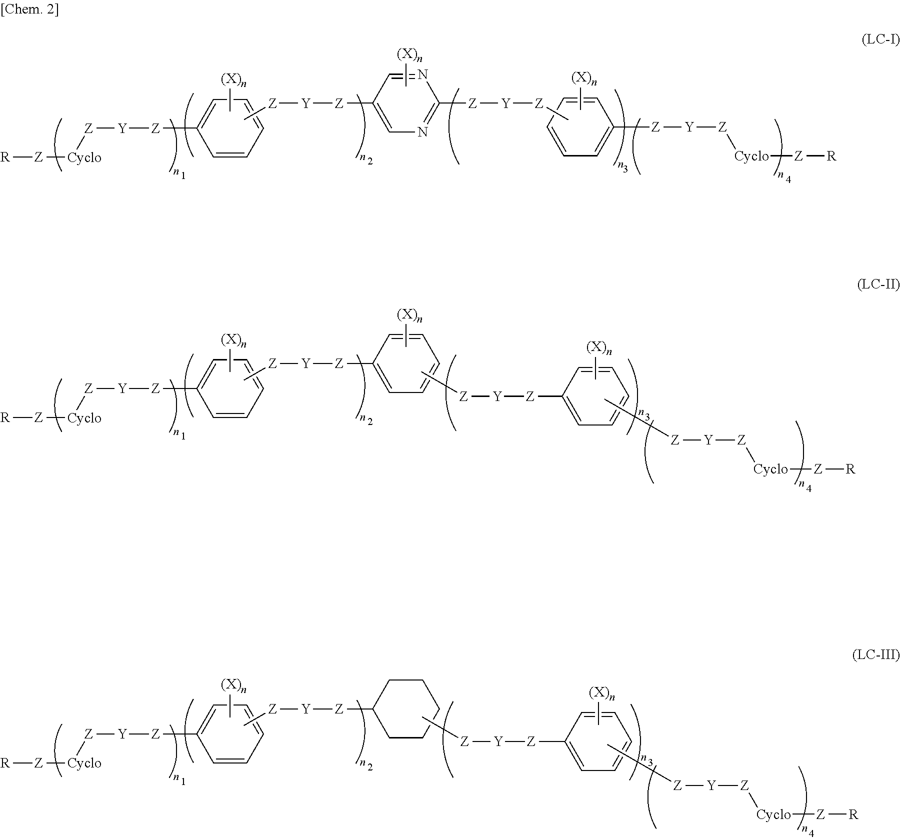

(In the formulas, R each independently represent a linear or a branched alkyl group having 1 to 18 carbon atoms, a hydrogen atom, or a fluorine atom, at least one —CH₂— group of the alkyl group may be substituted by —O—, —S—, —CO—, —CO—O—, —O—CO—, —CO—S—, —S—CO—, —O—SO₂—, —SO₂—O—, —O—CO—O—, CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN group;

Z each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH—CF₂—, —CF₂CF₂—, —CH═CH—, —CF═CH—, —CH═CF—, —CF═CF—, —C≡C—, —CH═CH—CO—O—, —O—CO—CH═CH—, or a single bond, and R^{a} of —CO—N(R^{a})— or —N(R^{a})—CO— represents a hydrogen atom or a linear or a branched alkyl group having 1 to 4 carbon atoms;

Y each independently represent a single bond or a linear or a branched alkylene group having 1 to 10 carbon atoms, at least one methylene group present in the alkylene group each may be independently substituted by —O—, —CO—, —COO— or —OCO— so that oxygen atoms are not directly bonded to each other, and at least one hydrogen atom present in the alkylene group each may be independently substituted by a halogen atom or an alkyl group having 1 to 9 carbon atoms;

X each independently represent a halogen atom, a cyano group, a methyl group, a methoxy group, —CF—, or —OCF₃;

n each independently represent an integer of 0 to 4;

although n₁, n₂, n₃, and n₄ each independently represent 0 or 1, n₁+n₂+n₃+n₄=1 to 4 holds; and

Cyclo each independently represent a cylcoalkane having 3 to 10 carbon atoms and may arbitrarily include a double bond.)

In this case, Cyclo preferably represents cyclohexane (cyclohexylene group), and for example, liquid crystal compounds (LC-I′) to (LC-III′) represented by the following general formulas are preferable.

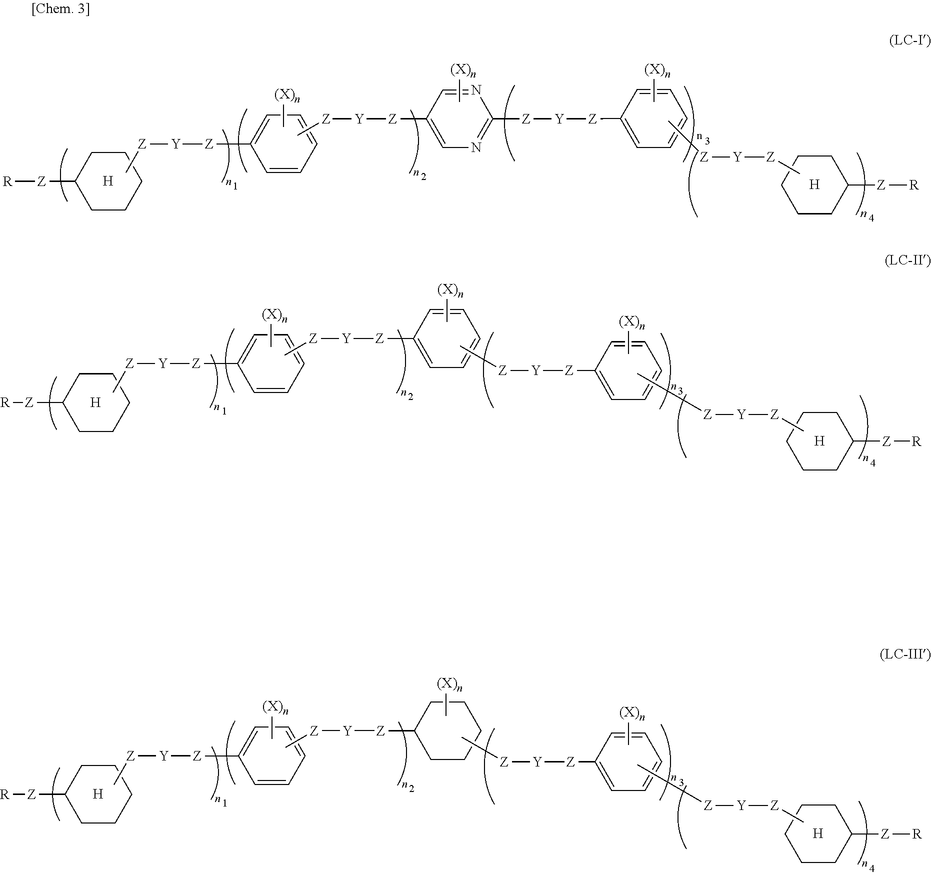

(In the formulas, R each independently represent a linear or a branched alkyl group having 1 to 18 carbon atoms, a hydrogen atom, or a fluorine atom, at least one —CH₂— group of the alkyl group may be substituted by —O—, —S—, —CO—, —CO—O—, —O—CO—, —CO—S—, —S—CO—, —O—SO₂—, —SO₂—O—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN group;

Z each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, and R^{a} of —CO—N(R^{a})— or —N(R^{a})—CO— represents a hydrogen atom or a linear or a branched alkyl group having 1 to 4 carbon atoms;

Y each independently represent a single bond or a linear or a branched alkylene group having 1 to 10 carbon atoms, at least one methylene group present in the alkylene group each may be independently substituted by —O—, —CO—, —COO— or —OCO— so that oxygen atoms are not directly bonded to each other, and at least one hydrogen atom present in the alkylene group each may be independently substituted by a halogen atom or an alkyl group having 1 to 9 carbon atoms;

X each independently represent a fluorine atom, a chlorine atom, a bromine atom, a cyano group, a methyl group, a methoxy group, a —CF₃ group, or a —OCF₃ group;

n each independently represent an integer of 0 to 4; and

although n₁, n₂, n₃, and n₄ each independently represent 0 or 1, n₁+n₂+n₃+n=1 to 4 holds.)

In order to express liquid crystal properties, 1,4-substituted ring is preferable. That is, as a cyclic divalent group included in the liquid crystal compound, for example, a 1,4-cyclohexylene group, a 1,4-phenylene group, or a 2,5-pyrimidinediyl group is preferable.

For example, liquid crystal compounds (LC-Ia) to (LC-IIIa) represented by the following general formulas are preferable.

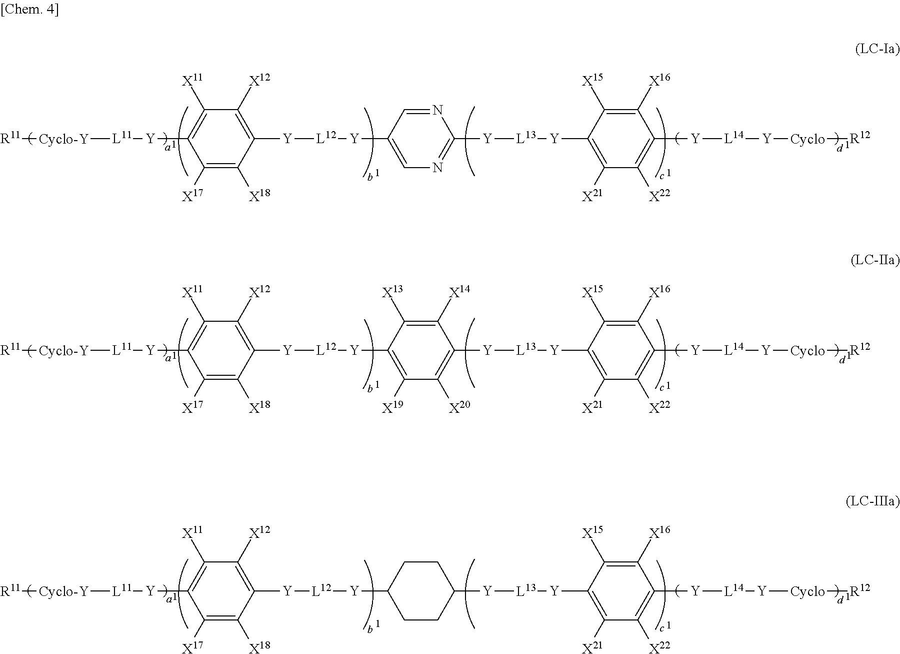

(In the formulas, although R¹¹ and R¹² each independently represent a linear or a branched alkyl group having 1 to 18 carbon atoms or a fluorine atom, R¹¹ and R¹² do not simultaneously represent a fluorine atom, at least one —CH₂— group of the alkyl group may be substituted by —O—, —S—, —CO—, —CO—O—, —O—CO—, —CO—S—, —S—CO—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom or a CN group;

X¹¹ to X²² each independently represent a hydrogen atom, a fluorine atom, a CF₃ group, or an OCF₃ group;

L¹¹ to L¹⁴ each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—;

Y each independently represent a single bond or a linear or a branched alkylene group having 1 to 10 carbon atoms, at least one methylene group present in the alkylene group each may be independently substituted by —O—, —CO—, —COO— or —OCO— so that oxygen atoms are not directly bonded to each other, and at least one hydrogen atom present in the alkylene group each may be independently substituted by a halogen atom or an alkyl group having 1 to 9 carbon atoms; although a¹, b¹, c¹, and d¹ each independently represent an integer of 0 or 1, a¹+b¹+c¹+d¹ represents 1, 2, or 3, when ax represents 0, d¹ represents 0, when a¹ represents 1, c¹ represents 0, when c¹ represents 1, a¹ represents 0, and when b¹=c¹=1 holds, a¹=d¹=0 holds; and

Cyclo each independently represent a cylcoalkane having 3 to 10 carbon atoms and may arbitrarily include a double bond.)

In addition, liquid crystal compounds (LC-IV) and (LC-V) represented by the following general formulas are preferable.

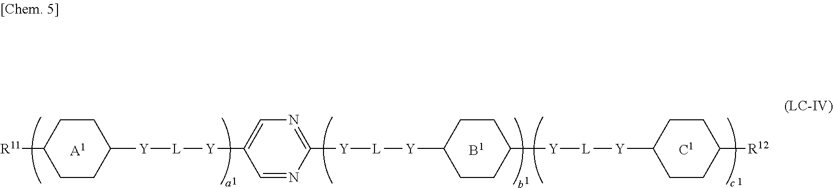

(In the formula, although R¹¹ and R¹² each independently represent a linear or a branched alkyl group having 1 to 1.8 carbon atoms or a fluorine atom, R¹¹ and R¹² do not simultaneously represent a fluorine atom, at least one —CH₂— group of the alkyl group may be substituted by —O—, —S—, —CO—, —CO—O—, —O—CO—, —CO—S—, —S—CO—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom or a CN group;

the ring A¹ represents a 1,4-phenylene group or a 1,4-cyclohexylene group, in each of which one to four hydrogen atoms may be substituted by a fluorine atom, a CF₃ group, an OCF₃ group, a CN group, or a plurality of the groups mentioned above;

the ring B¹ represents a 1,4-phenylene group in which one to four hydrogen atoms may be substituted by a fluorine atom, a CF, group, an OCF₃ group, a CN group, or a plurality of the groups mentioned above;

the ring C¹ represents a 1,4-cyclohexylene group in which one to four hydrogen atoms may be substituted by a fluorine atom, a CF₃ group, an OCF₃ group, a CN group, or a plurality of the groups mentioned above;

L each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CF—, or —C≡C—;

Y each independently represent a single bond or a linear or a branched alkylene group having 1 to 10 carbon atoms, at least one methylene group present in the alkylene group each may be independently substituted by —O—, —CO—, —COO— or —OCO— so that oxygen atoms are not directly bonded to each other, and at least one hydrogen atom present in the alkylene group each may be independently substituted by a halogen atom or an alkyl group having 1 to 9 carbon atoms; and

a¹ represents 0, 1, or 2, b¹ and c¹ each represent an integer of 0, 1, or 2, and the sum of a¹, b¹, and c¹ represents 1, 2, or 3.)

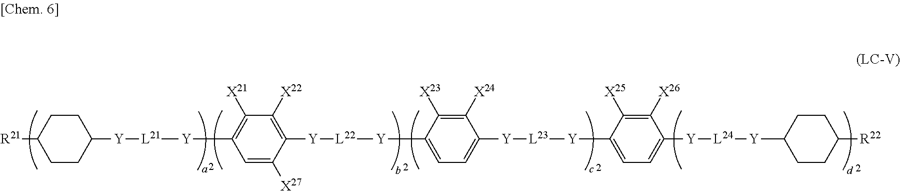

(In the formula, although R²¹ and R²² each independently represent a linear or a branched alkyl group having 1 to 18 carbon atoms or a fluorine atom, R²¹ and R²² do not simultaneously represent a fluorine atom, at least one —CH₂— group of the alkyl group may be substituted by —O—, —S—, CO—, —CO—O—, —O—CO—, —CO—S—, —S—CO—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom or a CN group;

X²¹ to X²⁷ each independently represent a hydrogen atom, a fluorine atom, a CF₃ group, or an OCF₃ group;

L²¹ to L²⁴ each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—, and the definition of Y is the same as that of the formula (LC-IV); and

although a², b², c², and d² each independently represent an integer of 0 or 1, a²+b²+c²+d² represents 1, 2, or 3, when a² represents 0, d² represents 0, when a² represents 1, c² represents 0, and when b²=c²=1 holds, a²=d²=0 holds.)

In a phenylpyrimidine compound, in order to obtain an inclined smectic phase necessary to express ferroelectric properties, to increase a molecular tilt angle, or to decrease the melting point, as a substituent on the ring of the molecule, at least one of a fluorine atom, a CF, group, and an OCF₃ group is preferably introduced. A fluorine atom having a small shape is preferably introduced as the substituent so as to stably maintain the liquid crystal phase and to retain the rapid response performance. The number of substituents is preferably 1 to 3.

In order to decrease the viscosity and to perform a rapid response, a linker (—Z—Y—Z— or —Y-L-Y—) connecting rings is preferably selected from a single bond, —CH₂O—, OCH₂—, —CF₂O—, —OCF₂—, —CH₂CH₂—, —CH═CH—, and —C≡CH— and in particular, a single bond is preferable. In order to suppress local polarization of the molecule and to reduce adverse influence on switching behavior, a single bond is also preferable. On the other hand, as a material to maintain the stability of the layer structure, a material having a higher viscosity is preferable, and in this case, one selected from —CO—O—, —O—CO—, —CO—S—, and —S—CO— is preferably used, and in particular, —CO—O— or —O—CO— is preferably used.

On the other hand, in order to enhance an effect of decreasing the melting point, a hydrogen atom, a methyl group, an ethyl group, a propyl group, a pentyl group, a hexyl group, a heptyl group, an octyl group, a nonyl group, an isopropyl group, an alkyl carbonyloxy group, an alkyloxy carbonyl group, or an alkyloxy carbonyloxy group is preferably used for at least one of the side chains (R, R¹¹, R¹², R²¹, and R²²).

As a compound which is suitable to increase Δn, which exhibits a stable ferroelectric liquid crystal phase, which has a low viscosity, and which is suitable for a rapid response, a liquid crystal compound (LC-VI) represented by the following general formula is preferable.

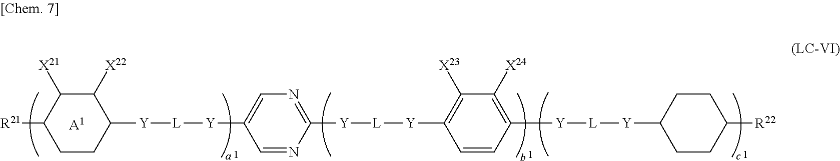

(In the formula, R²¹ and R²² each independently represent a linear or a branched alkyl group having 1 to 18 carbon atoms, a hydrogen atom, or a fluorine atom,
at least one —CH₂— group of the alkyl group may be substituted by —O—, —S—, —CO—, —CO—O—, —O—CO—, —CO—S—, —S—CO—, —O—SO₂—, —SO₂—O—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN group;

X¹⁴ to X²⁴ each independently represent a hydrogen atom, a halogen, a cyano group, a methyl group, a methoxy group, a CF₃ group, or an OCF₃ group;

the ring A¹ represents a phenylene group or a cyclohexylene group;

L each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—, and the definition of Y is the same as that of the formula (IL-IV); and

a¹ represents 0, 1, or 2, b¹ and c¹ each represent an integer of 0, 1, or 2, the sum of a¹+b¹+c¹ represents 1 or 2, when a¹=1 holds, c¹=0 holds, and when c¹=1 holds, a¹=0 holds.)

Y of the above general formulas (LC-I) to (LC-VI) each preferably independently represent a single bond or an alkylene group having 1 to 7 carbon atoms (at least one methylene group present in the alkylene group each may be independently substituted by —O—, —CO—, —COO—, or —OCO— so that oxygen atoms are not directly bonded to each other);

more preferably, each independently represent a single bond or an alkylene group having 1 to 5 carbon atoms (at least one methylene group present in the alkylene group each may be independently substituted by —O—, —CO—, —COO—, or —OCO— so that oxygen atoms are not directly bonded to each other); and

more preferably, each independently represent a single bond or an alkylene group having 1 to 3 carbon atoms (at least one methylene group present in the alkylene group each may be independently substituted by —O—, —CO—, —COO—, or —OCO— so that oxygen atoms are not directly bonded to each other).

As a compound which is suitable for TFT drive, which exhibits a stable ferroelectric liquid crystal phase, which has a low viscosity, and which is suitable for a rapid response, a liquid crystal compound (LC-VII) represented by the following general formula is particularly preferable.

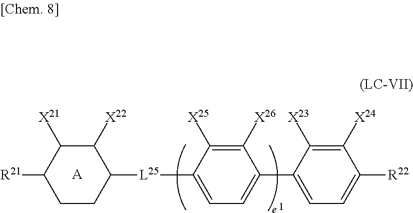

(In the formula, e¹ represents 0 or 1;

although X²¹ to X²⁶ each independently represent a hydrogen atom or a fluorine atom group, when e¹ represents 0, at least one of X²¹ to X²⁴ represents a fluorine atom, and when e¹ represents 1, at least one of X²¹ to X²⁶ represents a fluorine atom;

R²¹ and R²² each independently represent a linear or a branched alkyl group having 1 to 18 carbon atoms, and at least one —CH₂— group of the alkyl group may be substituted by —O—;

L²⁵ represents a single bond, —CH₂O—, or —OCH₂—; and

the ring A represents a phenylene group or a cyclohexylene group.)

For a liquid crystal compound used for the ferroelectric liquid crystal composition of the present invention, the above (LC-0), (LC-I) to (LC-III), (LC-IV), (LC-V), (LC-VI), (LC-VII), and the like may be used alone, or at least two thereof may be used in combination.

### <Chiral Compound>

The ferroelectric liquid crystal composition used for a liquid crystal device of the present invention may contain a chiral compound. As the chiral compound, any one of a compound having an asymmetric atom, a compound having axial asymmetry, and a compound having plane asymmetry may be used, the chiral compound may or may not have a polymerizable group, and at least one chiral compound may be used. In this embodiment, it is regarded that the compound having axial asymmetry includes an atropisomer.

As those chiral compounds, a compound having an asymmetric atom or a compound having axial asymmetry is preferable, and in particular, a compound having an asymmetric atom is preferable. In the compound having an asymmetric atom, when the asymmetric atom is an asymmetric carbon, it is preferable since the stereoinversion is unlikely to occur; however, a hetero atom may also function as the asymmetric atom in some cases. The asymmetric atom may be introduced in either a chain structure or a cyclic structure. When a strong helical twisting power is particularly required, a compound having axial asymmetry is preferable.

As the compound having an asymmetric atom, a compound having an asymmetric atom in its side chain portion, a compound having an asymmetric atom in its cyclic structure portion, and a compound having asymmetric atoms in the above two portions may be mentioned. In particular, a compound represented by the following general formula (Ch-1) may be mentioned.

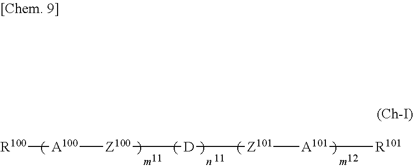

Although R¹⁰⁰ and R¹⁰¹ each independently represent a hydrogen atom, a cyano group, NO₂, a halogen, OCN, SCN, SF₅, a chiral or an achiral alkyl group having 1 to 30 carbon atoms, or a chiral group including a polymerizable group or a cyclic structure, one CH₂ group or at least two CH₂ groups which are not adjacent to each other of the alkyl group each may be independently substituted by —O—, —S—, —NH—, —N(CH₃)—, —CO—, —COO—, —OCO—, —OCO—O—, —S—CO—, —CO—S—, —CH═CH—, —CF₂—, —CF═CH—, —CH═CF—, —CF═CF—, or —C—, at least one hydrogen atom of the alkyl group each may be independently substituted by a halogen or a cyano group, and the alkyl group may have a linear, a branched, or a cyclic structure.

As the chiral alkyl group, the following formulas (Ra) to (Rk) are preferable.

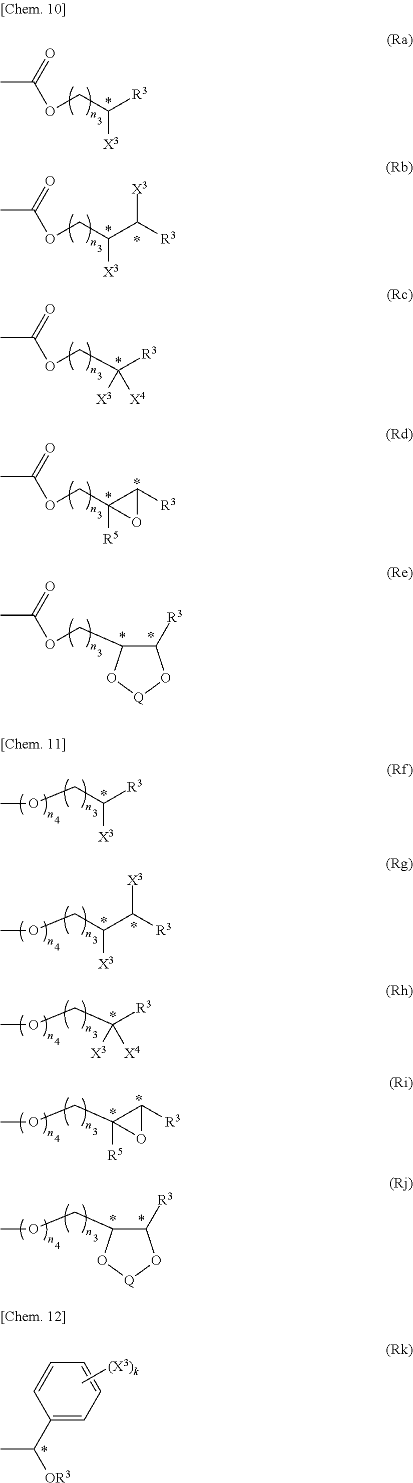

R³ and R⁵ each independently represent a linear or a branched alkyl group having 1 to 10 carbon atoms or a hydrogen atom, at least one —CH₂— group of the alkyl group may be substituted by —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropyl group, or —Si(CH)₂—, at least one hydrogen atom of the alkyl group may be substituted by a fluorine atom, a chlorine atom, a bromine atom, or a cyano group, and the alkyl group may have a polymerizable group.

As the polymerizable group, structures represented by the following formulas (R-1) to (R-15) are preferable.

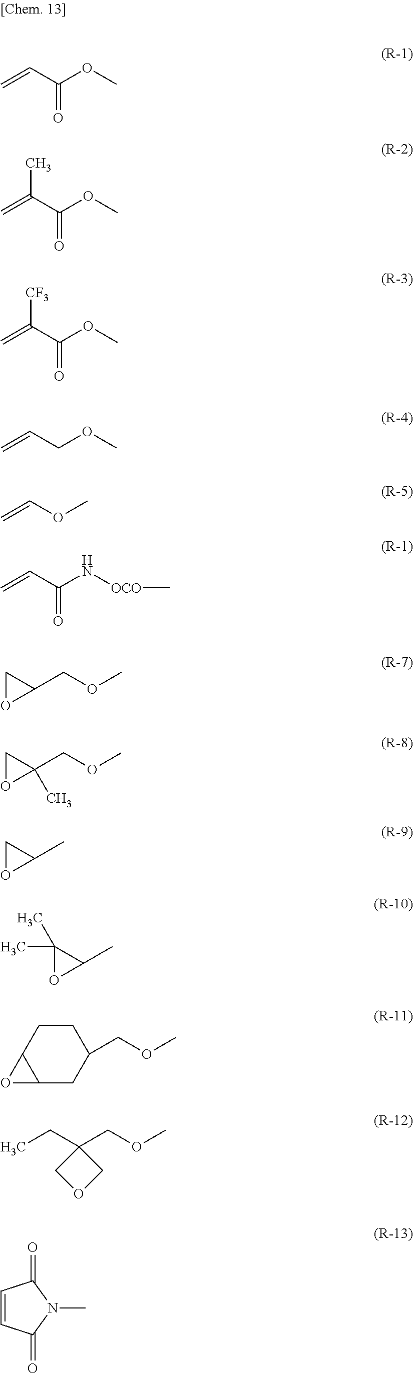

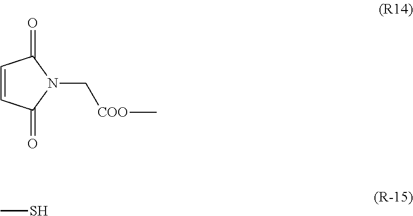

Those polymerizable groups are cured by radical polymerization, radical addition polymerization, cationic polymerization, and anionic polymerization. In particular, when UV polymerization is performed as a polymerization method, the formula (R-1), (R-2), (R-4), (R-5), (R-7), (R-11), (R-13), or (R-15) is preferable, the formula (R-1), (R-2), (R-7), (R-1), or (R-13) is more preferable, and the formulas (R-1) and (R-2) are more preferable. In the chiral group including a cyclic structure, either an aromatic cyclic structure or an aliphatic cyclic structure may be used. As a cyclic structure that the alkyl group is able to form, a single cyclic structure, a condensed cyclic structure, or a spiro cyclic structure may be mentioned, and at least one hetero atom may be included therein.

In addition, X³ and X⁴ each preferably represent a halogen atom (F, Cl, Br, or I), a cyano group, a phenyl group (at least one arbitrary hydrogen atom of the phenyl group may be substituted by a halogen atom (F, Cl, Br, or I), a methyl group, a methoxy group, —CF, or —OCF₃), a methyl group, a methoxy group, —CF₃, or —OCF₃. However, in the general formulas (Rc) and (Rh), when the position marked with an asterisk * is a position of the asymmetric atom, different groups are selected for X¹ and X⁴.

In addition, n₃ represents an integer of 0 to 20, and n₄ represents 0 or 1;

R⁵ of the general formulas (Rd) and (Rj) preferably represents a hydrogen atom or a methyl group;

Q of the general formulas (Re) and (Rj) represents a divalent hydrocarbon group, such as a methylene group, an isopropylidene group, or a cyclohexylidene group;

k of the general formula (Rk) represents an integer of 0 to 5; and

more preferably, a linear or a branched alkyl group having 4 to 8 carbon atoms, such as R₃═C₄H₉, C₆H₁₃, or C₃H₁₇, may be mentioned. In addition, as X³, F, CF₃, or CH₃ is preferable.

Among those mentioned above, the following is preferable.

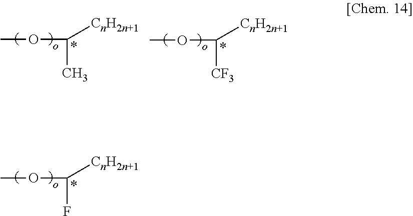

(In the formulas, o represents 0 or 1, n represents an integer of 2 to 12, preferably 3 to 8, and more preferably 4, 5, or 6, and an asterisk * represents a chiral carbon atom.)

In the above general formula (Ch-I), R¹⁰⁰ and R¹⁰¹ each more preferably represent a chiral group so as to collectively form a dichiral compound. As the dichiral compound, a compound having an ester bond is preferable since the self polarization is increased, and a compound having an ether compound is also preferable since the tilt angle is increased or the alignment during voltage application is stabilized.

Z¹⁰⁰ and Z¹⁰¹ each independently represent —O—, —S—, —CO—, —COO—, —OCO—, —O—COO—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH—, or a single bond, and although R^{a} of —CO—N(R^{a})— or —N(R^{a})—CO— represents a hydrogen atom or a linear or a branched alkyl group having 1 to 4 carbon atoms, —CF₂O—, —OCF₂—, —CF₂CF₂—, —CF═CF—, —COO—, —OCO—, —CH₂—CH₃—, —C≡C—, or a single bond is preferable.

A¹⁰⁰ and A¹⁰¹ each independently represent

(a) a trans-1,4-cyclohexylene group (in this group, one —CH₂— or at least two —CH₂— groups which are not adjacent to each other may be independently substituted by —O— or —S—),
(b) a 1,4-phenylene group (in this group, one —CH═ or at least two —CH═ groups which are not adjacent to each other may be substituted by a nitrogen atom), or
(c) a group selected from the group consisting of a 1,4-cyclohexenylene group, a 1,4-bicyclo[2,2,2]octylene group, indane-2,5-diyl, a naphthalene-2,6-diyl group, a decahydronaphthalene-2,6-diyl group, and a 1,2,3,4-tetrahydronaphthalene-2,6-diyl group (in one of those functional groups of this group (c), one —CH₂— or at least two —CH₂— groups which are not adjacent to each other each may be independently substituted by —O— or —S—, and in one of those functional groups of this group (c), one —CH═ or at least two —CH═ groups which are not adjacent to each other may be substituted by a nitrogen atom). However, all the groups mentioned above may be unsubstituted or each may be substituted at at least one position by a halogen, a cyano group, or NO₂ or by an alkyl having 1 to 7 carbon atoms, an alkoxy, an alkyl carbonyl or an alkoxy carbonyl group, in each of which at least one hydrogen atom may be substituted by F or Cl.

Although A¹⁰⁰ and A¹⁰¹ of the general formula (Ch-I) each preferably represent 1,4-phenylene or trans-1,4-cyclohexylene, those rings are preferably unsubstituted or are preferably substituted at at least one of positions 1 to 4 by F, Cl, CN, an alkyl having 1 to 4 carbon atoms, an alkoxy, an alkyl carbonyl, or an alkoxy carbonyl.

n¹¹ represents 0 or 1; when n¹¹ represents 0, m¹² represents 0, and m¹¹ represents 0, 1, 2, 3, 4, or 5; when n¹¹ represents 1, m¹¹ and m¹² each independently represent 0, 1, 2, 3, 4, or 5; and when n¹¹ represents 0, at least one of R¹⁰⁰ and R¹⁰¹ represent a chiral alkyl group or a chiral group having a polymerizable group or a cyclic structure.

When n¹¹ and m¹² each represent 0, m¹¹ preferably represents 1, 2, or 3; when n¹¹ represents 1, m¹¹ and m¹² each preferably represent 1, 2, or 3.

D represents a substituent each represented by the following formulas (D1) to (D8).

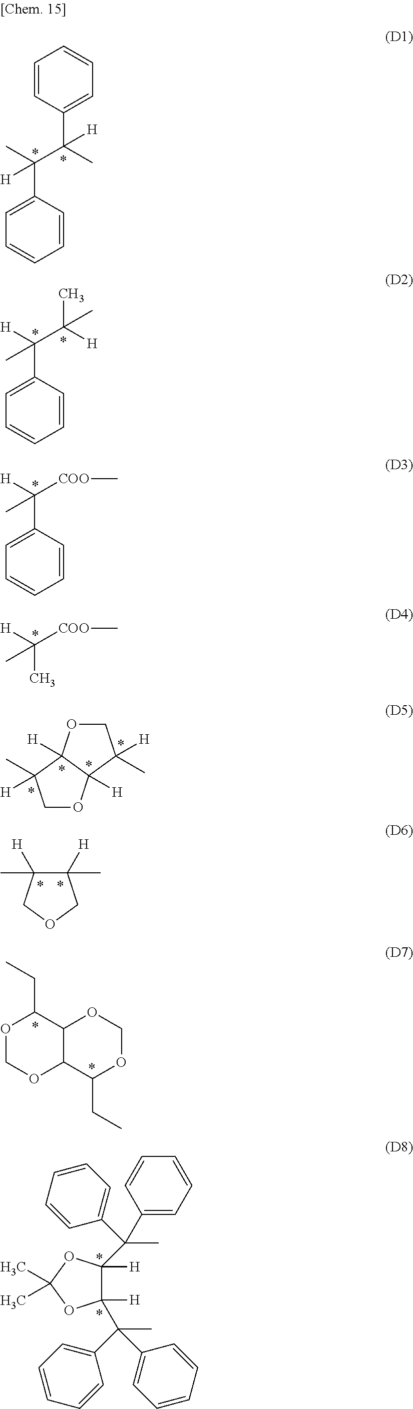

(In the formulas, at least one arbitrary hydrogen atom of the benzene ring may be substituted by a halogen atom (F, Cl, Br, or I), an alkyl having 1 to 20 carbon atoms, or an alkoxy group, a hydrogen atom of the alkyl or the alkoxy group may be arbitrarily substituted by a fluorine atom, and a methylene group of the alkyl or the alkoxy group may be substituted by —O—, —S—, —COO—, —OCO—, —CF₂—, —CF═CH—, —CH═CF—, —CF═CF—, or —C≡C— so that oxygen atoms or sulfur atoms are not directly bonded to each other.)

In a partial structure, -(A¹⁰⁰-Z¹⁰⁰)m¹¹-(D)n¹¹-(Z¹⁰¹-A¹⁰¹)m¹²-, of the general formula (Ch-I), when n¹¹ represents 0, as the partial structure, the following structures are preferable.

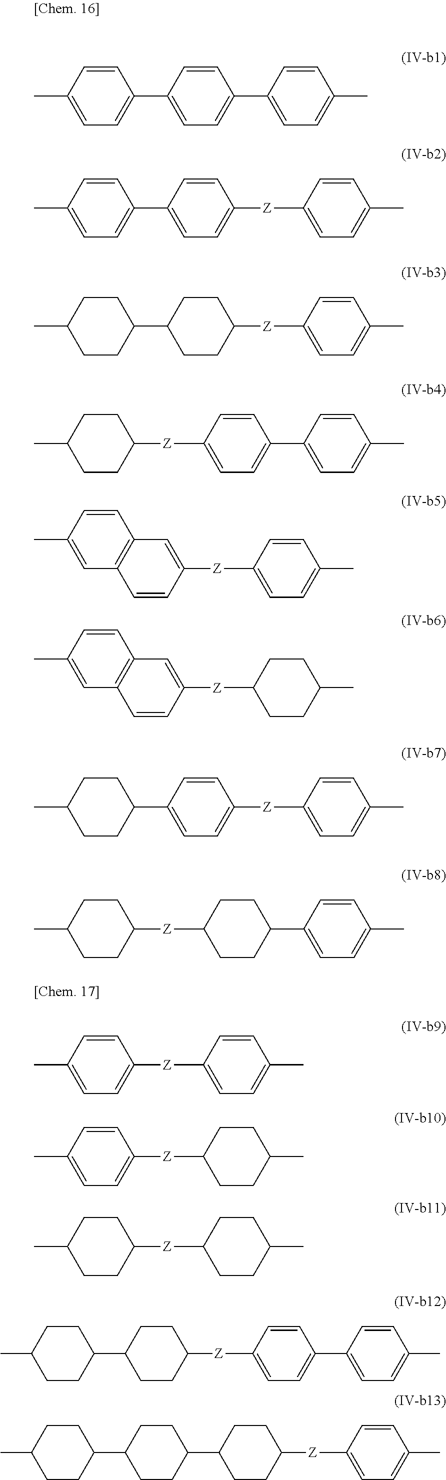

(However, in those formulas, at least one arbitrary hydrogen atom of the benzene ring may be substituted by a halogen atom (F, Cl, Br, or I), a methyl group, a methoxy group, —CF₃, or —OCF₃, at least one arbitrary carbon atom of the benzene ring may be substituted by a nitrogen atom, and the introduction of those substituents and nitrogen atom is preferable to decrease the crystallinity and to control the direction and intensity of dielectric anisotropy. The definition of Z is the same as that of Z¹⁰⁰ and Z¹⁰¹ of the formula (Ch-I).) In view of the reliability, compared to a hetero ring, such as a pyridine ring or a pyrimidine ring, a benzene ring and a cyclohexane ring are preferable. In order to increase the dielectric anisotropy, although a compound having a hetero ring, such as a pyridine ring or a pyrimidine ring, is preferably used, in this case, this type of compound has a relatively high polarity, and the crystallinity is decreased, so that the liquid crystal properties can be preferably stabilized. On the other hand, when a hydrocarbon ring, such as a benzene ring or a cyclohexane ring, is used, the polarity of the compound is low. Hence, in accordance with the polarity of the chiral compound, an appropriate content thereof is preferably selected.

When n¹¹ and m¹² each represent 0, preferable structures of the compound represented by the general formula (Ch-I) are as shown below.

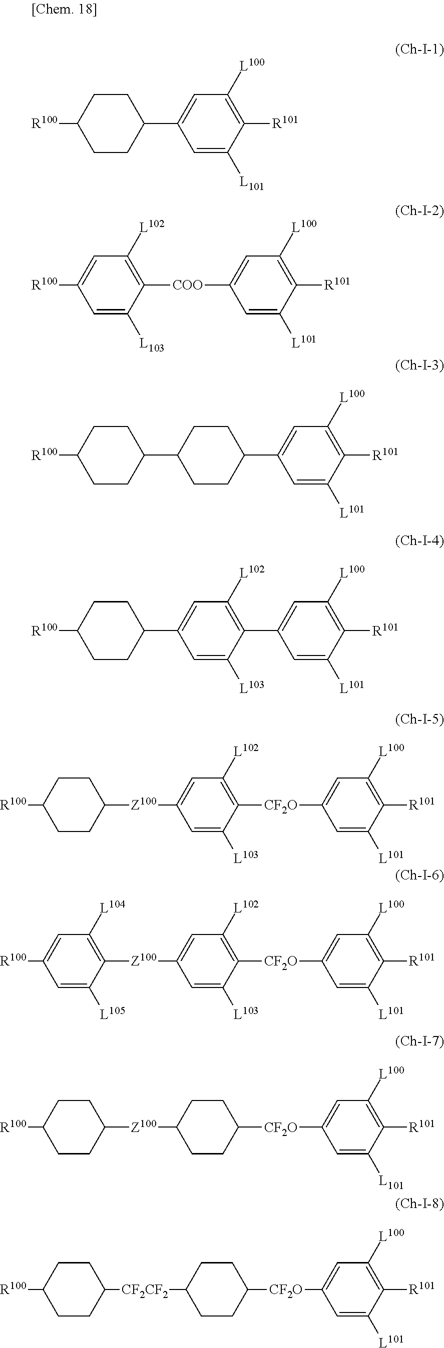

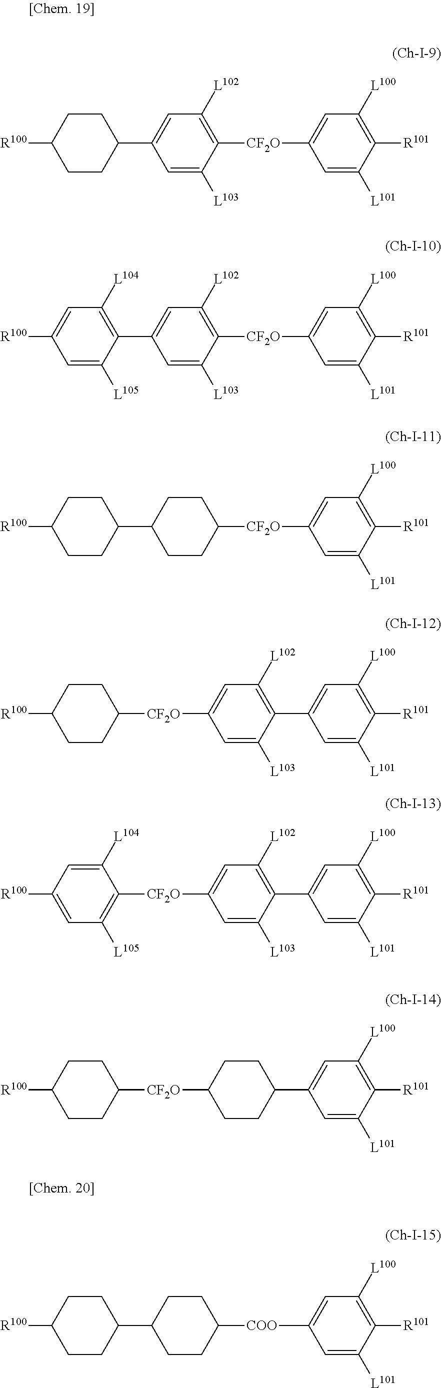

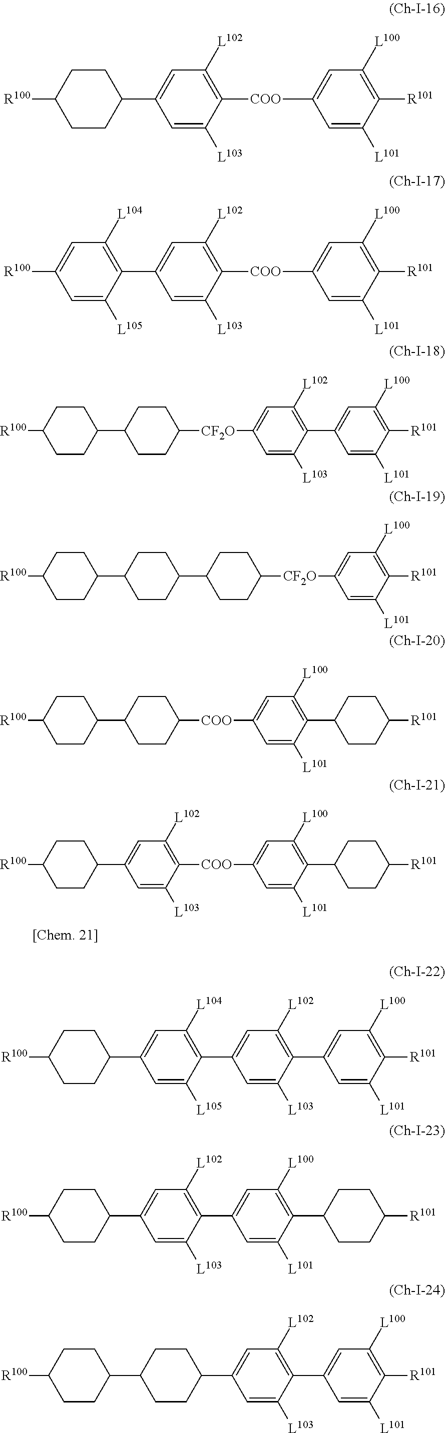

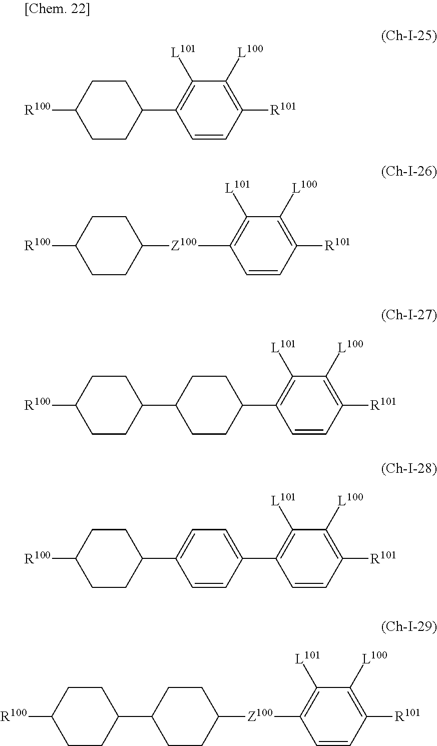

In the formulas, R¹⁰⁰, R¹⁰¹, and Z¹⁰⁰ represent the same meanings as those of R¹⁰⁰, R¹⁰¹, and Z¹⁰⁰ of the general formula (Ch-I), at least one of R¹⁰⁰ and R¹⁰¹ represents a chiral group, and L¹⁰⁰ to L¹⁰⁵ each independently represent a hydrogen atom or a fluorine atom.

When n¹¹ represents 1, although the compound represented by the general formula (Ch-I) has a structure in which an asymmetric atom is present in a cyclic structure portion, a chiral structure D is preferably represented by formula (D5).

As the compound represented by the general formula (Ch-I) when D is represented by the formula (D5), in particular, the following compounds represented by the following formulas (D5-1) to (D5-8) are preferable.

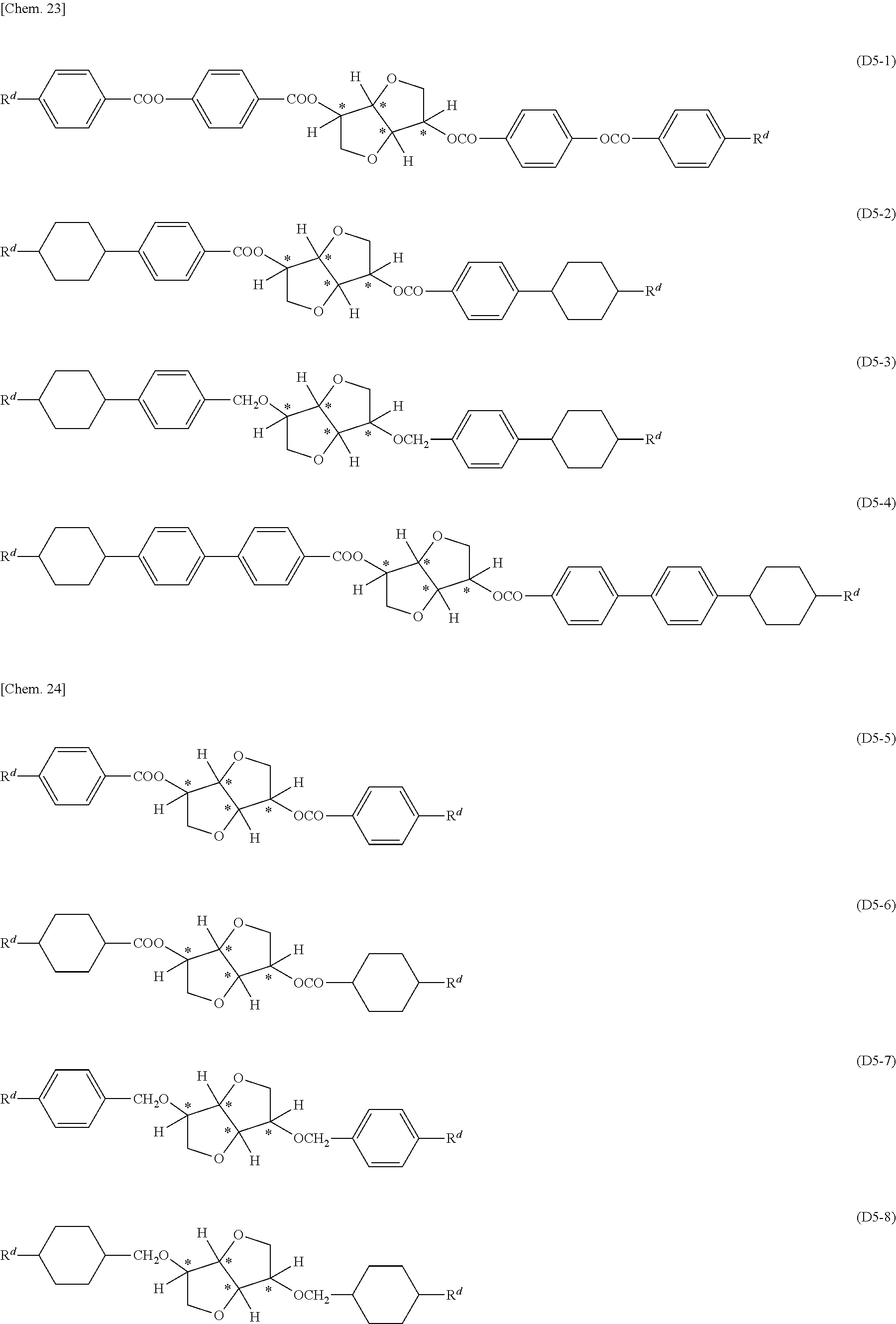

(R^{d} each independently represent an alkyl group having 3 to 10 carbon atoms, —CH₂— adjacent to a ring of this alkyl group may be substituted by —O—, and arbitrary —CH₂— may be substituted by —CH═CH—.)

As the axial asymmetric compound, compounds represented by the following general formulas (Ch-II), (Ch-III), and (Ch-III) are preferable.

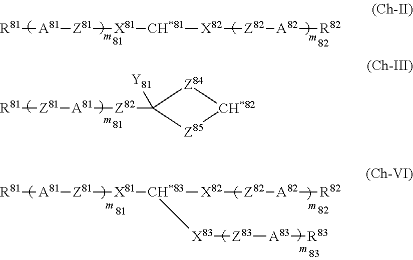

R⁸¹, R⁸², R⁸³, and Y⁸¹ each independently represent a linear or a branched alkyl group having 1 to 30 carbon atoms, a hydrogen atom, or a fluorine atom, at least one —CH₂— of the alkyl group may be substituted by —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropyl group, or —Si(CH₃)₂— so that oxygen atoms or sulfur atoms are not directly bonded to each other, at least one hydrogen atom of the alkyl group may be further substituted by a fluorine atom, a chlorine atom, a bromine atom, or a CN group, the alkyl group may have a polymerizable group, the alkyl group may include a condensed or a spiro cyclic system, the alkyl group may include at least one aromatic or aliphatic ring which is able to include at least one hetero atom, and the rings described above each may be arbitrarily substituted by an alkyl group, an alkoxy group, or a halogen;

Z⁸¹, Z⁸², Z⁸³, Z⁸⁴, and Z⁸⁵ each independently represent an alkylene group having 1 to 40 carbon atoms, and at least one —CH₂— of the alkyl group may be substituted by —O—, —S—, —NH—, —N(CH)—, —CO—, —COO—, —OCO—, —OCOO—, —S—CO—, —CO—S—, —CH═CH—, —CH═CF—, —CF═CH—, —CF═CF—, —CF₂—, or —C≡C— so that oxygen atoms or sulfur atoms are not directly bonded to each other;

X⁸¹, X⁸², and X⁸³ each independently represent —O—, —S—, —P—, —CO—, —COO—, —OCO—, —OCOO—, —CO—NH—, —NH—CO—, —CH₂CH₂—, —OCH₂—, —CH₂O—, —SCH₂—, —CH₂S—, —CF═CF—, —CH═CH—, —OCO—CH═CH—, —C≡C—, or a single bond;

A⁸¹, A⁸², and A⁸³ each independently represent a cyclic group selected from a phenylene group, a cyclohexylene group, a dioxolanediyl group, a cyclohexenylene group, a bicyclo[2,2,3]octylene group, a piperidinediyl group, a naphthalenediyl group, a decahydronaphthalenediyl group, a tetrahydronaphthalenediyl group, or an indanediyl group, at least one —CH═ group in the ring of the phenylene group, naphthalenediyl group, tetrahydronaphthalenediyl group, or indanediyl group may be substituted by a nitrogen atom, one —CH₂— group or two —CH₂— groups which are not adjacent to each other in the ring of the cyclohexylene group, dioxolanediyl group, cyclohexenylene group, bicyclo[2,2,3]octylene group, piperidinediyl group, decahydronaphthalenediyl group, tetrahydronaphthalenediyl group, or indanediyl group may be substituted by —O— and/or —S—, and at least one hydrogen atom of the cyclic group may be substituted by a fluorine atom, a chlorine atom, a bromine atom, a CN group, or a NO₂ group or by an alkyl group having 1 to 7 carbon atoms, an alkoxy group, an alkyl carbonyl group or an alkoxy carbonyl group, in each of which at least one hydrogen atom may be substituted by a fluorine atom or a chlorine atom; and

m₈₁, m₈₂, and m₈₃ each represent 0 or 1, and m₈₁+m₈₂+m₈₃ represents 1, 2, or 3.

CH*⁸¹, CH*⁸², and CH*⁸³ represent the following groups.

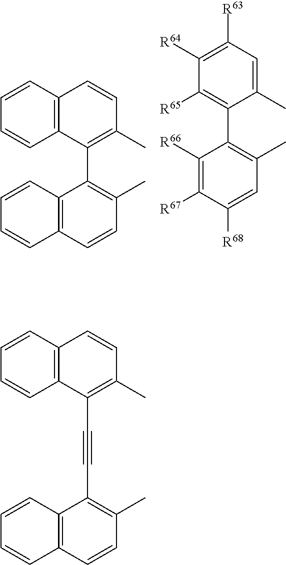

R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamine group, two of R⁶³, R⁶⁴, and R⁶⁵ may form a methylene chain which may have a substituent or may form a mono- or a poly-methylenedioxy group which may have a substituent, and two of R⁶⁶, R⁶⁷, and R⁶⁸ may form a methylene chain which may have a substituent or may form a mono- or a poly-methylenedioxy group which may have a substituent. However, when R⁶⁵ and R⁶⁶ each represent a hydrogen atom, the cases described above are excluded.

In more particular, compounds represented by the following general formulas (IV-d4), (IV-d5), (IV-c1), and (IV-c2) are preferable. In the cases of (IV-d4), (IV-d5), and (IV-c2), the axis of the axial asymmetry is a bond connecting the α positions of the two naphthalene rings, and in the case of (IV-c1), the axis of the axial asymmetry is a single bond connecting the two benzene rings.

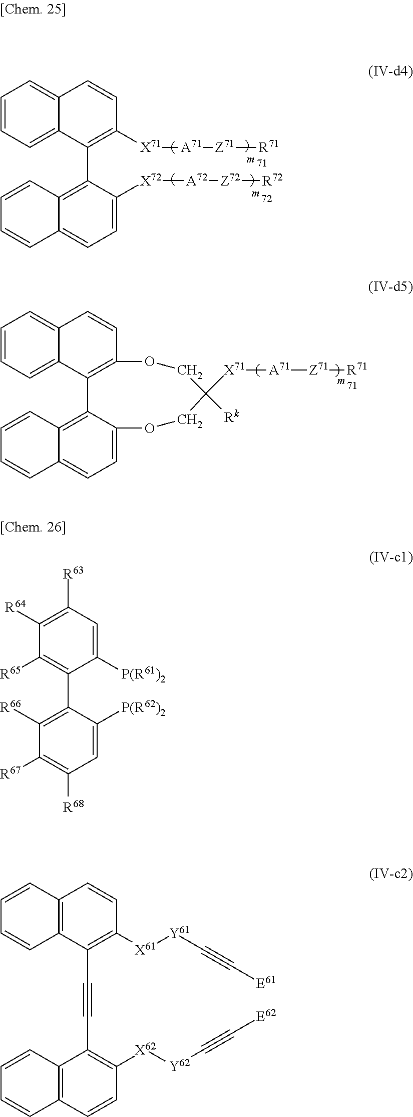

In the general formulas (IV-d4) and (IV-d5), although R⁷¹ and R⁷² each independently represent hydrogen, a halogen, a cyano (CN) group, an isocyanate (NCO) group, an isothiocyanate (NCS) group, or an alkyl group having 1 to 20 carbon atoms, at least one arbitrary —CH₃— of this alkyl group may be substituted by —O—, —S—, —COO—, —OCO—, —CH═CH—, —CF═CF—, or —C≡C—, and arbitrary hydrogen of this alkyl may be substituted by a halogen;

although A⁷¹ and A⁷² each independently represent a three-, a six-, or an eight-membered aromatic or non-aromatic ring or a condensed ring having at least 9 carbon atoms, arbitrary hydrogen of the above rings may be substituted by a halogen, an alkyl having 1 to 3 carbon atoms, or a haloalkyl group, at least one —CH₃— of the ring may be substituted by —O—, —S—, or —NH—, and at least one —CH═ of the ring may be substituted by —N═;

although Z⁷¹ and Z⁷² each independently represent a single bond or an alkylene group having 1 to 8 carbon atoms, arbitrary —CH₃— may be substituted by —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and arbitrary hydrogen may be substituted by a halogen;

X⁷¹ and X⁷² each independently represent a single bond, —COO—, —OCO—, —CH₂O—, —OCH₂—, —CF₂O—, —OCF₂—, or —CH₂CH₂—; and m⁷¹ and m⁷³ each independently represent an integer of 1 to 4. However, one of m⁷¹ and m⁷² in the general formula (IV-d5) may represent 0.

R^{k} represents a hydrogen atom, a halogen atom, or the same meaning as that of —X⁷¹-(A⁷¹-Z⁷¹)—R⁷¹.

In the general formulas (IV-c1) and (IV-c2), at least one of X⁶¹ and Y⁶¹ is present and at least one of X⁶² and Y⁶² is present, and X⁶¹, X⁶², Y⁶¹, and Y⁶² each independently represent one of CH₂, C═O, O, N, S, P, B, and Si. In addition, in the case of N, P, B, or Si, X⁶¹, X⁶², Y⁶¹, and Y⁶² may be bonded to a substituent, such as an alkyl group, an alkoxy group, or an acyl group, so as to satisfy a predetermined atomic valence.

E⁶¹ and E⁶² each independently represent a hydrogen atom, an alkyl group, an aryl group, an allyl group, a benzyl group, an alkenyl group, an alkynyl group, an alkyl ether group, an alkyl ester group, an alkyl ketone group, a heterocyclic group or a derivative thereof.

In addition, in the general formula (IV-c1), R⁶¹ and R⁶² each independently represent a phenyl group which may be substituted by an alkyl group, an alkoxyl group, or a halogen atom, a cyclopentyl group, or a cyclohexyl group; and

R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamine group, two of R⁶³, R⁶⁴, and R⁶⁵ may form a methylene chain which may have a substituent or a mono- or poly-methylenedioxy group which may have a substituent, and two of R⁶⁶, R⁶⁷, and R⁶⁸ may form a methylene chain which may have a substituent or a mono- or poly-methylenedioxy group which may have a substituent.

However, when R⁶⁵ and R⁶⁶ each represent a hydrogen atom, the cases described above are excluded.

In the case in which a strong helical twisting power is particularly required, the compounds represented by the general formulas (IV-d4) and (IV-d5) are specifically preferable.

As the axial asymmetric compound, compounds represented by the following formulas (E-1) to (E-3) are preferable.

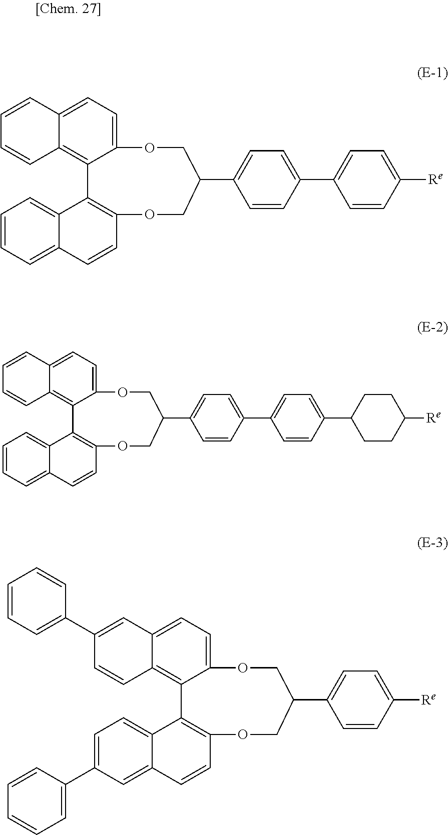

(R^{e} each independently represent an alkyl group having 3 to 10 carbon atoms, —CH₂— adjacent to the ring of this alkyl group may be substituted by —O—, and arbitrary —CH₂— may be substituted by —CH═CH—.) In the cases of (E-1), (E-2), and (E-3), the axis of the axial asymmetry is a bond connecting the α positions of the two naphthalene rings.

As the plane asymmetric compound, for example, the following helicene derivative is preferable.

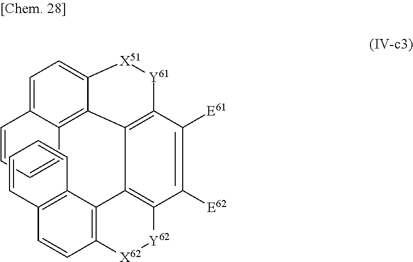

(In the formula, at least one of X⁶¹ and Y⁶¹ is present and at least one of X⁶² and Y⁶² is present, and X⁶¹, X⁶², Y⁶¹, and Y⁶² each independently represent one of CH₂, C═O, O, N, S, P, B, and Si. In addition, in the case of N, P, B, or Si, X⁶¹, X⁶², Y⁶¹, and Y⁶² may be bonded to a substituent, such as an alkyl group, an alkoxy group, or an acyl group, so as to satisfy a predetermined atomic valence.

E⁶¹ and E⁶² each independently represent a hydrogen atom, an alkyl group, an aryl group, an allyl group, a benzyl group, an alkenyl group, an alkynyl group, an alkyl ether group, an alkyl ester group, an alkyl ketone group, a heterocyclic group, or a derivative thereof.) In the helicene derivative as described above, since the front-to-back positional relationship of rings which are overlapped in a front-to-back direction cannot be freely changed, the case in which the rings form a clockwise helical structure is discriminated from the case in which the rings form an anticlockwise helical structure, so that the chirality is expressed.

### <Polymerizable Compound>

The ferroelectric liquid crystal composition in the liquid crystal display device of the present invention may contain at least one type of polymerizable compound. As the polymerizable compound, a polymerizable compound having a cyclic structure (mesogenic supporting group), such as a cyclohexane skeleton or a benzene skeleton, and a compound having no mesogenic supporting group may be used.

As the polymerizable compound having a mesogenic supporting group, a polymerizable compound represented by the following general formula (PC1) is preferable.

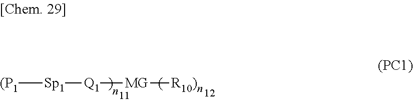

(In the formula, P₁ represents a polymerizable group, Sp₁ represents a spacer group having 0 to 20 carbon atoms, Q₁ represents a single bond, —O—, —OCH₂—, —CH₂O—, —C₂H₄—, —COO—, —OCO—, —CH═CH—, —CO—, —OCOO—, —NH—, —NHCOO—, —OCONH—, —OCOCH₂—, —CH₂OCO—, —COOCH₂—, —CH₂COO—, —CH═CH—COO—, —OCO—CH═CH—, —CH═CH—OCO—, —COO—CH═CH—, —CH═CCH₃—COO—, —COO—CCH₃═CH—, —COOC₂H₄—, —OCOC₂H₄—, —C₂H₄OCO—, —C₂H₄COO—, —C—, —CF₂O—, or —OCF₂—, n₁₁ and n₁₂ each independently represent 1, 2, or 3, and MG represents a mesogenic group or a mesogenic supporting group; and

R₁₀ represents a hydrogen atom, a halogen atom, a cyano group, or an alkyl group having 1 to 25 carbon atoms, at least one CH₂ group of the alkyl group may be substituted by —O—, —S—, —NH—, —N(CH₃)—, —CO—, —COO—, —OCO—, —OCOO—, —SCO—, —COS—, or —C≡C—, or R₁₀ represents P₂-Sp₂-Q₂- (in the formula, P₂, Sp₂, and Q₂ each independently represent the same meaning of one of P₁, Sp₁, and Q₁).)

In the general formula (PC1), MG is preferably represented by the following structure.

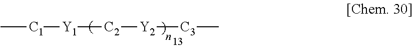

(In the formula, C₁ to C₃ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2) octylene group, a decahydronaphthalene. 2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene 2,7-diyl group, or a fluorene 2,7-diyl group, the 1,4-phenylene group, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene 2,7-diyl group, and fluorene 2,7-diyl group each may have as a substituent, at least one of F, Cl, CF₃, OCF₃, a cyano group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, and an alkenoyloxy group, Y₁ and Y₂ each independently represent —COO—, —OCO—, —CH₂CH—, —OCH₂—, —CH₂O—, —CH═CH—, —C≡C—, —CH═CHCOO—, —OCOCH═CH—, —CH₂CH₂CO—, —CH₂CH₂OCO—, —COOCH₂CH₂—, —OCOCH₂CH₂—, —CONH—, —NHCO—, or a single bond, and n₁₃ represents 0, 1, or 2.)

Sp₁ and SP₂ each preferably independently represent an alkylene group having 1 to 15 carbon atoms, at least one hydrogen atom present in the alkylene group each may be independently substituted by a halogen atom, a cyano group, a methyl group, or an ethyl group, at least one CH₂ group present in this group may be substituted by —O—, —S—, —NH—, —N(CH₃)—, —CO—, —COO—, —OCO—, —OCOO—, —SCO—, —COS—, or —C≡C— so that oxygen atoms are not directly adjacent to each other, and P₁ and P₂ each preferably independently have the structure represented by one of the following general formulas (R-1) to (R-15).

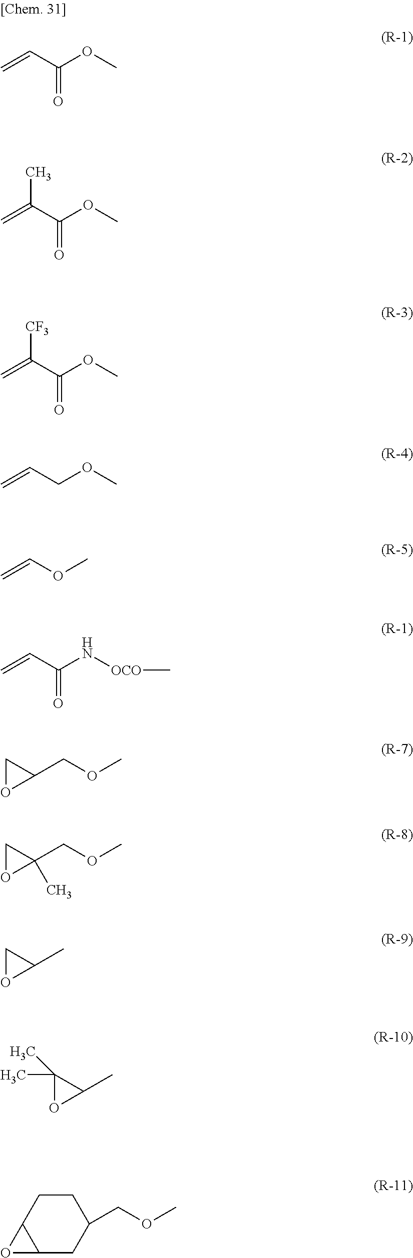

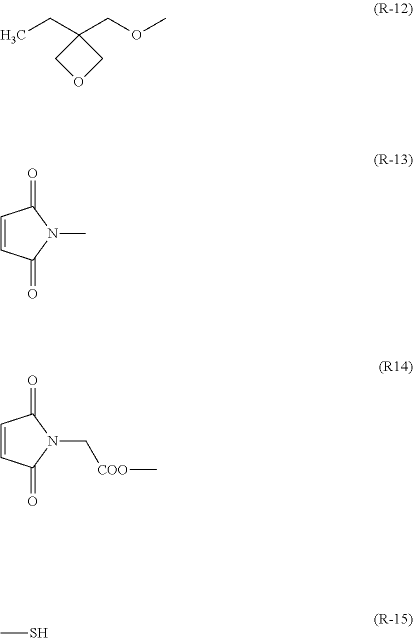

Those polymerizable groups are cured by radical polymerization, radical addition polymerization, cationic polymerization, and anionic polymerization. In particular, when UV polymerization is performed as a polymerization method, the formula (R-1), (R-2), (R-4), (R-5), (R-7), (R-11), (R-13), or (R-15) is preferable, the formula (R-1), (R-2), (R-7), (R-11), or (R-13) is more preferable, and the formulas (R-1) and (R-2) are more preferable.

The polymerizable compound having a mesogenic supporting group represented by the general formula (PC1) may be represented by the following general formula (PC1)-0 having one polymerizable group in its molecule.

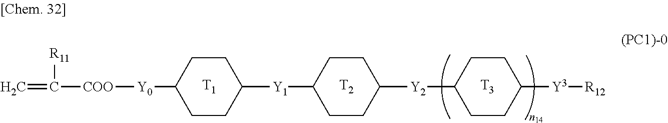

In the formula, R₁₁ represents a hydrogen atom or a methyl group, 6-membered rings T₁, T₂, and T₃ each independently represent one of the following compounds (however, m represents an integer of 1 to 4), and n₁₄ represents an integer of 0 or 1.

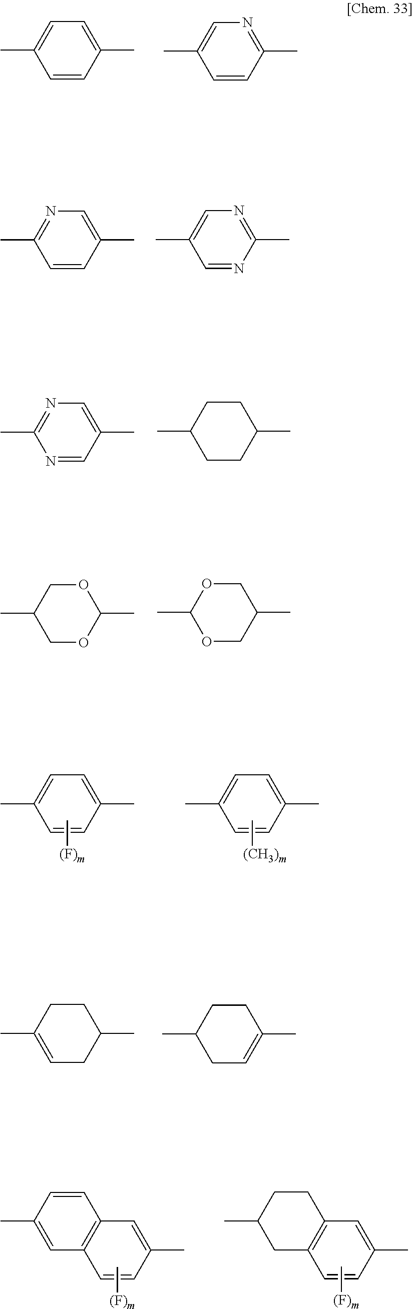

In addition, Y₀, Y₁, and Y₂ each independently represent a single bond, —O—, —OCH—, —CH₂O—, —C₂H₄—, —COO—, —OCO—, —CH═CH—, —CO—, —OCOO—, —NH—, —NHCOO—, —OCONH—, —OCOCH₂—, —CH₂OCO—, —COOCH₂—, —CH₂COO—, —CH═CH—COO—, —OCO—CH═CH—, —CH═CH—OCO—, —COO—CH═CH—, —CH═CCH₃—COO—, —COO—CCH₃═CH—, —COOC₂H₄—, —OCOC₂H₄—, —C₂H₄OCO—, —C₂H₄COO—, —C≡C—, —CF₂O—, or —OCF₂—, and Y₃ represents a single bond, —O—, —COO—, or —OCO—; and
R₁₂ represents a hydrogen atom, a halogen atom, a cyano group, an alkyl group having 1 to 20 carbon atoms, an alkenyl group having 1 to 20 carbon groups, an alkoxy group having 1 to 20 carbon atoms, or a hydrocarbon group having 1 to 20 carbon atoms.

The polymerizable compound having a mesogenic supporting group represented by the general formula (PC1) may be represented by general formulas (PC1)-1 or (PC1)-2 each having at least two polymerizable groups in its molecule.

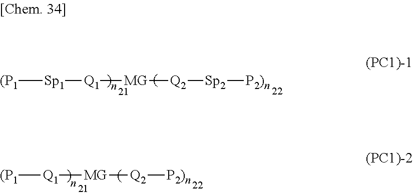

In the formulas, P₁, Sp₁, Q₁, P₂, Sp₂, Q₂, and MG represent the same meanings as those of the general formula (PC1), and n₃ and n₄ each independently represent 1, 2, or 3.

As the general formula (PC1)-1, at least one type of polymerizable compound selected from the group consisting of compounds represented by the following general formulas (PC1)-3 to (PC1)-11 is preferable.

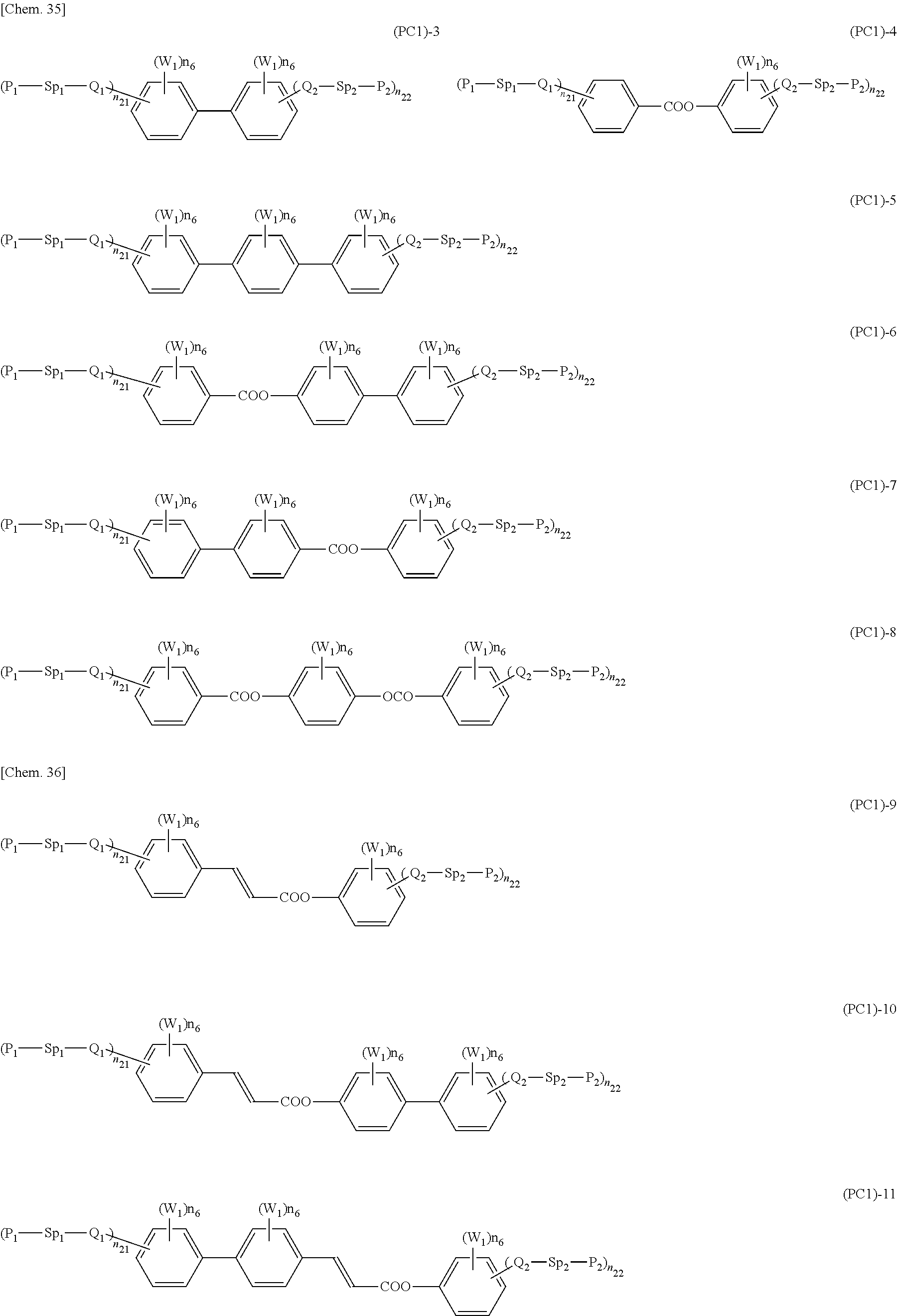

(In the formulas, P₁, P₂, Sp₁, Sp₂, Q₁, and Q₂ represent the same meanings as those of the general formula (PC1), W₁ each independently represent F, CF₃, OCF₃, CH₃, OCH₃, an alkyl group having 2 to 5 carbon atoms, an alkoxy group, an alkenyl group, COOW₂, OCOW₂, or OCOOW₂ (in the formulas, W₂ each independently represent a linear or a branched alkyl group having 1 to 1.0 carbon atoms or an alkenyl group having 2 to 5 carbon atoms), n₂₁ each independently represent 1, 2, or 3, n₂₂ each independently represent 1, 2, or 3, n₆ each independently represent 0, 1, 2, 3, or 4, and n₂₁+n₆ and n₂₂+n₆ each present on the same ring is 5 or less.)

In the general formulas (PC1)-3 to (PC1)-11, Sp₁, Sp₂, Q₁, and Q₂ each preferably represent a single bond. n₂₁+n₂₂ preferably represents 1 to 3 and preferably 1 or 2. P₁ and P₂ preferably represent the formula (P-1) or (P-2). W₁ preferably represents F, CF₃, OCF₃, CH₄, or OCH₃. n₆ preferably represents 1, 2, 3, or 4.

In particular, the following compounds are preferable.

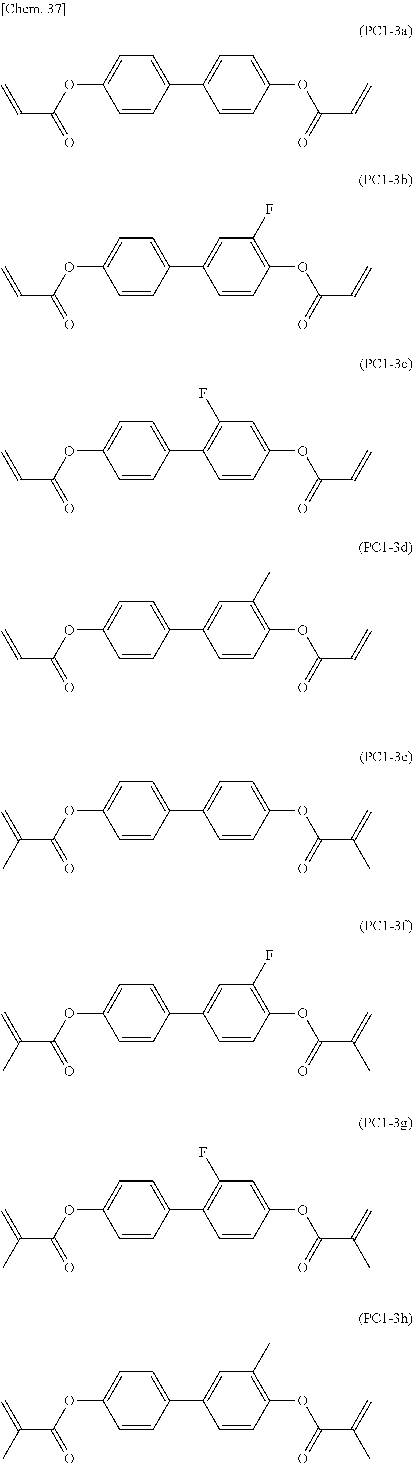

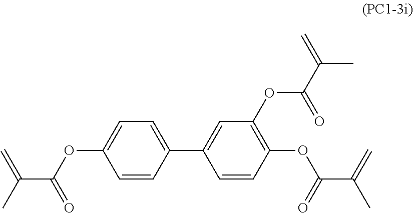 [SMILES: C=C(C)C(=O)Oc1ccc(-c2ccc(OC(=O)C(=C)C)c(OC(=O)C(=C)C)c2)cc1]

In addition, at least one hydrogen atom of the benzene ring of each of the above (PC1-3a) to (PC1-3i) may be substituted by a fluorine atom.

In addition, as the general formula (PC1)-1, at least one type of polymerizable compound selected from the group consisting of the following general formulas (II-a) and (II-b) is preferable.

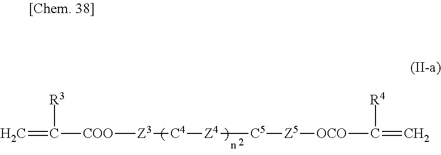

(In the formula (II-a), R³ and R⁴ each independently represent a hydrogen atom or a methyl group, and C⁴ and C⁵ each independently represent a 1,4-phenylene group, a 1,4-cyclohexylene group, a pyridine-2,5-diyl group, a pyrimidine-2,5-diyl group, a pyridazine-3,6-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a 2,6-naphthylene group, or an indane-2,5-diyl group (among those groups, the 1,4-phenylene group, 1,2,3,4-tetrahydronaphthalene-2,6-diyl group, 2,6-naphthylene group, and indane-2,5-diyl group each may be unsubstituted or may have as a substituent, at least one of a fluorine atom, a chlorine atom, a methyl group, a trifluoromethyl group, and a trifluoromethoxy group);

Z³ and Z⁵ each independently represent a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group); and

Z⁴ represent a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—, and n² represents 0, 1, or 2. However, when n² represents 2, C⁴ and Z⁴, the number of each of which is at least two, each may be the same or may be different from each other.)

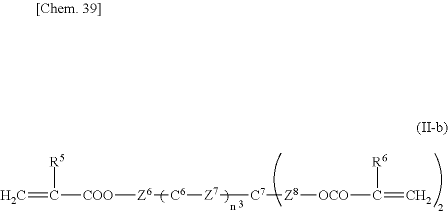

(In the formula (II-b), R⁵ and R⁶ each independently represent a hydrogen atom or a methyl group, and C⁶ represents a 1,4-phenylene group, a 1,4-cyclohexylene group, a pyridine-2,5-diyl group, a pyrimidine-2,5-diyl group, a pyridazine-3,6-diyl group, 1,3-dioxane-2,5-diyl group, a cyclohexene-1,4-diyl group, a decahydronaphthalene-2,6-diyl group, a 1,2,3,4-tetrahydronaphthalene-2,6-diyl group, a 2,6-naphthylene group, or an indane-2,5-diyl group (among those groups, the 1,4-phenylene group, 1,2,3,4-tetrahydronaphthalene-2,6-diyl group, 2,6-naphthylene group, and indane-2,5-diyl group each may be unsubstituted or may have as a substituent, at least one of a fluorine atom, a chlorine atom, a methyl group, a trifluoromethyl group, and a trifluoromethoxy group);

C⁷ represents a benzene-1,2,4-tolyl group, a benzene-1,3,4-tolyl group, a benzene-1,3,5-tolyl group, a cyclohexane-1,2,4-tolyl group, a cyclohexane-1,3,4-tolyl group, or a cyclohexane-1,3,5-tolyl group;

Z⁶ and Z⁸ each independently represent a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group); and

Z⁷ represents a single bond, —CH₂CH₃—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—, and n³ represents 0, 1, or 2. However, when n³ represents 2, C⁶ and Z⁷, the number of each of which is at least two, each may be the same or may be different from each other.)

As the compound represented by the general formula (II-a), a compound represented by one of the following general formulas (II-d) and (II-e) is preferably used since an optical isomer having excellent mechanical strength and heat resistance can be obtained.

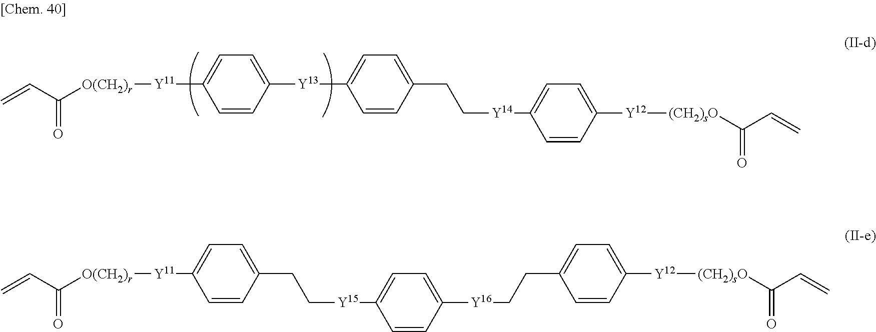

(In the formulas (II-d) and (II-e), m¹ represents 0 or 1, Y¹¹ and Y¹² each independently represent a single bond, —O—, —COO—, or —OCO—, Y¹³ and Y¹⁴ each independently represent —COO—, or —OCO—, Y¹⁵ and Y¹⁶ each independently represent —COO—, or —OCO—, and r and s each independently represent an integer of 2 to 14. The 1,4-phenylene group present in the formula may be unsubstituted or may have as a substituent, at least one of a fluorine atom, a chlorine atom, a methyl group, a trifluoromethyl group, and a trifluoromethoxy group.)

As particular examples of the compound represented by the formula (II-a), compounds represented by the following formulas (II-1) to (II-10) may be mentioned.

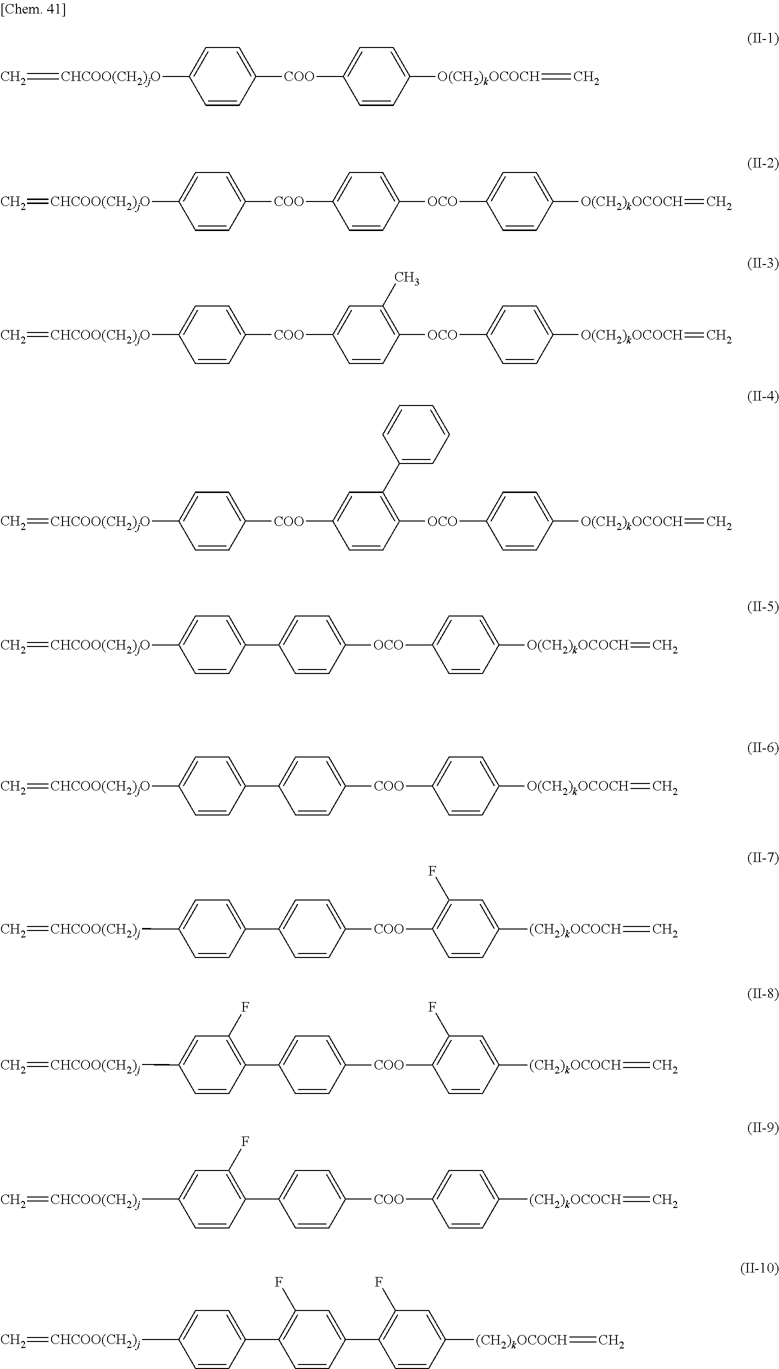

In the formulas, j and k each independently represent an integer of 2 to 14.

In addition, as particular examples of the compound represented by one of the general formulas (II-d) and (II-e), compounds represented by the following formulas (II-11) to (I-20) may be mentioned.

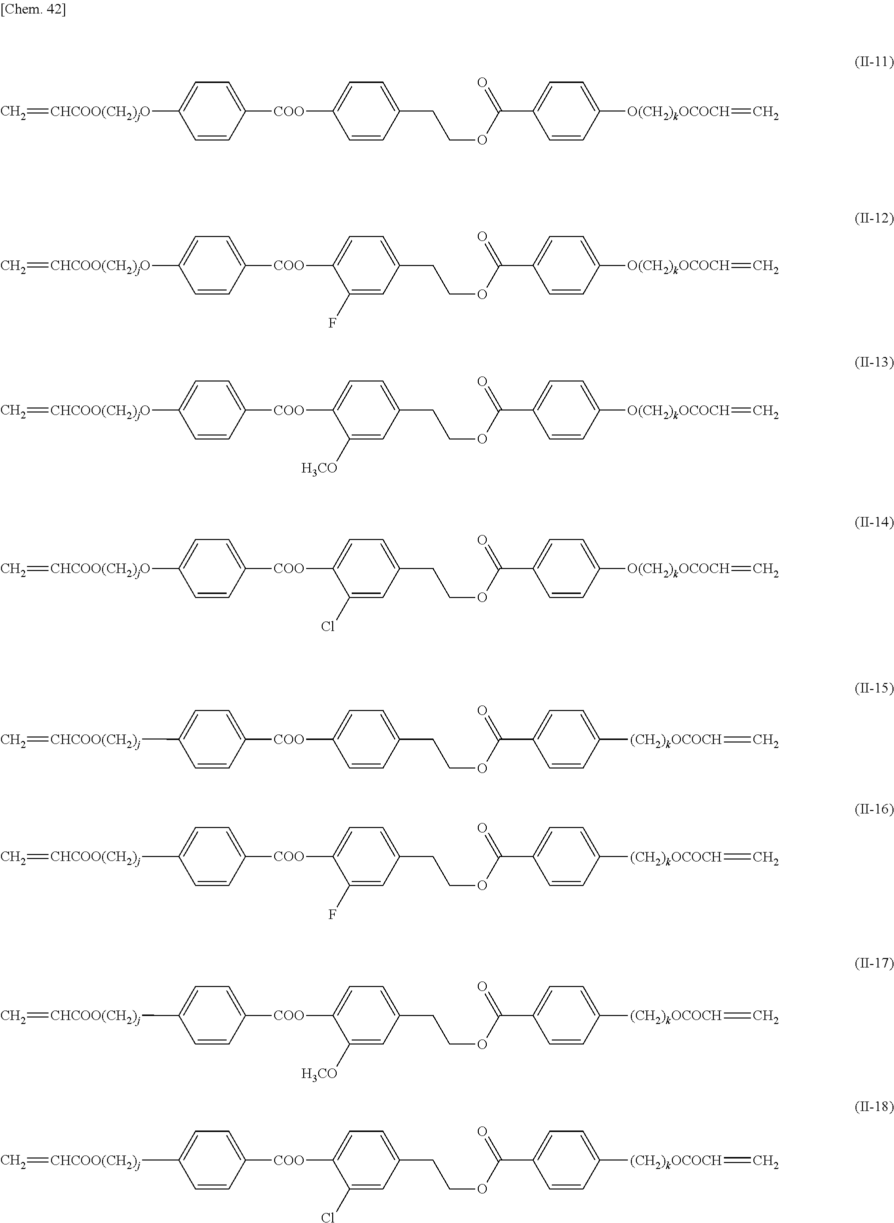

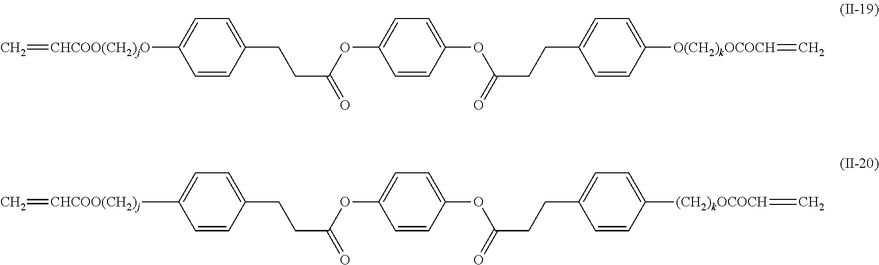

In the formulas, j and k each independently represent an integer of 2 to 14.

As the polymerizable compound having no mesogenic supporting group, a polymerizable compound represented by the general formula (PC2) is preferable, and among the compounds represented by the formula (PC2), a plurality of compounds having different main chain lengths and/or alkyl side chain lengths may be contained.

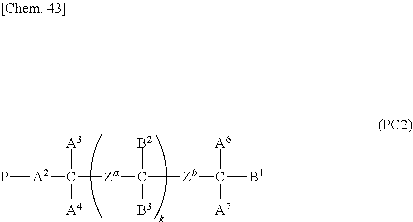

(In the formula, P represents a polymerizable group, A² represents a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group);

Z^{a} and Z^{b} represent a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group);

A³ and A⁶ each independently represent a hydrogen atom or an alkyl group having 1 to 30 carbon atoms (at least one methylene group present in the alkyl group each may be independently substituted by an oxygen atom, —CO—, —COO—, or —OCO— so that oxygen atoms are not directly bonded to each other, and at least one hydrogen atom present in the alkyl group each may be independently substituted by a halogen atom or an alkyl group having 1 to 17 carbon atoms);

A⁴ and A⁷ each independently represent a hydrogen atom or an alkyl group having 1 to 1.0 carbon atoms (at least one methylene group present in the alkyl group each may be independently substituted by an oxygen atom, —CO—, —CO—, or —OCO— so that oxygen atoms are not directly bonded to each other, and at least one hydrogen atom present in the alkyl group each may be independently substituted by a halogen atom or an alkyl group having 1 to 9 carbon atoms), and k represents 0 to 40; and

B¹, B², and B³ each independently represent a group represented by a hydrogen atom, a linear or a branched alkyl group having 1 to 10 carbon atoms (at least one methylene group present in the alkyl group each may be independently substituted by an oxygen atom, —CO—, —COO—, or —OCO— so that oxygen atoms are not directly bonded to each other), or -A⁸-P (in the formula, A⁸ represents a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group). However, among B¹, B², and B³, the total number of which is 2k+1, the number of the groups represented by the -A⁸-P is 0 to 3.)

As a preferable structure of the polymerizable compound represented by the general formula (PC2), at least one selected from the group consisting of compounds represented by the following general formulas (PC2)-1, (PC2)-2, (PC2)-3, and (PC2)-4 may be mentioned. Among those compounds, the compound represented by the formula (PC2)-1 is preferably contained.

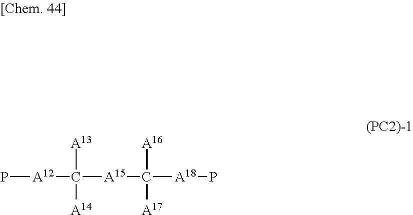

(In the formula, P represents a polymerizable group, and A¹² and A¹⁸ each independently represent a single bond or an alkylene group having 1 to 15 carbon atoms (at least one methylene group present in the alkylene group each may be independently substituted by an oxygen atom, —CO—, —COO—, or —OCO— so that oxygen atoms are not directly bonded to each other, and at least one hydrogen atom present in the alkylene group each may be independently substituted by a fluorine atom, a methyl group, or an ethyl group);

A¹³ and A¹⁶ each independently represent a linear alkyl group having 2 to 20 carbon atoms (at least one methylene group present in the alkyl group each may be independently substituted by an oxygen atom, —CO—, —COO—, or —OCO— so that oxygen atoms are not directly bonded to each other);

A¹⁴ and A¹⁷ each independently represent a hydrogen atom or an alkyl group having 1 to 1.0 carbon atoms (at least one methylene group present in the alkyl group each may be independently substituted by an oxygen atom, —CO—, —COO—, or —OCO— so that oxygen atoms are not directly bonded to each other, and at least one hydrogen atom present in the alkyl group each may be independently substituted by a halogen atom or an alkyl group having 1 to 9 carbon atoms); and

A¹⁵ represents an alkylene group having 9 to 16 carbon atoms (in at least one methylene group to 5 methylene groups present in the alkylene group, one hydrogen atom in the at least one methylene group each independently substituted by a linear or a branched alkyl group having 1 to 10 carbon atoms. At least one methylene group present in the alkylene group each may be independently substituted by an oxygen atom, —CO—, —COO—, or —OCO— so that oxygen atoms are not directly bonded to each other).)

[Chem. 45]

P—(CH₂)ₐ—P (PC2)-2

(In the formula, P represents a polymerizable group, and a represents an integer of 6 to 22.)

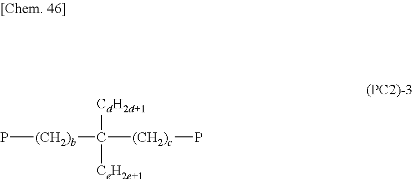

(In the formula, P represents a polymerizable group, b and C each independently represent an integer of 1 to 10, d represents an integer of 1 to 1.0, and e represents an integer of 0 to 6.)

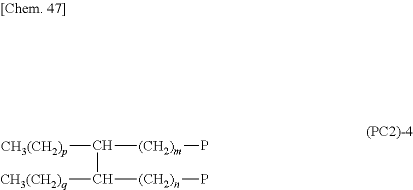

(In the formula, P represents a polymerizable group, and m, n, p, and q each independently represent an integer of 1 to 10.)

As the polymerizable group P, although the following formulas (R-1) to (R-15) may be used, the formula (R-1), (R-2), (R-4), (R-5), (R-7), (R-11), (R-13), or (R-15) is preferable, the formula (R-1), (R-2), (R-7), (R-11), or (R-13) is more preferable, and the formulas (R-1) and (R-2) are more preferable. Furthermore, since the polymerization rate is more increased, the formula (R-1) is particularly preferable.

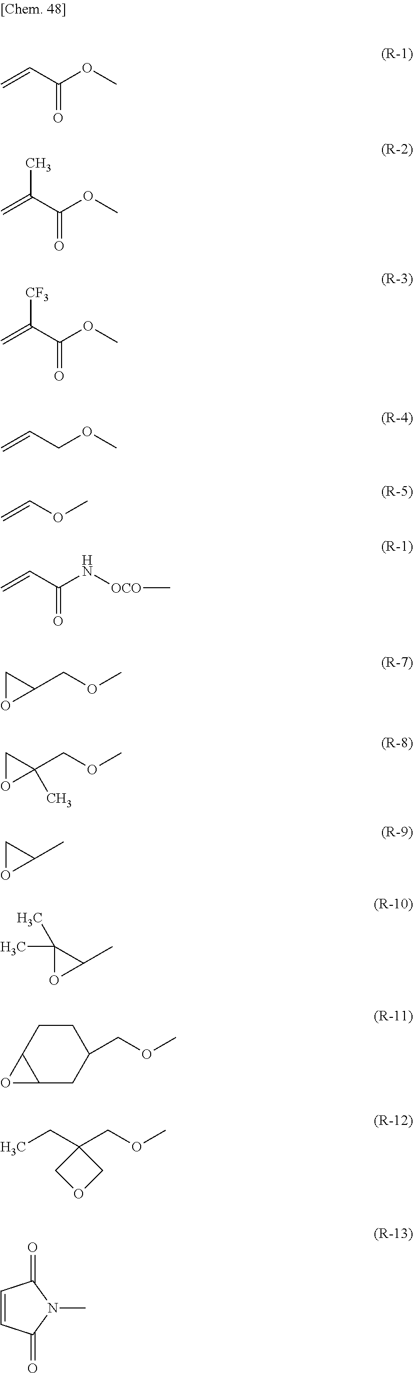

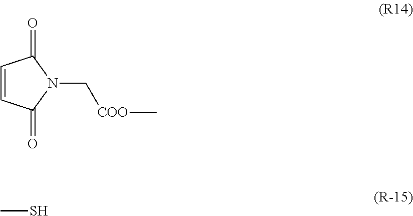

A¹² and A¹⁸ each preferably independently represent a single bond or an alkylene group having 1 to 3 carbon atoms. The distance between the two polymerizable groups may be adjusted by independently changing the lengths of carbon numbers of A¹² and A¹⁸ and A¹⁵. Although the feature of the compound represented by the general formula (PC2)-1 is that the distance (distance between cross-linking points) between the polymerizable functional groups is large, when this distance is excessively large, the polymerization rate is remarkably decreased, and the phase separation may be adversely influenced; hence, the distance between the polymerizable functional groups has an upper limit. On the other hand, the distance between the two side chains of A¹³ and A¹⁶ also has the influence on the mobility of the main chain. That is, when the distance between A¹³ and A¹⁶ is small, side chains A¹³ and A¹⁶ tend to interfere with each other, and the mobility is decreased. Hence, in the compound represented by the general formula (PC2)-1, although the distance between the polymerizable functional groups is determined by the sum of A¹², A¹⁵, and A¹⁶, among those mentioned above, instead of increasing the length of A¹² and that of A¹⁸, the length of A¹⁵ is preferably increased.

On the other hand, as for the side chains A¹³, A¹⁴, A¹⁶ and A¹⁷, the lengths of those side chains preferably have the following modes.

In the general formula (PC2)-1, although A¹³ and A¹⁴ are bonded to the same carbon atom of the main chain, when the lengths are different from each other, a longer side chain is called A¹³ (when the length of A¹³ is equal to that of A¹⁴, one of them is called A¹³). As in the case described above, when the lengths of A¹⁶ and A¹⁷ are different from each other, a longer side chain is called A¹⁶ (when the length of A¹⁶ is equal to that of A¹⁷, one of them is called A¹⁶).

In the present application, although A¹³ and A¹⁶ each independently represent a linear alkyl group having 2 to 20 carbon atoms (at least one methylene group present in the alkyl group each may be independently substituted by an oxygen atom, —CO—, —COO—, or —OCO— so that oxygen atoms are not directly bonded to each other),

preferably, A¹³ and A¹⁶ each independently represent a linear alkyl group having 2 to 18 carbon atoms (at least one methylene group present in the alkyl group each may be independently substituted by an oxygen atom, —CO—, —COO—, or —OCO— so that oxygen atoms are not directly bonded to each other), and

more preferably, A¹³ and A¹⁶ each independently represent a linear alkyl group having 3 to 15 carbon atoms (at least one methylene group present in the alkyl group each may be independently substituted by an oxygen atom, —CO—, —COO—, or —OCO— so that oxygen atoms are not directly bonded to each other).

Since the side chain has a high mobility as compared to that of the main chain, the presence of the side chain contributes to improvement in mobility of a polymer chain at a low temperature; however, in the case in which two side chains cause spatial interference therebetween as described above, the mobility is conversely decreased. In order to prevent the spatial interference between the side chains as described above, an increase in distance between side chains and a decrease in side-chain length within a necessary range are effective.

Furthermore, in the present application, although A¹⁴ and A¹⁷ each independently represent a hydrogen atom or an alkyl group having 0.1 to 10 carbon atoms (at least one methylene group present in the alkyl group each may be independently substituted by an oxygen atom, —CO—, —COO—, or —OCO— so that oxygen atoms are not directly bonded to each other, and at least one hydrogen atom present in the alkyl group each may be independently substituted by a halogen atom or an alkyl group having 1 to 9 carbon atoms), A¹⁴ and A¹⁷ each preferably independently represent a hydrogen atom or an alkyl group having 1 to 7 carbon atoms (at least one methylene group present in the alkyl group each may be independently substituted by an oxygen atom, —CO—, —CO—, or —OCO— so that oxygen atoms are not directly bonded to each other), each more preferably independently represent a hydrogen atom or an alkyl group having 1 to 5 carbon atoms (at least one methylene group present in the alkyl group each may be independently substituted by an oxygen atom, —CO—, —COO—, or —OCO— so that oxygen atoms are not directly bonded to each other), and each even more preferably independently represent a hydrogen atom or an alkyl group having 1 to 3 carbon atoms (at least one methylene group present in the alkyl group each may be independently substituted by an oxygen atom, —CO—, —COO—, or —OCO— so that oxygen atoms are not directly bonded to each other).

As for A¹⁴ and A¹⁷, when the lengths thereof are excessively long, it is also not preferable since spatial interference between the side chains is induced. On the other hand, when A¹⁴ and A¹⁷ are alkyl groups each having a short length, it is believed that those groups each function as a side chain having a high mobility and each function to inhibit adjacent main chains from coming close to each other. Since A¹⁴ and A¹⁷ are believed to have a function to prevent the interference between polymer main chains and to enhance the mobility thereof, an increase in anchoring energy at a low temperature can be suppressed, and hence the characteristics of a polymer-stabilized liquid crystal optical element in a low temperature region can be effectively improved.

In order to change the distance between the side chains and also to increase the distance between the cross-linking points so as to decrease a glass transition temperature, A¹⁵ located between the two side chains is preferably has a large length. However, when A¹⁵ is excessively long, for example, the compatibility with a liquid crystal composition is degraded due to an excessive increase in molecular weight of the compound represented by the general formula (PC2)-1, and the phase separation is adversely influenced due to an excessive decrease in polymerization rate: hence, an upper limit of the length is naturally determined.

Accordingly, in the present application, A¹⁵ preferably represents an alkylene group having 9 to 16 carbon atoms (in at least one methylene group to 5 methylene groups present in the alkylene group, one hydrogen atom of the at least one methylene group each independently substituted by a linear or a branched alkyl group having 1 to 10 carbon atoms. At least one methylene group present in the alkylene group each may be independently substituted by an oxygen atom, —CO—, —COO—, or —OCO— so that oxygen atoms are not directly bonded to each other).

That is, in the present application, the alkylene chain length of A¹⁵ is preferably 9 to 1.6 carbon atoms. As the structural feature of A¹⁵, A¹⁵ has the structure in which a hydrogen atom of the alkylene group is substituted by an alkyl group having 1 to 10 carbon atoms. Although the number of alkyl groups for substitution is 1 to 5, the number is preferably 1 to 3 and more preferably 2 or 3. The number of carbon atoms of the alkyl group for substitution is preferably 1 to 5 and more preferably 1 to 3.

For example, in the general formula (PC2)-1, a compound in which A¹⁴ and A¹⁷ each represent hydrogen can be obtained in such a way that a compound having a plurality of epoxy groups is allowed to react with a polymerizable compound, such as acrylic acid or methacrylic acid, having active hydrogen which is reactable with an epoxy group to synthesize a polymerizable compound having a hydroxide group, and this compound is then allowed to react with a saturated fatty acid.

Furthermore, the compound described above may also be obtained in such a way that a compound having a plurality of epoxy groups is allowed to react with a saturated fatty acid to synthesize a compound having a hydroxide group, and this compound is then allowed to react with a polymerizable compound, such as an acrylic acid chloride, having a group which is reactable with a hydroxide group.

In addition, for example, when A¹⁴ and A¹⁷ of the general formula (PC2)-1 each represent an alkyl group, and A¹² and A¹⁸ each represent a methylene group having one carbon atom, a radical polymerizable compound can be obtained, for example, by a method in which a compound having a plurality of oxetane groups is allowed to react with a fatty acid chloride or a fatty acid which is reactable with an oxetane group, and a polymerizable compound, such as acrylic acid, having active hydrogen is further allowed to react with a reaction product, or by a method in which a compound having one oxetane group is allowed to react with a polyvalent fatty acid chloride or fatty acid which is reactable with an oxetane group, and a polymerizable compound, such as acrylic acid, having active hydrogen is further allowed to react with a reaction product.

In addition, when A¹² and A¹⁸ of the general formula (PC2)-1 each represent an alkylene group having 3 carbon atoms (propylene group: —CH₂CH₂CH₂—), a polymerizable compound can be obtained when a compound having a plurality of furan groups is used instead of using a compound having an oxetane group. Furthermore, when A¹² and A¹⁸ of the general formula (PC2)-1 each represent an alkylene group having 4 carbon atoms (butylene group; —CH₂CH₂CH₂CH₂—), a polymerizable compound can be obtained when a compound having a plurality of pyran groups is used instead of using a compound having an oxetane group.

As a polymerizable compound used for the ferroelectric liquid crystal composition of the liquid crystal display device of the present invention, besides the achiral substances described above, a chiral substance may also be used. As a photopolymerizable compound exhibiting chiral properties, for example, a polymerizable compound represented by the following general formula (II-x) or (II-y) may be used.

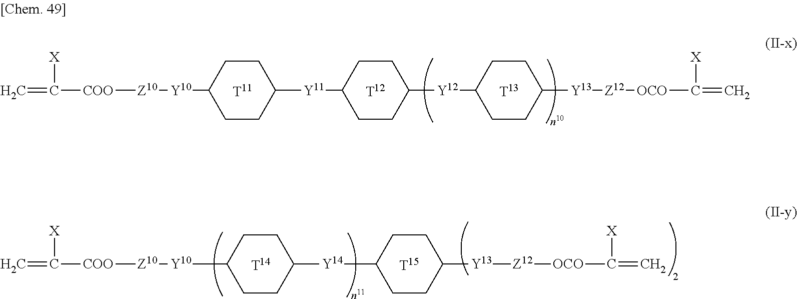

In the above general formulas (II-x) and (II-y), x represents a hydrogen atom or a methyl group. In addition, n¹⁰ represents an integer of 0 or 1, and n¹¹ represents an integer of 0, 1, or 2. However, when n¹¹ represents 2, a plurality of T¹⁴ and Y¹⁴ each may be the same or may be different from each other.

In addition, 6-membered rings T¹¹, T¹², T¹³, and T¹⁴ each represent a substituent, such as a 1,4-phenylene group or a trans-1,4-cyclohexylene group, having a 6-membered ring structure. However, the six-membered rings T¹¹, T¹², and T¹³ are no limited only to the substituents mentioned above, may have at least one of substituents having the following structures, and may be the same or may be different from each other.

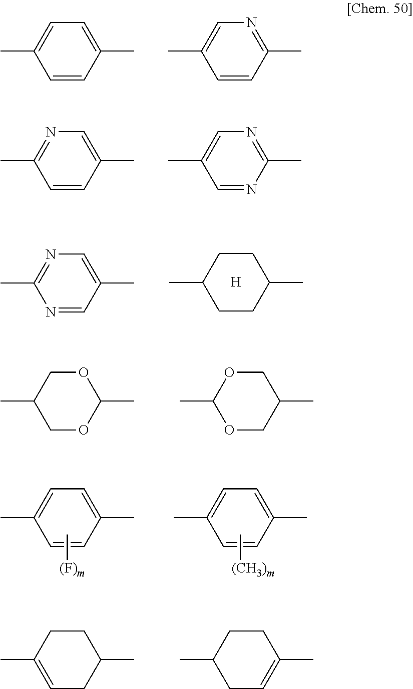

In addition, in the above substituents, m represents an integer of 1 to 4.

In addition, T¹⁵ in the general formula (II-y) represents a cyclic trivalent group, such as a bezene-1,2,4-tolyl group, a bezene-1,3,4-tolyl group, a bezene-1,3,5-tolyl group, a cyclohexane-1,2,4-tolyl group, a cyclohexane-1,3,4-tolyl group, or a cyclohexane-1,3,5-tolyl group.

In addition, Y¹¹, Y¹², and Y¹⁴ in the general formulas (II-x) and (II-y) each independently represent a linear or a branched alkylene group having 1 to 10 carbon atoms, one CH₂ group present in this group or at least two CH₂ groups which are not adjacent to each other may be substituted by —O—, —S—, —CO—O—, or —O—CO— and may include a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CHCH₂CH₂—, or —CH₂CH₂CH═CH—. In addition, an asymmetric atom may or may not be contained. That is, as long as having any one of the above structures, Y¹¹ and Y¹² may be the same or different from each other.

In addition, Y¹⁰ and Y¹³ each represent a single bond, —O—, —OCO—, or —COO—.

Z¹¹ represents a branched alkylene group having an asymmetric atom and 3 to 20 carbon atoms.

Z¹² represents an alkylene group having 1 to 20 carbon atoms and may or may not contain an asymmetric atom.

In addition, the polymerizable compound is also preferably a disc-shaped liquid crystal compound represented by the following general formula (PC1)-9.

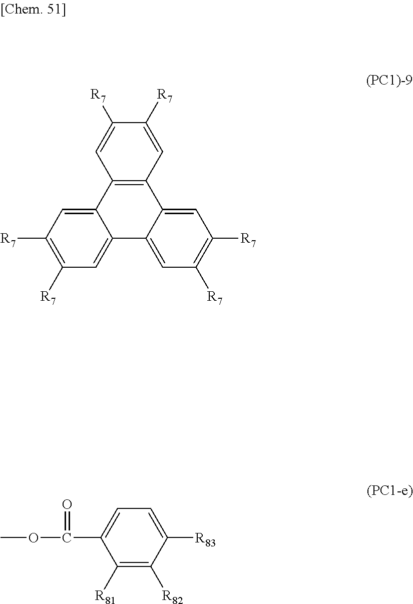

(In the formula, R, each independently represent a P₁-Sp₁-Q₁or a substituent represented by the general formula (PC1-e) (in the formula, P₁, Sp₁, and Q₁ have the same meanings as those of the general formula (PC1), R₈₁ and R₈₂ each independently represent a hydrogen atom, a halogen atom, or a methyl group, R₈₃ represents an alkoxy group having 1 to 20 carbon atoms, and at least one hydrogen atom of the alkoxy group is substituted by the substituent represented by one of the formulas (R-1) to (R-15).)

The use amount of each of the polymerizable compounds described above is preferably 10 percent by mass or less, more preferably 5 percent by mass or less, and particularly preferably 2 percent by mass or less.

As a polymerization method when the ferroelectric liquid crystal composition of the present invention contains a polymerizable compound, although radical polymerization, anionic polymerization, cationic polymerization, or the like may be used, polymerization is preferably performed by radical polymerization.

As a radical polymerization initiator, although a thermal polymerization initiator and a photopolymerization initiator may be used, a photopolymerization initiator is preferable. In particular, the following compounds are preferable.

acetophenones, such as diethoxy acetophenone, 2-hydroxy-2-methyl-1-phenylpropane-1-one, benzil dimethyl ketal, 1-(4-isopropylphenyl)-2-hydroxy-2-methylpropane-1-one, 4-(2-hydroxyethoxy)phenyl-(2-hydroxy-2-propyl) ketone, 1-hydroxycyclohexyl-phenyl ketone, 2-methyl-2-morpholino(4-thiomethylphenyl)propane-1-one, and 2-benzyl-2-dimethylamino-1-(4-morpholinophenyl)-butanone;

benzoins, such as benzoin, benzoin isopropyl ether, and benzoin isobutyl ether;

acyl phosphine oxides, such as (2,4,6-trimethylbenzoyl)diphenylphosphine oxide;

benzil, and methylphenyl glyoxy esters;

benzophenones, such as benzophenone, methyl o-benzoylbenzoate, 4-phenylbenzophenon, 4,4′-dichlorobenzophenone, hydroxybenzophenone, 4-benzoyl-4′-methyl-diphenyl sulfide, acrylated benzophenone, 3,3′,4,4′-tetra(t-butyl peroxycarbonyl)benzophenone, and 3,3′-dimethyl-4-methoxybenzophenone;

thioxanthones, such as 2-isopropyl thioxanthone, 2,4-dimethyl thioxanthone, 2,4-diethyl thioxanthone, and 2,4-dichloro thioxanthone;

aminobenzophenones, such as Michler ketone and 4,4′-diethylaminobenzophenone; and

10-butyl-2-chloroacridone, 2-ethylanthraquinone, 9,10-phenanthrenequinone, and camphor quinone. Among those mentioned above, benzil dimethyl ketal is most preferable.

In the present invention, besides the polymerizable liquid crystal compound (PC1), a polyfunctional liquid crystal monomer may also be added. As this polyfunctional liquid crystal monomer, an acryloyloxy group, a methacryloyloxy group, an acrylamide group, a methacrylamide group, an epoxy group, a vinyl group, a vinyloxy group, an ethynyl group, a mercapto group, a maleimide group, ClCH═CHCONH—, CH₂═CCl—, CHCl═CH—, or RCH═CHCOO— (in this case, R represents chlorine, fluorine, or a hydrocarbon group having 1 to 18 carbon atoms) may be mentioned as a polymerizable functional group. However, among those mentioned above, an acryloyloxy group, a methacryloyloxy group, an epoxy group, a mercapto group, and a vinyloxy group are preferable, a methacryloyloxy group and an acryloyloxy group are particularly preferable, and an acryloyloxy group is most preferable.

As a molecular structure of the polyfunctional liquid crystal monomer, a monomer having a liquid crystal skeleton including at least two cyclic structures, a polymerizable functional group, and at least two flexible groups connecting the liquid crystal skeleton and the polymerizable functional group is preferable, and a monomer having 3 flexible groups is more preferable. As the flexible group, for example, an alkylene spacer group as represented by —(CH₂)ₙ— (in this case, n represents an integer of 1 to 30) or a siloxane spacer group as represented by —(Si(CH)₂—O)ₙ— (in this case, n represents an integer of 1 to 30) may be mentioned, and among those mentioned above, the alkylene spacer group is preferable. In a bonding portion between the flexible group and the liquid crystal skeleton or the polymerizable functional group, a bond, such as —O—, —COO—, or —CO—, may be incorporated.

For example, in order to improve the response speed of a liquid crystal composition, to improve the alignment stability, to decrease the threshold voltage, to suppress a decrease in response speed at a low temperature, and to stabilize a layer structure, nanoparticles, such as organic particles, inorganic particles, or organic-inorganic hybrid particles, may also be added. As the organic particles, for example, polymer particles, such as a polystyrene, a poly(methyl methacrylate), a poly(hydroxy acrylate), or divinylbenzene, may be mentioned. As the inorganic particles, for example, oxides, such as barium titanate (BaTiO₃), SiO₂, TiO₂, or Al₂O₃, and metals, such as Au, Ag, Cu, or Pd, may be mentioned. The organic particles and the inorganic particles may be hybrid particles formed by coating the surfaces thereof with a different material and may also be organic-inorganic hybrid particles formed by coating the surfaces of inorganic particles with an organic material. When the organic material applied to the surfaces of inorganic particles exhibits liquid crystal properties, it is preferable since liquid crystal molecules present around the particles are likely to be aligned.

Besides the above particles, for example, an antioxidant, an UV absorber, a non-reactive oligomer, an inorganic filler, an organic filler, a polymerization inhibitor, an antifoaming agent, a leveling agent, a plasticizer, and/or a silane coupling agent may be appropriately added, if needed. In addition, a biaxial compound, a trapping material for ions and polar compounds, and the like may also be contained.

As a molecular structure exhibiting biaxial properties of the biaxial compound, for example, a plate-shaped structure, a structure in which discs and rods are used in combination, a structure in which half-discs and rods are used in combination, a bent structure such as a banana-type liquid crystal, and a lateral connection (structure formed by connection between molecular side chains) are preferable, and as a concrete biaxial compound, compounds disclosed, for example, in J. Mater. Chem., 2010, 20, 4263, and The Chemical Record. Vol. 4, 10 (2004) may be mentioned.

In order to remove impurities and the like or to further increase the resistivity, the ferroelectric liquid crystal composition may be processed by a refining treatment with silica, alumina, and/or the like. As the resistivity of the liquid crystal composition, when drive is performed by THT, 10¹¹ Ω·cm or more is preferable, 10¹² Ω·cm or more is more preferable, and 10¹³ Ω·cm or more is more preferable. In addition, as a method for preventing the influence of cations present in the liquid crystal composition as impurities, a cation inclusion compound, such as a crown ether, a podand, a coronand, or a cryptand, may be added.

In order to maintain the performance of the liquid crystal optical element under low temperature environment, the ferroelectric liquid crystal composition preferably has a low temperature storage stability. As the low temperature storage stability of the liquid crystal composition, the SmC* is preferably maintained at 0° C. or less for 24 hours or more, more preferably at −20° C. or less for 500 hours or more, and even more preferably at −30° C. or less for 700 hours or more.

### <Ferroelectric Liquid Crystal Display Element>

In the liquid crystal optical element of the present invention, even if a pressing force is applied to the substrates, the layer normal direction of the SmC* phase when the ferroelectric liquid crystal composition is sandwiched between the substrates is 80° to 90° with respect to the substrate surface. In addition, a stable alignment can be obtained without having zigzag defects and the shevron structure as observed in SSFIC. Accordingly, even if a display is temporarily distorted by pressure application, a display restoring ability to restore a display after a pressure is released can be obtained. Hence, the liquid crystal optical element of the present invention is suitable for an apparatus which is operated by pressing a display screen, such as a touch panel.

The liquid crystal optical element may have a display restoring ability against a pressure of 1 kg (9.8 N) or less per 0.2 mm².

A display optical element using the ferroelectric liquid crystal of the present invention has a pair of pixel electrodes and a common electrode on at least one of a pair of substrates provided with two polarizing plates, polarizing planes of which are disposed orthogonal to each other, and between the two substrates, the ferroelectric liquid crystal composition of the present invention is sandwiched. An electric field is preferably applied to the display element in a direction parallel to the layer normal, and as an electrode structure which realizes the electric field as described above, an electrode structure having a comb structure such as an IPS (In-Plaine Switching) method is preferable. As in S-IPS (Super IPS), AS-IPS (Advanced Super IPS), IPS-Pro (IPS-Provectus), and the like, in view of decrease in drive voltage, improvement in image quality, increase in brightness, increase in ultrahigh brightness, and the like, it is preferable to control the direction of a lateral electric field applied in a direction parallel to the layer normal by bending the structure of a comb electrode or interdigitized electrode. Although a metal electrode may be used as the comb electrode, in order to increase use efficiency of light at an electrode portion, a transparent electrode formed, for example, of ITO, indium oxide-gallium-zinc (IGZO), or graphene is preferably used. To reduce the distribution of electric field intensity in a display element is preferable in view of decrease in drive voltage, improvement in response speed, increase in contrast, and improve in image quality. As a method for reducing the distribution of electric field intensity, the structure in which one pair of pixel electrodes and a common electrode are provided on each of a pair of substrates may also be formed.

In particular, the following method may be mentioned.

IPS, S-IPS, AS-IPS, or IPS-Pro electrodes are preferably provided on two of a pair of substrates, and an electrode projecting inside a cell is preferable as compared to a flat electrode since an element is formed so that the distribution of electric field intensity inside the cell is not likely to degrade. As a projecting electrode structure, a spherical shape, a semispherical shape, a cubic shape, a rectangular parallelepiped shape, a triangular prism shape, a trapezoid body shape, a circular cylindrical shape, a conical shape, a 3 to 20 polygonal cylindrical shape, a 3 to 20 polygonal prism shape, or an asymmetric shape may be used; the surface may be either flat or irregular; the corner of each electrode may be formed from either a curved line or a straight line; the height of the projection may be any one of 1/100, 1/10, 1/9, 1/8, 1/7, 1/6, 1/5, 1/4, 1/2, and 3/4 or more of the cell gap, or the projecting portion may be in contact with a counter electrode; the projecting electrode may be directly provided on the substrate or on a stage formed of a resin, an insulating material, a dielectric material, a semiconductor, or a composite thereof; and the pixel electrode may be provided at an upper portion, a middle portion, or a bottom portion of the stage.

Furthermore, as a concrete projecting electrode structure, for example, there have been used a structure (Japanese Unexamined Patent Application Publication No. 2007-171938) including a first substrate, a pair of electrodes each of which has a shape projecting in a thickness direction of the first substrate and which are provided on one surface side of the first substrate so as to be apart from each other, and a second substrate disposed so that one surface side faces the one surface side of the first substrate; a structure (Japanese Unexamined Patent Application Publication No. 2011-133876) in which a pixel electrode layer (first electrode layer) provided between a first substrate and a ferroelectric liquid crystal layer and common electrode layers (second electrode layers) are disposed so as not to be overlapped with each other, the pixel electrode layer is formed to cover an upper surface and a side surface of a rib-shaped first structural body provided to project from a surface of the first substrate at a ferroelectric liquid crystal layer side to the liquid crystal layer, and the common electrodes are each formed to cover an upper surface and a side surface of a rib-shaped second structure body provided to project from the surface of the first substrate at the ferroelectric liquid crystal layer side to the ferroelectric liquid crystal layer; a structure (Japanese Unexamined Patent Application Publication No. 2011-133874) in which a ferroelectric liquid crystal layer is sandwiched by pixel electrode layers having opening patterns, first common electrode layers having opening patterns (slits), and second common electrode layers having opening patterns (slits), the first and the second common electrode layers facing each other, and the pixel electrode layers are formed on upper portions of structural bodies provided to project from a surface of a first substrate at a ferroelectric liquid crystal layer side to the ferroelectric liquid crystal layer and are disposed therein between the first common electrode layers and the second common electrode layers; a structure (Japanese Unexamined Patent Application Publication No. 2005-227760) in which at least one pair of electrodes is provided so that the maximum electric field region is formed at a position apart from the substrate interface; and a structure (Japanese Unexamined Patent Application Publication No. 2011-8241) in which a first structural body is provided on a first electrode layer (pixel electrode layer), a second structural body is also provided on a second electrode layer (common electrode layer), and the first and the second structural bodies are each an insulating body having a dielectric constant higher than that of a liquid crystal material used for a liquid crystal layer and are formed so as to project to the liquid crystal layer. In addition, a structure in which recesses are formed in a substrate so as to actually enable pixel electrodes to project may also be used. For example, a double-penetrating fringe field (Journal of Display Technology, 287 to 289, Vol. 6, 2010) may also be used. Besides the above techniques, as a method for decreasing a drive voltage, a method using confined geometry (Lee, S.-D., 2009, IDW '09-Proceeding of the 16th International Display Workshots 1, pp. 111 to 112) in which a ferroelectric liquid crystal provided between electrodes is confined in a small resin space may be used, periodic corrugated electrodes (Appl. Phys. Lett. 96, 011102 (2010)) may be used, and one FFS (Fringe-Field Switching) electrode may be provided on at least one of a pair of substrate.

For two substrates of the liquid crystal cell, a transparent material, such as a glass or a plastic, having flexibility may be used, and for one substrate, an opaque material, such as silicon, may also be used. A transparent substrate having a transparent electrode layer can be obtained, for example, by sputtering indium tin oxide (ITO) on a transparent substrate, such as a glass. In order to enhance a realistic feeling in a large-scale television or the like, indium oxide-gallium-zinc (IGZO) having an electron mobility, which is an index indicating the mobility of electrons, faster than that of amorphous silicon by one order of magnitude is preferably used.

A color filter may be formed, for example, by a pigment dispersion method, a printing method, an electrodeposition method, or a dying method. For example, a method for forming a color filter by a pigment dispersion method is performed in such a way that, after a curable coloring composition for color filter is applied on a transparent substrate, a patterning treatment is performed, and subsequently, curing is performed by heating or light irradiation. This process is performed for each of three colors, red, green, and blue, so that pixel portions for color filter can be formed. In addition, on the substrate described above, pixel electrodes provided with active elements, such as TFTs, thin film diodes, or metal-insulator-metal resistivity elements, may be disposed.

The substrates are provided to face each other so that the transparent electrode is located therebetween. In this step, the distance between the substrates may be adjusted with spacers provided therebetween. In this case, the thickness of the cell to be obtained is preferably adjusted to be 1 to 100 μm. The cell thickness is more preferably 1 to 10 μm and even more preferably 2 to 4 μm.

When two polarizing plates are used, the polarizing axis of each polarizing plate may be controlled so as to obtain preferable viewing angle and contrast. When the polarizing plate is used, the product (Δnd) of refractive index anisotropy Δn of liquid crystal, and a cell thickness d is preferably controlled so as to maximize the contrast. In addition, in order to increase the viewing angle, a retardation film may also be used.

As a method for sandwiching the ferroelectric liquid crystal composition between two substrates, for example, a common vacuum injection method or an ODF method may be used. In this case, in a polymer stabilized ferroelectric liquid crystal composition, it is preferable when individual components are compatible with each other, and a uniform isotropic state or a (chiral) nematic phase is preferably obtained.

On each of the surfaces of the substrates which sandwiches a liquid crystal, an alignment layer may be provided on inner surface of cell. As the alignment layer, a common alignment layer, such as a polyimide, or an photoalignment layer may be used.

As the alignment layer, an alignment layer having a vertical alignment property is preferable.

A polyimide-based alignment layer having a vertical alignment property is preferable, and in particular, there may be mentioned a poly(amic acid) obtained by reaction among an acid anhydride substituted by an alkyl long chain or an alicyclic group, a diamine substituted by an alkyl long chain or an alicyclic group, and an acid dianhydride, or a polyimide obtained by dehydration ring-opening of the above poly(amic acid). When a film is formed on the substrate using a liquid crystal alignment agent formed of a polyimide, a polyamide, or a poly(amic acid), each having a bulky group as described above, a liquid crystal alignment layer having a vertical alignment property can be manufactured.

As the acid anhydride, for example, compounds represented by the following general formulas (VII-a1) to (VII-a3) may be mentioned. In addition, as the diamine, for example, compounds represented by the following general formulas (VII-b1) to (VII-b3) may be mentioned.

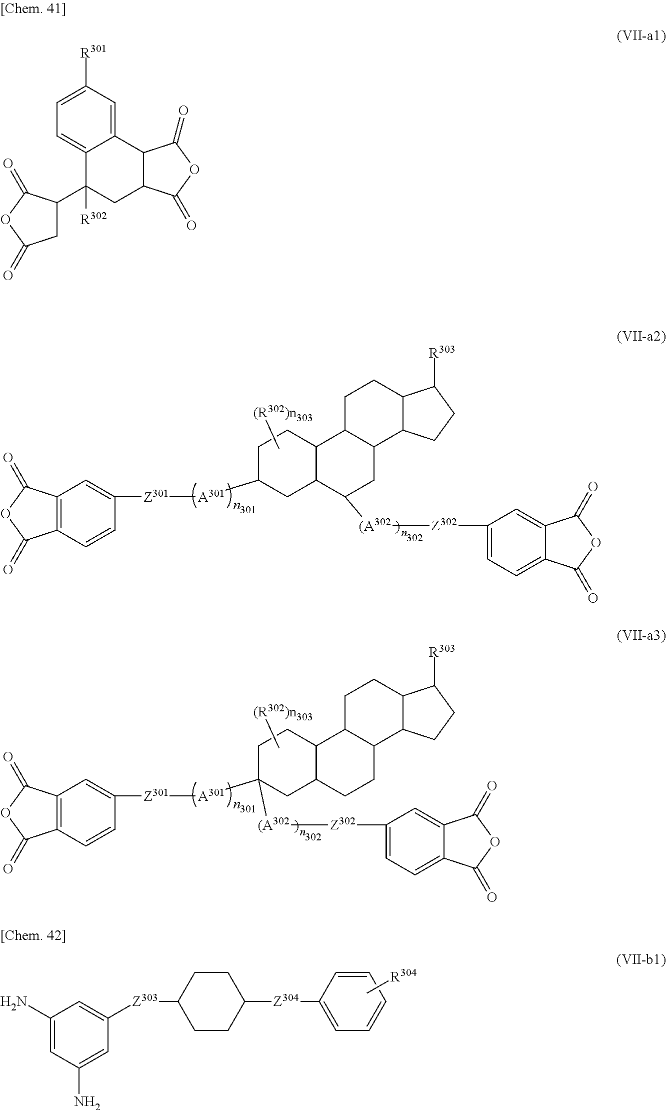

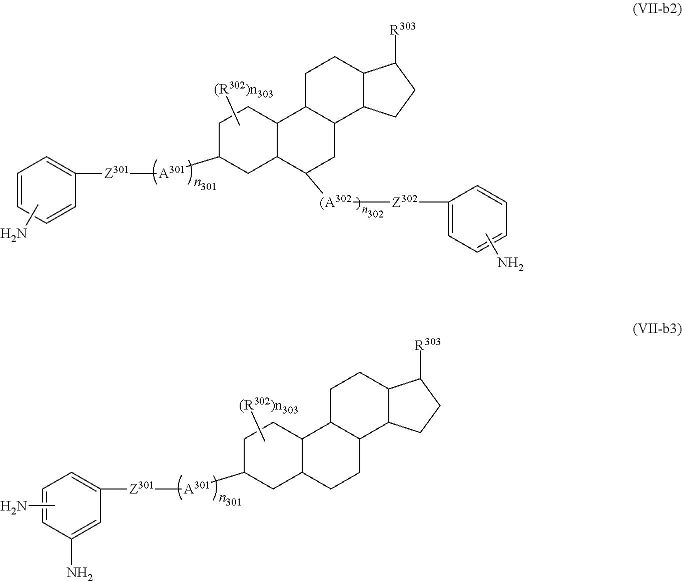

In the formulas (VII-a1) to (VII-a3) and (VII-b1) to (VII-b3), R³⁰¹, R³⁰², R³⁰³, and R³⁰⁴ each independently represent a linear or a branched alkyl group having 1 to 30 carbon atoms, a hydrogen atom, or a fluorine atom, one —CH₂— group or at least two —CH₂— groups which are not adjacent to each other of the alkyl group may be substituted by —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropyl group, or —Si(CH₃)₂—, and at least one hydrogen atom of the alkyl group may be substituted by a fluorine atom, a chlorine atom, a bromine atom, or a CN group;

Z³⁰¹, Z³⁰², Z³⁰³, and Z³⁰⁴ each independently represent —O—, —S—, —CO—, —CO—O—, —O—CO—, —O—CO—O—, —OCH₂—, —CH₂O—, —SCH₂—, —CH₂S—, —CF₂O—, —OCF₂—, —CF₂—S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond;

A³⁰¹ and A³⁰² each independently represent a cyclic group selected from a phenylene group, a cyclohexylene group, a dioxolanediyl group, a cyclohexenylene group, a bicyclo[2,2,2]octylene group, a piperidinediyl group, a naphthalenediyl group, a decahydronaphthalenediyl group, a tetrahydronaphthalenediyl group, or an indanediyl group, at least one —CH═ group in the ring of the above phenylene group, naphthalenediyl group, tetrahydronaphthalenediyl group, or indanediyl group may be substituted by a nitrogen atom, one —CH₂— group or two —CH₂— groups which are not adjacent, to each other in the ring of the above cyclohexylene group, dioxolanediyl group, cyclohexenylene group, bicyclo[2,2,2]octylene group, piperidinediyl group, decahydronaphthalenediyl group, tetrahydronaphthalenediyl group, or indanediyl group may be substituted by —O— and/or —S—, and at least one hydrogen atom of the above cyclic group may be substituted by a fluorine atom, a chlorine atom, a bromine atom, a CN group, or a NO₂ group or by an alkyl group having 1 to 7 carbon atoms, an alkoxy group, an alkyl carbonyl group, or an alkoxy carbonyl group, in each of which at least one hydrogen atom may be substituted by a fluorine atom or a chlorine atom; and

n³⁰¹ and n³⁰² each independently represent 0 or 1, and n³⁰³ represents an integer of 0 to 5.

In addition, in the general formulas (VII-a2) and (VII-a2) and (VII-b2) and (VII-b3), at least one —CH₂— group of the steroid skeleton may be substituted by —O— and/or —S—, and the steroid skeleton may have at least one unsaturated bond (C═C) at an arbitrary position.

In a lateral electric field-type liquid crystal display element in which an electric field is applied in a lateral direction, as a preferable mode of the alignment layer, when a poly(amic acid) or a polyimide having the structure represented by one of the following formulas (VII-c1) and (VII-c2) is used as a liquid crystal alignment agent, it is preferable since excellent residual image characteristics can be obtained, and light transmittance in a dark state with no electric field application can be decreased.

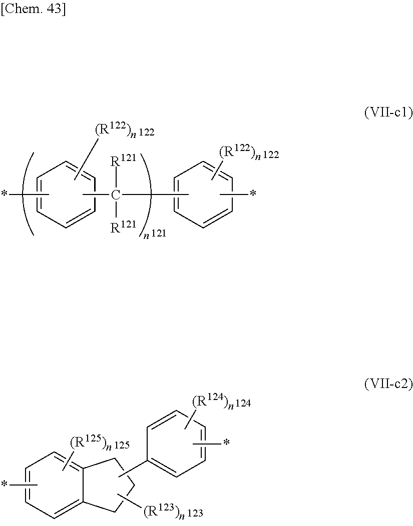

In the formula (VII-c1), R¹²¹ each independently represent an alkyl group having 1 to 6 carbon atoms, and R¹²² each independently represent an alkyl group having 1 to 6 carbon atoms, a halogen atom, a cyano group, a hydroxide group, or a carboxy group; and

n¹²¹ represents an integer of 1 to 10, n¹²² each independently represent an integer of 0 to 4, and “*” represents a chemical bond.

In the formula (VII-c2), R¹²³ each independently represent an alkyl group having 0.1 to 6 carbon atoms, and R¹²⁴ and R¹²⁵ each independently represent an alkyl group having 1 to 6 carbon atoms, a halogen atom, a cyano group, a hydroxide group, or a carboxy group; and

n¹²³ represents an integer of 0 to 5, n¹²⁴ represent an integer of 0 to 4, n¹²⁵ represent an integer of 0 to 3, and “*” represents a chemical bond.

A poly(amic acid) at least partially having the structure represented by the formula (VII-c1) and the structure represented by the formula (VII-c2) in its molecule may be obtained, for example, by a reaction of a tetracarboxylic acid dianhydride having the structure represented by the formula (VII-c1) and a tetracarboxylic acid dianhydride having the structure represented by the formula (VII-c2) with a diamine or by a reaction of a diamine having the structure represented by the formula (VII-c1) and a diamine having the structure represented by the formula (VII-c2) with a tetracarboxylic acid dianhydride.

As the tetracarboxylic acid dianhydride having the structure represented by (VII-c1) or the formula (VII-c2), in particular, there may be mentioned a compound in which benzene rings located at the two ends and having the chemical bonds each represented by “*” each represent a phthalic acid anhydride group.

As the diamine having the structure represented by (VII-c1) or the formula (VII-c2), in particular, there may be mentioned a compound in which benzene rings located at the two ends and having the chemical bonds each represented by “*” each represent an aniline group.

In addition, as the optical alignment layer, for example, there may be mentioned an optical alignment film which has the structure of azobenzene, stilbene, α-hydrazono-β-ketoester, cumarin, or the like and which uses photoisomerization; an photoalignment layer which has the structure of azobenzene, stilbene, benzylidene phthaldiimide, or cynnamoyl and which uses geometric photoisomerization; an photoalignment layer which has the structure of spiropyran, spirooxazine, or the like and which uses a photo ring-opening/closure reaction; an photoalignment layer which has the structure of cynnamoyl, calcon, cumarin, diphenylacetylene, or the like and which uses photodimerization; an photoalignment layer which has the structure of a soluble polyimide, a cyclobutane-type polyimide, or the like and which uses photodecomposition by light irradiation; and an photoalignment layer formed by light irradiation on a polyimide obtained through a reaction between biphenyl tetracarboxylic acid dianhydride and diamino diphenyl ether (BPDA/DPE).

The photoalignment layer may be manufactured by irradiating light having anisosropy on a coating film which contains a compound having an optical alignment group so as to align the optical alignment group and so as to fix the optical alignment state.

When the compound having an optical alignment group has a polymerizable group, after a light irradiation treatment is performed to impart a liquid crystal alignment ability, the polymerization is preferably performed. The polymerization method may be either photopolymerization or thermal polymerization. In the case of photopolymerization, a photopolymerization reaction is performed in such a way that a photopolymerization initiator is added to an optical alignment agent, and after a light irradiation treatment is performed, for example, light having a different wavelength is irradiated. On the other hand, in the case of thermal polymerization, a thermal polymerization reaction is performed in such a way that a thermal polymerization initiator is added to an optical alignment agent, and after a light irradiation treatment is performed, heating is performed.

In order to fix the optical alignment state of the photoalignment layer, an optically cross-linkable polymer may be used. As the optically cross-linkable polymer alignment film, the following compounds may be mentioned.

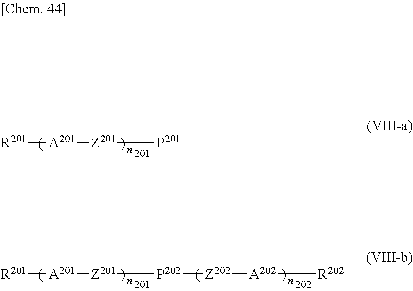

(In the formula, R²⁰¹ and R²⁰² each independently represent a linear or a branched alkyl group having 1 to 30 carbon atoms, a hydrogen atom, or a fluorine atom, at least one —CH₂— group of the alkyl group may be substituted by —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropyl group, or —Si(CH₃)₂— so that oxygen atoms or sulfur atoms are not directly bonded to each other, at least one hydrogen atom of the alkyl group may be further substituted by a fluorine atom, a chlorine atom, a bromine atom, or a CN group, the alkyl group may have a polymerizable group, the alkyl group may include a condensed or a spiro cyclic system, the alkyl group may include at least one aromatic or aliphatic ring which is able to include at least one hetero atom, and the rings described above may be arbitrarily substituted by an alkyl group, an alkoxy group, or a halogen;

Z²⁰¹ and Z²⁰² each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, and R^{a} of —CO—N(R^{a})— or —N(R^{a})—CO— represents a hydrogen atom or a linear or a branched alkyl group having 1 to 4 carbon atoms;

A²⁰¹ and A²⁰² each independently represent a cyclic group selected from a phenylene group, a cyclohexylene group, a dioxolanediyl group, a cyclohexenylene group, a bicyclo[2,2,2]octylene group, a piperidinediyl group, a naphthalenediyl group, a decahydronaphthalenediyl group, a tetrahydronaphthalenediyl group, or an indanediyl group, at least one —CH═ group in the ring of the above phenylene group, naphthalenediyl group, tetrahydronaphthalenediyl group, or indanediyl group may be substituted by a nitrogen atom, one —CH₂— group or two —CH₂— groups which are not adjacent to each other in the ring of the above cyclohexylene group, dioxolanediyl group, cyclohexenylene group, bicyclo[2,2,2]octylene group, piperidinediyl group, decahydronaphthalenediyl group, tetrahydronaphthalenediyl group, or indanediyl group may be substituted by —O— and/or —S—, and at least one hydrogen atom of the above cyclic group may be substituted by a fluorine atom, a chlorine atom, a bromine atom, a CN group, or a NO₂ group or by an alkyl group having 1 to 7 carbon atoms, an alkoxy group, an alkyl carbonyl group, or an alkoxy carbonyl group, in each of which at least one hydrogen atom may be substituted by a fluorine atom or a chlorine atom;

n₂₀₁ and n₂₀₂ each independently represent an integer of 1 to 3; and

P²⁰¹ and P²⁰² each independently represent an optical alignment group, such as cynnamoyl, cumarin, benzylidene phthaldiimide, calcon, azobenzene, or stilbene, P²⁰¹ represents a monovalent group, and P²⁰² represents a divalent group.

As a more preferable compound, for example, compounds represented by formula (VII-c) having a cynnamoyl group, formula (VII-d) having a cumarin group, and formula (VII-e) having a benzylidene phthaldiimide may be mentioned.

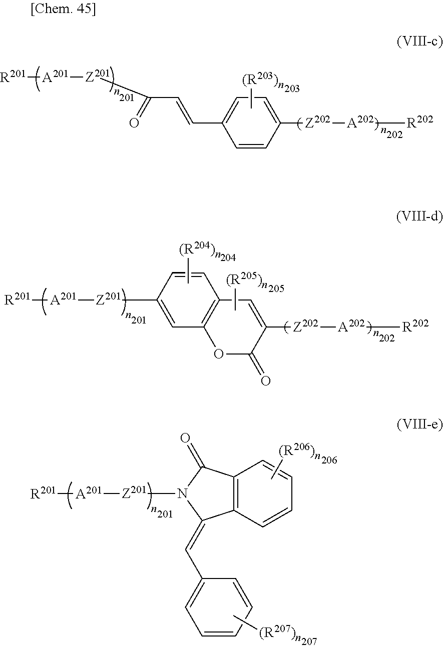

In the formulas (VII-c), (VII-d), and (VII-e), the definitions of R²⁰¹, R²⁰², A²⁰¹, A²⁰², Z²⁰¹, Z²⁰², n₂₀₁ and n₂₀₂ are the same as those of the formulas (VII-a) and (VII-b); R²⁰³, R²⁰⁴, R²⁰⁵, R²⁰⁶, and R²⁰⁷ each independently represent a halogen atom (F, Cl, Br, or I), a methyl group, a methoxy group, —CF₃, —OCF₃, a carboxy group, a sulfo group, a nitro group, an amino group, or a hydroxy group; and

n²⁰³ represents an integer of 0 to 4, n²⁰⁴ represents an integer of 0 to 3, n²⁰⁵ represents an integer of 0 or 1, n²⁰⁶ represents an integer of 0 to 4, and n²⁰⁷ represents an integer of 0 to 5.

Although a light source of the liquid crystal display element is not particularly limited, in consideration of low power consumption, an LED is preferable. An LED is preferably disposed along a short side of the liquid crystal display element as compared to along a long side thereof, is preferably provided at one side as compared to at two sides, and is more preferably provided only at a corner of the liquid crystal display element. Furthermore, in order to suppress the power consumption, for example, a blinking control (technique to decrease light quantity or turn off light in a dark region), a multi-field drive technique (technique to discriminate a drive frequency for a moving image display and that for a still image display), a technique to switch a light quantity mode between the inside and the outside of a building or between night and day, and a technique to temporarily stop drive using a memory function of the liquid crystal display element are preferably used. In addition, since outdoor light (sunlight and/or interior light) can be used, a reflective type display element is preferable although having no light source. In order to prevent the loss of light emitted from a light source, a light guide plate and/or a prism sheet is preferably used. The light guide plate and/or the prism sheets preferably uses an association resin, and as a transparent resin, for example, a methacrylic resin (PMMA or the like), a polycarbonate resin, an ABS resin (acrylonitrile-styrene-butadiene copolymer resin), an MS resin (methyl methacrylate-styrene copolymer resin), a polystyrene resin, an AS resin (acrylonitrile-styrene copolymer resin), a polyolefin resin (polyethylene, polypropylene, or the like), and a cyclic polyolefin may be mentioned.

As for the improvement in contrast, a blinking control (technique to decrease light quantity or turn off light in a dark region), an element having an aperture ratio of 50% or more, an alignment film having high alignment characteristics, and/or an antiglare film may be used, or a field sequential method (coloring method in which without using a color filter, LEDs of three RGB colors are sequentially turned on for a time within one frame of displaying image shorter than human eyes' time resolution so as to enable a viewer to recognize a color) may be preferably used. In order to increase the aperture ratio, the size of the active element is preferably decreased, and a semiconductor having a high mobility of 600 cm²/Vs or more is preferably used to reduce the size of the active element.

For the rapid response performance, it is preferable to use an overdrive scheme (voltage for gray scale display is increased to obtain fast switching time), to impart a pretilt to the substrate, or to use a ferroelectric liquid crystal having negative dielectric anisotropy.

The liquid crystal display element of the present invention may also be used as a touch panel display element for tablet PC application, and in this case, the display element preferably has an impact resistance, a vibration resistance, hydrophobic and lipophobic characteristics, a stain resistance, and a finger print resistance. In applications, such as an ATM (automatic teller machine), an automatic vending machine, an automatic ticketing machine, a toilet monitor, a copying machine, and a public phone, which many unspecified people use, and also in medical, nursing care, and baby-related applications, the display element preferably has a virus resistance against viruses, such as a flu virus, a norovirus, and an RS virus, and a bacterial resistance against salmonella, Bacillus coli, Staphylococcus aureus, and the like and more preferably has a solvent resistance, an acid resistance, an alkaline resistance, and a heat resistance which are required for cleaning, such as sterilization, of the display element. In applications for warehouses, transportation/distribution, manufacturing, maintenance works, construction sites, marine survey, fire fighting/police, lifesaving (rescue), accident prevention, and the like, the display element preferably has characteristics, such as a dust resistance, a water resistance, a salt resistance, an explosion resistance, and a radiation resistance and more preferably satisfies Europe Explosion Protection Regulation (ATEX Zone2 Category3), water-proof and dust-proof execution (IP65), and US military standard (MIL-STD-810F).

The impact resistance is preferably used for a display element which is required to pass a 3-foot drop test performed onto a concrete floor, an impact-resistance magnesium alloy or a multilayer magnesium alloy is preferably used for a case of the display element, and in order to secure the impact resistance and the vibration resistance, a SSD is preferably used for storage. In order to enhance the visibility even in an outdoor environment under direct sunlight, Dual-Mode Allvue™ Xtreme Technology is preferably used.

In order to suppress the degradation in display quality caused by stains, a film having hydrophobic and lipophobic characteristics, a stain resistance, a finger print resistance, finger-print erasing characteristics, and the like is preferably used, a transparent base film is preferably used as a base material of the film, and in particular, as a resin material forming the transparent base film, there may be mentioned an acrylic resin, such as a poly(meth)acrylate, a cellulose resin, such as a triacetate cellulose (TAC), a diacetyl cellulose, or a cellophane, a polyester resin, such as a poly(ethylene terephthalate) (PET) or a poly(ethylene naphthalate), a polyamide resin, such as a 6-nylon, a polyolefin resin, such as a polyethylene or a polypropylene, an organic polymer, such as a polystyrene, a poly(vinyl chloride), a polyimide, a poly(vinyl alcohol), a polycarbonate, or an ethylene vinyl alcohol, an epoxy resin, a urethane resin, or a copolymer resin, such as an ABS resin (acrylonitrile-styrene-butadiene copolymer resin), an MS resin (methyl methacrylate-styrene copolymer resin), or an acrylonitrile-styrene. Among those mentioned above, in view of the versatility, a triacetate cellulose (TAC)-based resin and a poly(ethylene terephthalate) (PET)-based resin are preferable.

In order to enhance a scratch resistance, a hard coat film or a self-restoring coat film is preferably applied to the film. As a resin contained in a hard coat-layer forming composition, although known resins may be used, in consideration of improvement in surface hardness, an ionizing radiation curable resin is preferably contained.

As the ionizing radiation curable resin, for example, there may be mentioned a polyfunctional acrylate, such as an acrylate ester or a methacrylate ester of a polyalcohol, or a polyfunctional urethane acrylate synthesized, for example, from diisocyanate and a hydroxy ester between a polyalcohol and acrylic acid or methacrylic acid. In addition, besides the above resins, for example, a polyether resin, a polyester resin, an epoxy resin, an alkyd resin, a spiro acetal resin, a polybutadiene resin, and a polythiol-polyene resin, each of which has an acrylate functional group, may also be mentioned. Among those mentioned above, in consideration of the improvement in surface hardness, a polyfunctional (meth)acrylic monomer is preferably used. In this case, as the polyfunctional (meth)acrylic monomer, an ester compound is preferable which is formed in such a way that a polyalcohol having at least two alcoholic hydroxides in its molecule is allowed to react at the alcoholic hydroxides thereof with at least two (meth)acrylic acid molecules. Besides the above compound, for example, a compound in which a reactive acrylic group is bonded to an acrylic resin skeleton, a poly(ester acrylate), a urethane acrylate, an epoxy acrylate, and a poly(ether acrylate) may also be mentioned. In addition, for example, a compound in which an acrylic group is bonded to a rigid skeleton, such as melamine or isocyanuric acid, may also be used. In addition, the polyfunctional (meth)acrylic monomer of the present invention may also be an oligomer. As commercially available polyfunctional acrylic monomers, for example, products sold by Mitsubishi Rayon Co., Ltd. (trade name: “Diabeam” series and the like), Nagase ChemteX Corp. (trade name: “Denacol” series and the like), Shin-Nakamura Chemical Co., Ltd. (trade name: “NK Ester” series and the like), Dainippon Ink and Chemicals Inc. (trade name: “UNIDIC” series and the like), Toagosei Co., Ltd. (trade name: “Alonix” series and the like), NOF Corp. (trade name: “Blenmer” series and the like), Nippon Kayaku Co., Ltd. (trade name: “KAYARAD” series and the like), and Kyoeisha Chemical Co., Ltd. (trade name: “Light Ester” series, “Light Acrylate” and the like) may be used.

In addition, as another ionizing radiation curable resin, a fluorine-containing compound having a polymerizable group may be mentioned. Since the hard coat-layer forming composition contains a fluorine-containing compound having a polymerizable group, the stain resistance can be imparted to the surface of a hard coat layer formed from the hard coat-layer forming composition. When a fluorine-based additive having no polymerizable group is used, since being present in a floating state on the surface of the hard coat layer, the additive is removed from the surface thereof by wiping with a cloth or the like. Hence, when the surface is wiped once with a cloth or the like, the stain resistance is disadvantageously lost. Accordingly, when a fluorine compound having a stain resistance is modified to have a polymerizable group, the fluorine additive can be simultaneously polymerized when the hard coat layer is formed, and as a fluorine-containing compound which has a polymerizable group and an advantage of maintaining a stain resistance even if the surface is wiped out with a cloth or the like, a compound having a (meth)acrylate group as a polymerizable group is more preferable. The reason for this is that copolymerization can be performed with a polyfunctional (meth)acrylate monomer, and by radical polymerization with ionizing radiation, an increase in hardness can be achieved. As the fluorine-containing compound having a polymerizable group, a compound having a (meth)acrylate group as a polymerizable group is more preferable. The reason for this is that copolymerization can be performed with a polyfunctional (meth)acrylate monomer, and by radical polymerization with ionizing radiation, an increase in hardness can be achieved. As the fluorine-containing compound having a polymerizable group described above, for example, there may be mentioned Optool DAC (manufactured by Daikin Industries, Ltd.), SUA1900L10 and SUA1900L6 (manufactured by Shin-Nakamura Chemical Co., Ltd.), UT3971 (manufactured by The Nippon Synthetic Chemical Industry Co., Ltd.), DefensaTF3001, DefensaTF3000, and DefensaTF3028 (manufactured by Dainippon Ink and Chemicals Inc.), Light Procoat AFC3000 (manufactured by Kyoeisha Chemical Co., Ltd.), KNS5300 (manufactured by Shin-Etsu Silicone Co., Ltd.), and UVHC1105 and UVHC8550 (manufactured by GE Toshiba Silicones Co., Ltd.). The use amount of the fluorine-containing compound having a polymerizable group is preferably 0.01 to 10 percent by weight with respect to the polyfunctional (meth)acrylic monomer of the hard coat-layer forming composition. When the amount is less than 0.01 percent by weight, a sufficient stain resistance cannot be obtained, and a surface energy is high, such as more than 20 mN/m, and when the amount is more than 10 percent by weight, since the compatibility with a polymerizable monomer and a solvent is inferior, whitening of a coating solution and precipitation occur, so that problems, such as defect generation of the coating solution and the hard coat layer, may arise in some cases.

The hard coat-layer forming composition preferably contains a photoradical polymerization initiator to initiate a polymerization reaction of the above ionizing radiation curable resin. The photoradical polymerization initiator generates radicals by irradiation of ionizing radiation and initiates the polymerization reaction of the above ionizing radiation curable resin. As particular examples of the photoradical polymerization initiator, for example, there may be used carbonyl compounds, such as acetophenone, 2,2-diethoxyacetophenone, p-dimethylacetophenone, p-(dimethylamino)propiophenone, benzophenone, 2-chlorobenzophenone, 4,4′-dichlorobenzophenone, 4,4′-bis(diethylamino)benzophenone, Michler ketone, benzil, benzoin, benzoin methyl ether, benzoin ethyl ether, benzoin isopropyl ether, p-isopropyl-α-hydroxyisobutylphenone, α-hydroxyisobutylphenone, 2,2-dimethoxy-2-phenylacetophenone, and 1-hydroxycyclohexyl phenyl ketone, and sulfur compounds, such as tetramethylthiuram monosulfide, tetramethylthiuram disulfide, thioxanthone, 2-chlorothioxanthone, and 2-methylthioxanthone. Those photopolymerization initiators may be used alone, or at least two types thereof may be used in combination. The use amount of the photoradical polymerization initiator is, with respect to the ionizing radiation curable resin of the hard coat-layer forming composition, appropriately 0.01 to 10 percent by weight. When the amount is less than 0.01 percent by weight, a sufficient curing reaction does not proceed by irradiation of ionizing radiation, and when the amount is more that 10 percent by weight, the ionizing radiation does not reach a lower portion of the hard coat layer.

Besides the components described above, if necessary, the hard coat-layer forming composition may contain, within the range in which the reaction by ionizing radiation is not disturbed, a modifier to improve the characteristics of the hard coat layer and/or a thermal polymerization inhibitor which inhibits thermal polymerization in manufacturing of a hard coat film and/or a dark reaction of the hard coat-layer forming composition during storage. As the modifier, for example, a coating improver, an antifoaming agent, a thickener, an anti-static agent, an inorganic filler, an organic filler, an organic lubricant, an organic polymer compound, an UV absorber, an optical stabilizer, a dye, a pigment, and a stabilizer may be mentioned. The content of the modifier is, in 100 percent by weight of the solid component of the hard coat-layer forming composition, preferably 0.01 to 5 percent by weight. As the thermal polymerization inhibitor, for example, hydroquinone, hydroquinone monomethyl ether, or 2,5-t-butyl hydroquinone may be mentioned. The content of the thermal polymerization initiator is, in 100 percent by weight of the solid component of the hard coat-layer forming composition, preferably 0.005 to 0.05 percent by weight.

In addition, in order to impart an antiglare function to the hard coat layer, the hard coat-layer forming composition may contain various types of particles. As the particles, for example, organic particles, such as acrylic particles, acrylic-styrene particles, polystyrene particles, polycarbonate particles, and melamine particles, and inorganic particles, such as silica particle talc, various types of aluminosilicates, kaolin clay, and MgAl hydrotalcite, may be mentioned. As the average particle diameter of the above particles, 0.5 to 10 μm is preferable, and in this case, the average film thickness of the hard coat layer is preferably 2 to 20 μm. When the average particle diameter of the particles is less than 0.5 μm, irregularities are difficult to be formed on the surface of the hard coat layer. On the other hand, when the average particle diameter of the particles is more than 10 μm, the texture of a hard coat film to be obtained becomes coarse, and hence, a hard coat film which is not suitable for a highly fine display surface may be formed in some cases. In addition, when the average film thickness of the hard coat layer is less than 2 μm, a scratch resistance sufficient for the display surface may not be obtained in some cases. On the other hand, when the average film thickness of the hard coat layer is more than 20 μm, the degree of curling of a hard coat film to be manufactured is increased, and hence handling thereof may become difficult in some cases.

In view of the scratch resistance, a film having a self-restoring function is also preferably applied, a film is preferably self-restored by its elastic modulus even if being scratched, and for example, “magic film” (Suncrest) or the like may be applied.

For the virus resistance and bacterial resistance, methods using an optical catalyst and/or Ag particles are preferably used, inorganic particles, such as titanium oxide, are preferably used as the optical catalyst, nanoparticles are more preferably used as the Ag particles, and a ceramic composite material, such as e⁺ (Earth Plus), having an optical decomposition ability is preferable for the virus resistance. When being not transparent, a coating or a film exhibiting the virus resistance and/or bacterial resistance is preferably applied to a portion other than a display portion, and when being transparent, the coating or the film mentioned above is preferably applied to the entire display element.

For the finger print resistance, a compound having an oil-repellent property is preferably added to the film, and a compound having a fluorinated substituent or a perfluoro group, such as a perfluoropolyether acrylate compound, is preferably added to the film. Alternatively, a functional film, such as “ClearTouch” (NOF Chemical) or Anti fingerprint (registered trade mark) Film (Tsujiden Co., Ltd.) may also be applied.

As the function of the display element of the present invention, a triaxial gyroscope, an acceleration sensor, an ambient light sensor, mobile phone communication such as Wi-Fi or 3G, a digital compass, and a GPS function are preferable.

As a UPU used for a tablet PC using the display element of the present invention, a unit which consumes a low power, generates a small heat quantity, and performs a large number of operations is preferable, a single core and a dual core are preferable, and a quad core, an 8-core, a 12-core, a 24-core, a 48-core, a 96-core, and a 192-core are more preferable.

In addition, the display element of the present invention preferably has a communication function to control a notebook personal computer, a mobile phone, a smart phone, a tablet PC, a monitor, a measuring instrument, a home appliance, such as a house air conditioner, a television, a washing machine, a rice cooker, a component stereo, a portable music player, a home solar cell, or a home fuel cell, a hybrid car, an electric car, a nursing robot, a nursing body suit, and a robot or an observation apparatus to be used for disasters, such as an earthquake, a fire, a flood disaster, a landslide, an eruption, a pyroclastic flow, an avalanche of earth and rocks, a guerrilla rainstorm, a nuclear reactor accident, and a nuclear reactor phenomenon. The communication is preferably performed through mobile LAN, such as Wi-Fi, 3G, fourth-generation mobile communication, fifth-generation mobile communication, or sixth-generation mobile communication, high speed networks, telephone lines, Internet, Bluetooth, and infrared rays. The display element of the present invention preferably has a function to control a next-generation power transmission system, such as a smart grid, a smart city, or a smart town, in which “centralized power generation” such as thermal power generation and/or nuclear power generation and “distributed power generation” which separately performs power generation at various places close to power consumption areas are efficiently controlled using a leading-edge IT technology, and is preferably used as an information terminal which controls at any time and at any place, electric power generated by thermal power generation, hydraulic power generation, nuclear power generation, wind power generation, geothermal power generation, solar cell power generation, geothermal power generation, fuel cell power generation, ocean current power generation, wave power generation, piezoelectric power generation, recyclable energy, and/or the like, and which also controls at any time and at any place, an automobile, an electric car, a work, a housing, a hospital, a school, a public office, a lighting device, an air conditioner, a machine, an apparatus, a home appliance, and the like, each of which is driven by using the electric power generated as described above. In addition, the display element of the present invention is preferably used for an electronic book, an electronic textbook, an electronic medical record, an electronic notebook, or the like, and a touch panel type in which a pressing force is applied by a finger, a pen input, or the like is most preferable.

Even if a pressure of 1 kg or less is pressed as the pressing force to the surface of the display element by a pointed front end, such as a mechanical pencil having an area of 0.2 mm² or a stylus pen for a tablet PC, the display is preferably restored; the display is preferably restored even when the surface of the display element is pressed by a thumb, an index finger, or the like; the display is preferably restored even when a pressure of 2 kg or less is applied by a finger having an area of 4×3 cm² or less; and resistance against repeated pressure cycles is preferably 10,000 times or more, 100,000 times or more, and 100,000 times or more and is more preferably 10,000,000 times or more.

Although the display element of the present invention may be used for a stationary type display element, such as a desktop personal computer, a small, a medium, or a large control apparatus, or an automatic vending machine, in addition to that, the display element may also be used for a digital signage (electronic signage), point of purchase advertising (POP), an electronic time table, an electronic display board, an electronic price tag, an electronic black board, an instrumental display, or the like. As the display surface, either one surface or two surfaces may be used, and a sea-through display may also be used. In particular, preferably, a touch panel system in which a pressing force is applied, for example, by a finger or a pen input is most preferable. In order to readily use the display element at any time and at any place, the form of a notebook personal computer, a tablet PC, a smart phone, or a mobile phone is preferable, and in particular, preferably, a touch panel type display element in which a pressing force is applied, for example, by a finger or a pen input is most preferable.

The liquid crystal display element may be a flexible display element, and in this case, as an electrode substrate, a flexible substrate, such as a plastic substrate or a thin film glass substrate, is preferably used. As the electrode, a flexible electrode material, such as a graphene (sheet formed of a carbon monoatomic layer) or an organic semiconductor, is preferably used.

The structure of an organic TFT is preferably a top contact or a bottom contact and more preferably a bottom gate/bottom contact type. As an organic semiconductor functioning as a key material, for example, an polycyclic aromatic compound, such as a metal (Cu, Pb, or Ni) phthalocyanine derivative, a metal porphyrin derivative, a pentacene derivative, an anthracene derivative, a tetracene derivative, an anthradithiophene derivative, a hexabenezocoronene derivative, or a rubrene derivative; a low molecular weight compound, such as tetracyanodiquimethane; a polymer, such as a polyacetylene, a poly-3-hexylthiophene (P3HT), a poly(p-phenylene vinylene) (PPV), a polyfluorene, or a polypyrrole; a polythiophene derivative, a perylene tetracarboxylic diimide derivative (PTCDI), a perylene tetracarboxylic acid dianhydride derivative (PTCDA), a fluorine-substituted phthalocyanine derivative, carbon nanotubes, a polyaniline derivative, a graphene, a naphthalene tetracarbonyl compound, a perylene tetracarbonyl compound, a quaterrylene tetracarbonyl compound, a fullerene compound, or a hetero 5-membered cyclic compound (such as an oligothiophene or a TTF derivative) is preferable, and pentacene is more preferable. In addition, those organic semiconductors each may be doped, and a polypyrrole doped with iodine and a polyacetylene doped with iodine are preferable. In order to improve the characteristics of the organic semiconductor compound, the alignment of molecules is preferably enhanced, and an organic semiconductor compound obtained by imparting liquid crystal properties to the above compound is preferably used. Those liquid crystal organic semiconductor compounds each may be any one of a low molecular weight compound, a high molecular weight compound, and a supramolecular weight compound and each preferably has a columnar structure or a layer structure to transport electrons or holes.

For manufacturing of a graphene material, either a top down or a bottom up may be used, any one of a scotch tape method, a modified Hummers method, and a supercritical method may be used for the top down, and either a thermal CVD method or a method for growing a graphene on SiC may be used for the bottom up. The formation of a transistor using a graphene is preferably performed by a peeling and transfer method, a CVD and transfer method, or a SiC surface pyrolytic method, and when manufacturing is performed at a low temperature, a technique is preferable in which a graphene is formed on an insulating substrate by CVD at a low temperature of 650° C. so as to directly form a graphene transistor over the entire surface of the substrate (Fujitsu Laboratories). In order to obtain a monolayer graphene sheet having a large area and a high carrier mobility, a method in which a graphene film is formed on a thin Cu film by CVD and is then transferred to another substrate is preferable, and in particular, a method is preferable in which after a Cu film is adhered to the inside of a cylindrical quartz tube having a diameter of 8 inches or more, and CVD is performed on the film, the Cu film is recovered and is then tightly adhered to a polymer film, followed by performing peeling (X. Li et al., Science, 324, 1312 to 131.4 (2010)).

Gold, platinum/gold, and a polymer material are preferably used of a gate electrode, a source and a drain electrode, and a gate insulating film and a passivation film, respectively, and after all layers other than the passivation film are formed, a pentacene film is preferably formed by deposition. In order to improve the performance of an organic TFT, the control of the interface of the pentacene with the organic gate insulating film and the electrode is important, and for example, it is preferable to increase the mobility by addition of a silane coupling agent into the organic insulating film so as to impart hydrophobic properties thereto and/or to form an electrode having a laminate structure so as to decrease the contact resistance of the pentacene with the source and the drain electrodes. Fine and precise integration between the organic TFT and an organic EL having a top emission structure is preferable as a display element.

Furthermore, as a method for manufacturing a display element using an organic semiconductor, a printing method (printable electronics) is preferable, and a graphene transistor formed by a printing method is preferably used. For a printing wire used for a flexible display element, a metal nanoparticles material, such as nano silver particles or nano copper particles, is preferably used. In addition, as a printing method which can obtain an organic semiconductor superior to amorphous silicon, a “double shot” printing method is preferable in which an ink dissolving an organic semiconductor and an ink promoting crystallization thereof are alternately dripped, and in this case, as a semiconductor ink, C8-BTBT (dioctyl benzothieno benzothiophene) is preferable (Nature 475, 364 to 367, 21 Jul. 2011).

The liquid crystal display element may also perform 3D display, for example, by time division, such as a field sequential method; space division, such as a polarization method, a parallax barrier method, or an integral imaging method; wavelength division, such as a spectroscopic method or anaglyph; or a FPS mode.

In order to improve the vibration resistance and impact resistance, which are required due to the reduction in number of components of a liquid crystal display element (cost reduction) and the reduction in number of portions to be connected to outside circuits, SOG (System on Glass) is preferable. As circuits mounted on a glass substrate, a DAC, a power amplifier, a logic circuit, a microprocessor, and a memory, each of which is supplied as an IC or an LSI, are mentioned, and a peripheral circuit mounted on a glass substrate is preferable which is systematically formed thereon by mounting a liquid crystal control circuit, a power source circuit, an input/output interface circuit, a signal processing circuit, a power amplifier, and the like.

### EXAMPLES

Hereinafter, although the present invention will be described in detail with reference to examples, the present invention is not limited only to those examples. In addition, unless otherwise noted, “%” indicates “percent by weight”.

### (Preparation of Ferroelectric Liquid Crystal Composition)

A ferroelectric liquid crystal composition (Composition 1) of Example 1 was prepared by blending a ferroelectric liquid crystal composition LC-1 (total 65%) and 35% of a chiral compound (CH-1).

A ferroelectric liquid crystal composition (Composition 2) of Example 2 was prepared by blending the ferroelectric liquid crystal composition LC-1 (total 65%) and 35% of a chiral compound (CH-2).

A ferroelectric liquid crystal composition (Composition 0.3) of Example 3 was prepared by blending the ferroelectric liquid crystal composition LC-1 (total 65%) and 35% of a chiral compound (CH-3).

A ferroelectric liquid crystal composition (Composition 4) of Example 4 was prepared by blending the ferroelectric liquid crystal composition LC-1 (total 65%), 10% of a chiral compound (CH-4), 15% of a chiral compound (CH-5), and 10% of a chiral compound (CH-6).

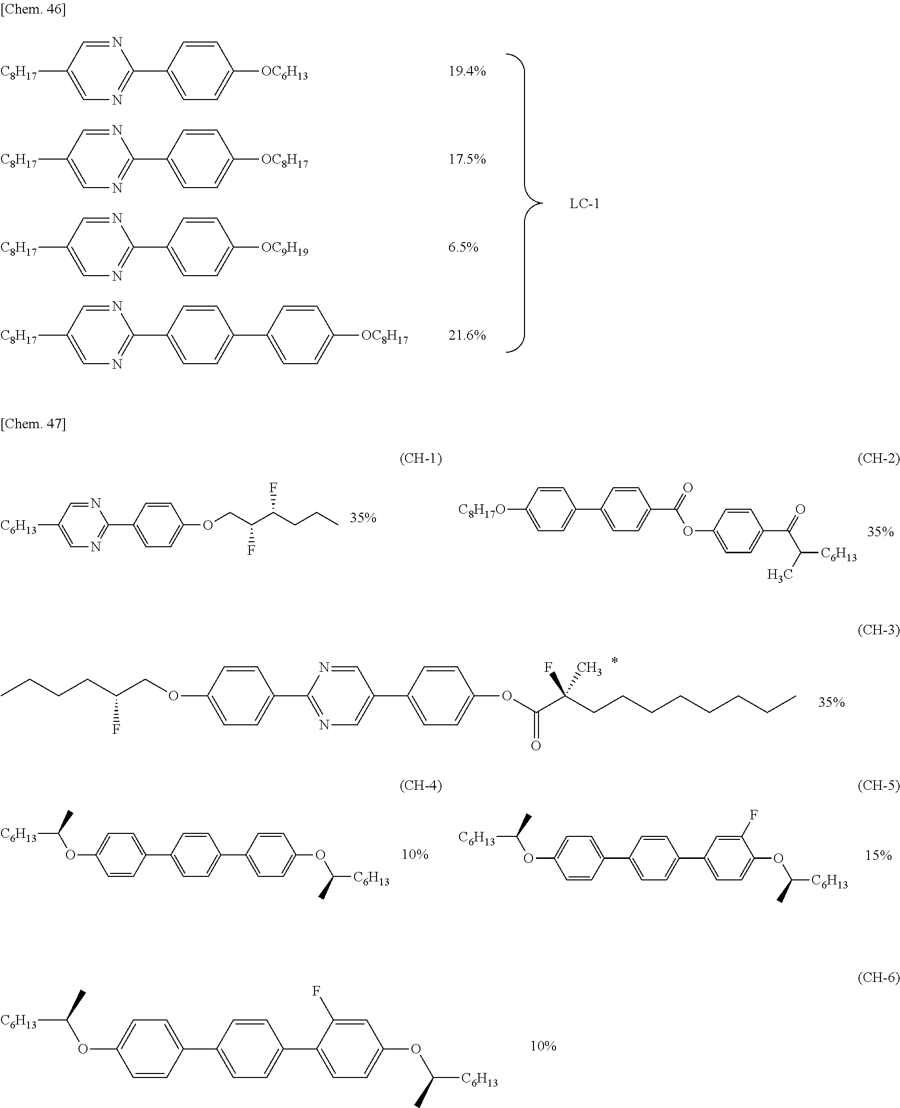

A ferroelectric liquid crystal composition (Composition 5) of Comparative Example 1 was prepared by blending a ferroelectric liquid crystal composition LC-2 (total 65%) and 35% of the chiral compound (CH-1).

A ferroelectric liquid crystal composition (Composition 6) of Comparative Example 2 was prepared by blending the ferroelectric liquid crystal composition LC-2 (total 65%) and 35% of the chiral compound (CH-2).

A ferroelectric liquid crystal composition (Composition 7) of Comparative Example 3 was prepared by blending the ferroelectric liquid crystal composition LC-2 (total 65%) and 35% of the chiral compound (CH-3).

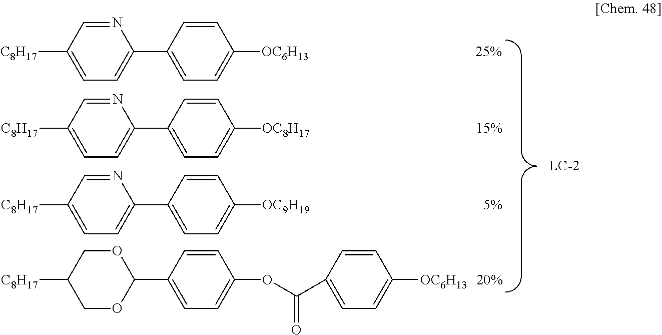

In addition, in the formulas LC-1, LC-2, CH-1, and CH-2, C₆H₁₃, C₈H₁₇, and C₉H₁₉ each represent a linear alkyl group.

A ferroelectric liquid crystal composition (Composition 1M) of Example 5 was prepared by blending the ferroelectric liquid crystal composition (total 94 parts) described in Example 1 and the following monomer mixture (total 6.12 parts).

A ferroelectric liquid crystal composition (Composition 2M) of Example 6 was prepared by blending the ferroelectric liquid crystal composition (total 94 parts) described in Example 2 and the following monomer mixture (total 6.12 parts).

A ferroelectric liquid crystal composition (Composition 3M) of Example 7 was prepared by blending the ferroelectric liquid crystal composition (total 94 parts) described in Example 3 and the following monomer mixture (total 6.12 parts).

A ferroelectric liquid crystal composition (Composition 4M) of Example 8 was prepared by blending the ferroelectric liquid crystal composition (total 94 parts) described in Example 4 and the following monomer mixture (total 6.12 parts).

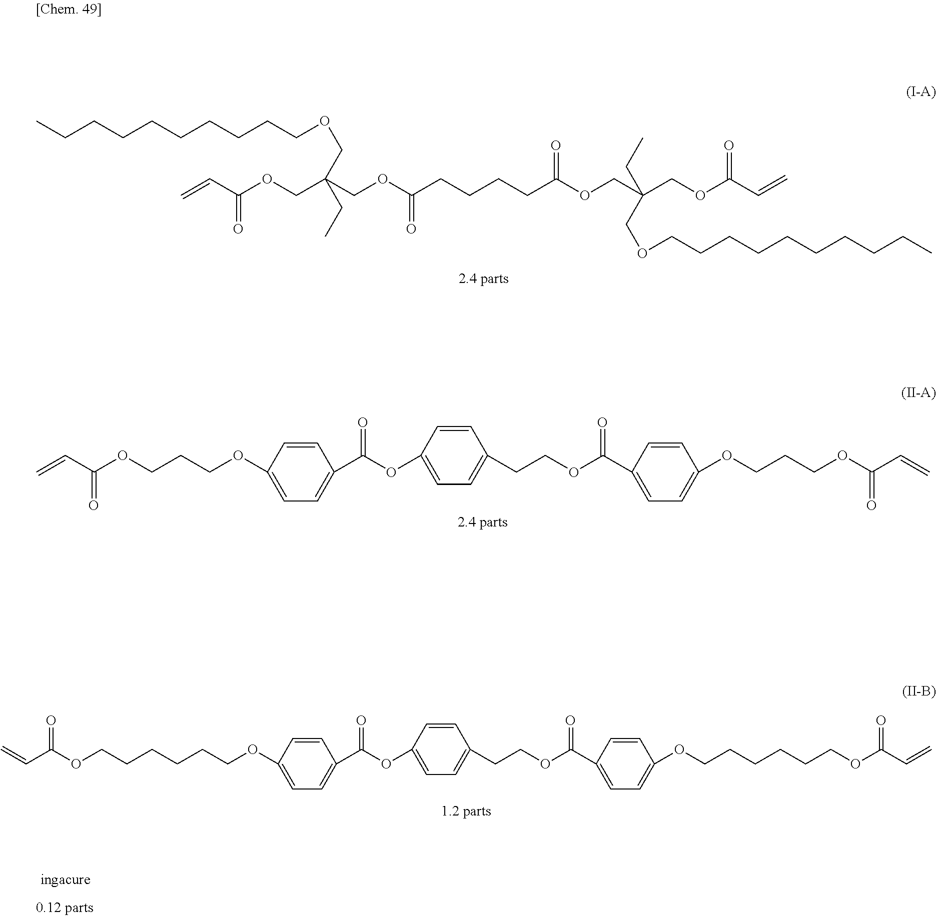

A ferroelectric liquid crystal composition (Composition 5M) of Comparative Example 4 was prepared by blending the ferroelectric liquid crystal composition (total 94 parts) described in Comparative Example 1 and the following monomer mixture (total 6.12 parts).

A ferroelectric liquid crystal composition (Composition 6M) of Comparative Example 5 was prepared by blending the ferroelectric liquid crystal composition (total 94 parts) described in Comparative Example 2 and the following monomer mixture (total 6.12 parts).

A ferroelectric liquid crystal composition (Composition 7M) of Comparative Example 6 was prepared by blending the ferroelectric liquid crystal composition (total 94 parts) described in Comparative Example 3 and the following monomer mixture (total 6.12 parts).

### (Formation of Liquid Crystal Display Element)

By using a capillary filling with heating, the ferroelectric liquid crystal composition of each of Examples 1 to 4 and Comparative Examples 1 to 3 was injected into a liquid crystal cell using a polyimide alignment film for vertical alignment, and after the injection was completed, the liquid crystal cell was sealed. As the vertically aligned liquid crystal cell, S-0088-4-N-W (Sun Trading Co., Ltd., cell gap: 4 μM) was used.

### (Method for Manufacturing Polymer Stabilized Display Element)

By the use of the ferroelectric liquid crystal composition described in each of Examples 5 to 8 and Comparative Examples 4 to 6, after a liquid crystal display element was formed in a manner similar to that of the above-described method for manufacturing a liquid crystal display element, by irradiation for 300 seconds using a metal halide lamp so as to obtain an irradiation intensity of 5 mW/cm² at the cell sample surface, a polymerizable compound of a polymer stabilized ferroelectric liquid crystal composition is polymerized, so that a polymer stabilized liquid crystal display element was obtained. UV rays were guided to the liquid crystal cell disposed on a microscope stage through a quartz glass optical fiber with an UV cut filter L-37 (manufactured by Hoya Candeo Optronics Corp.) provided therebetween.

### (Method for Confirming Layer Normal)

The angle of the layer normal was determined by measuring incidence angle dependence of retardation of the liquid crystal cell. In particular, the following equation was used which was the formula (3) in the literature by T. J. Scheffer and J Nehring (“Accurate determination of liquid-crystal tilt bias angles”, J. Appl. Phys., Vol. 48, No. 5, May 1977, p 1.783 to 1792).

$$\frac{1}{{e}^{2}} ( {a}^{2} - {b}^{2} ) sin αcosα - \frac{{a}^{2} {b}^{2}}{{c}^{3}} {( 1 - \frac{{a}^{2} {b}^{2}}{{c}^{2}} {sin}^{2} {ψ}_{x} )}^{- \frac{1}{2}} sin {ψ}_{x} + {b ( 1 - {b}^{2} {sin}^{2} {ψ}_{x} )}^{- \frac{1}{2}} sin {ψ}_{x} = 0 \qquad [ Math . 1 ]$$

(However, a=1/nₑ, a=1/n_{c}, and c²=a² cos²α+b² sin²α hold.) As shown by the above equation, when the incidence angle (ψₓ) dependence of retardation showed an extreme value (differentiation at ψₓ was 0), a value α indicating the angle of the layer normal was obtained by curve fitting. However, as for the refractive index nₑ of extraordinary rays and the refractive index n, of ordinary rays, the tilt angle was taken into consideration.

For measurement of the retardation, a liquid crystal characteristic evaluation apparatus OMS-D14RD (Chuo Precision Industrial Co., Ltd.) was used.

### (Anti-Pressure Alignment Ability)

After two polarizing plates were disposed in an crossed nicol state, and a plastic bar (cross-sectional area: approximately 0.2 mm²) having a diameter of 0.5 mm and a length of 200 mm was brought into contact with a liquid crystal cell provided between the polarizing plates, and a pressure of 3 N/cm² (300 g per 1 cm², or 6 g per 0.2 mm²) was applied thereto for 3 seconds. The pressure was released after 3 seconds, and the alignment restoration was confirmed by visual inspection. Evaluation was performed as follows. When the alignment was distorted (X), white light leaked, and when the alignment was restored ( [symbol] ), a dark field was obtained.

TABLE 1

| | | Angle of | Anti-Pressure |
|---|---|---|---|
| | | Layer | Alignment |
| | Composition | Normal | Ability |
| Example 1 | Composition 1 | 88° | [symbol] |
| Example 2 | Composition 2 | 88° | [symbol] |
| Example 3 | Composition 3 | 90° | [symbol] |
| Example 4 | Composition 4 | 90° | [symbol] |
| Example 5 | Composition 1M | 88° | [symbol] |
| Example 6 | Composition 2M | 88° | [symbol] |
| Example 7 | Composition 3M | 90° | [symbol] |
| Example 8 | Composition 4M | 90° | [symbol] |
| Comparative Example 1 | Composition 5 | 78° | X |
| Comparative Example 2 | Composition 6 | 77° | X |
| Comparative Example 3 | Composition 7 | 79° | X |
| Comparative Example 4 | Composition 5M | 78° | X |
| Comparative Example 5 | Composition 6M | 77° | X |
| Comparative Example 6 | Composition 7M | 79° | X |

The results thus obtained are shown in Table 1. According to Examples 1 to 8, after the pressure was released, the alignment was immediately restored, and a dark field was recovered. In the case of Comparative Examples 1 to 6, after the pressure was released, white light leaked. The reason for this is that although a voltage is not applied, light is scattered due to the distortion of the alignment, and a light quantity passing through the polarizing plates placed in an crossed nicol state is generated. Hence, it could be confirmed that according to the present invention, a ferroelectric liquid crystal composition having an excellent anti-pressure alignment ability was obtained.

1. A ferroelectric liquid crystal composition which contains at least one type of liquid crystal compound and which has a chiral smectic C phase, wherein a layer normal direction of the chiral smectic C phase obtained when the ferroelectric liquid crystal composition is sandwiched between substrates is 80° to 90° with respect to the substrate surface.

2. The ferroelectric liquid crystal composition according to claim 1, wherein the ferroelectric liquid crystal composition is used for application in which when the ferroelectric liquid crystal is sandwiched between the substrates, the chiral smectic C phase has a helical pitch equal to or less than a cell gap.

3. The ferroelectric liquid crystal composition according to claim 1, wherein when the ferroelectric liquid crystal is sandwiched between the substrates, the chiral smectic C phase has a helical pitch of 500 nm or less.

4. The ferroelectric liquid crystal composition according to claim 1, wherein when the ferroelectric liquid crystal is sandwiched between the substrates, the chiral smectic C phase has a helical pitch of 800 nm to 5 μm.

5. The ferroelectric liquid crystal composition according to claim 1, wherein a chiral compound included in the ferroelectric liquid crystal composition contains at least one of a compound having an asymmetric atom, a compound having axial asymmetry, and a compound having plane asymmetry, and the chiral compound has or has not a polymerizable group.

6. The ferroelectric liquid crystal composition according to claim 1, wherein the ferroelectric liquid crystal composition expresses at least one phase sequence of isotropic liquid-chiral nematic phase-smectic A phase-chiral smectic C phase, isotropic liquid-chiral nematic phase-chiral smectic C phase, isotropic liquid-blue phase-chiral nematic phase-smectic A phase-chiral smectic C phase, isotropic liquid-blue phase-chiral nematic phase-chiral smectic C phase, and isotropic liquid-chiral smectic C phase.

7. The ferroelectric liquid crystal composition according to claim 1, which contains a pitch canceller which is an additive to cancel the pitch of a chiral nematic phase or a chiral smectic C phase.

8. The ferroelectric liquid crystal composition according to claim 1, which contains a polymerizable compound.

9. The ferroelectric liquid crystal composition according to claim 1, which contains a biaxial compound.

10. The ferroelectric liquid crystal composition according to claim 1, which contains inorganic particles.

11. The ferroelectric liquid crystal composition according to claim 1, which contains organic-inorganic hybrid particles.

12. The ferroelectric liquid crystal composition according to claim 1, which contains a trapping material for ions and polar compounds.

13. The ferroelectric liquid crystal composition according to claim 1, wherein the liquid crystal compound is at least one compound selected from the group represented by the following general formula: 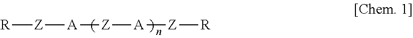
(in the formula, R each independently represent a linear or a branched alkyl group having 1 to 18 carbon atoms, a hydrogen atom, or a fluorine atom, at least one —CH₂— group of the alkyl group may be substituted by —O—, —S—, —CO—, —CO—O—, —O—CO—, —CO—S—, —S—CO—, —O—SO₂—, —SO₂—O—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN atom;
Z each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, and R^{a} of —CO—N(R)— or —N(R^{a})—CO— represents a hydrogen atom or a linear or a branched alkyl group having 1 to 4 carbon atoms;
A each independently represent a cyclic group selected from a phenylene group, a cyclohexylene group, a dioxolanediyl group, a cyclohexenylene group, a bicyclo[2,2,2]octylene group, a piperidinediyl group, a naphthalenediyl group, a decahydronaphthalenediyl group, a tetrahydronaphthalenediyl group, or an indanediyl group, at least one —CH═ group in the ring of the phenylene group, naphthalenediyl group, tetrahydronaphthalenediyl group, or indanediyl group may be substituted by a nitrogen atom, one —CH₂— group or at least two —CH₂— groups which are not adjacent to each other in the ring of the cyclohexylene group, dioxolanediyl group, cyclohexenylene group, bicyclo[2,2,2]octylene group, piperidinediyl group, decahydronaphthalenediyl group, tetrahydronaphthalenediyl group, or indanediyl group may be substituted by —O— and/or —S—, and at least one hydrogen atom of the cyclic group may be substituted by a fluorine atom, a chlorine atom, a bromine atom, a CN group, or a NO₂ group or by an alkyl group having 1 to 7 carbon atoms, an alkoxy group, an alkyl carbonyl group, or an alkoxy carbonyl group, in each of which at least one hydrogen atom may be substituted by a fluorine atom or a chlorine atom; and
n represents 1, 2, 3, 4, or 5).

14. The ferroelectric liquid crystal composition according to claim 1, wherein the liquid crystal compound is at least one compound selected from the group consisting of liquid crystal compounds represented by the following general 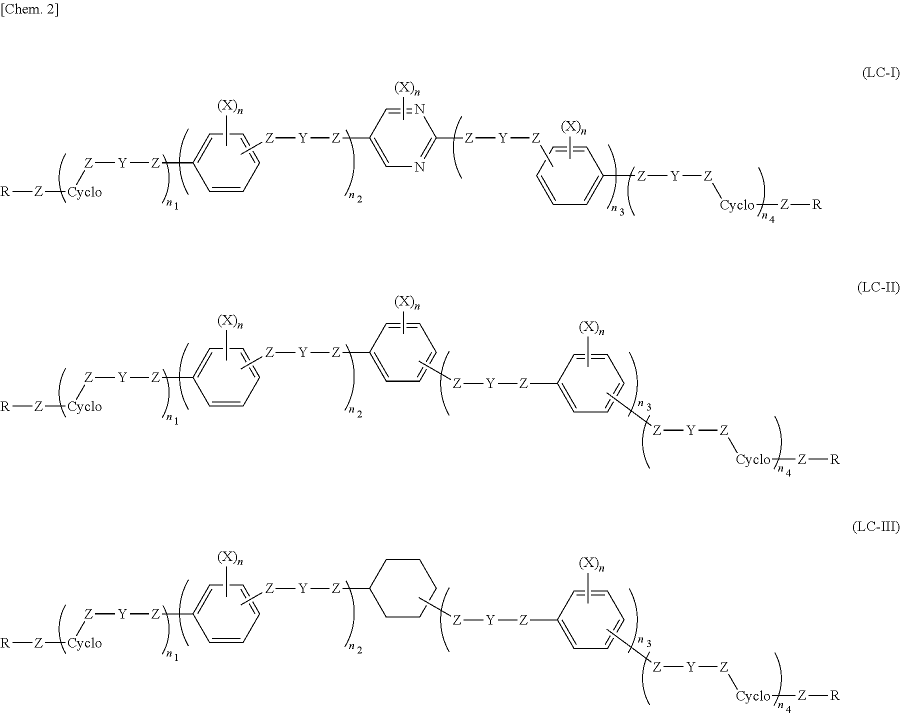
(in the formula, R each independently represent a linear or a branched alkyl group having 1 to 18 carbon atoms, a hydrogen atom, or a fluorine atom, at least one —CH₂— group of the alkyl group may be substituted by —O—, —S—, —CO—, —CO—O—, —O—CO—, —CO—S—, —S—CO—, —O—SO₂—, —SO₂—O—, —O—CO—O—, —CH═CH—, —C≡C—, a cyclopropyl group, or —Si(CH₃)₂— so that oxygen atoms or sulfur atoms are not directly bonded to each other, and at least one hydrogen atom of the alkyl group may be substituted by a fluorine atom, a chlorine atom, a bromine atom, or a CN atom;
Z each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, and R^{a} of —CO—N(R)— or —N(R^{a})—CO— represents a hydrogen atom or a linear or a branched alkyl group having 1 to 4 carbon atoms;
Y each independently represent a single bond or a linear or a branched alkylene group having 1 to 10 carbon atoms, at least one methylene group present in the alkylene group each may be independently substituted by —O—, —CO—, —COO—, or —OCO— so that oxygen atoms are not directly bonded to each other, and at least one of hydrogen atom present in the alkylene group each may be independently substituted by a halogen atom or an alkyl group having 1 to 9 carbon atoms;
X each independently represent a halogen atom, a cyano group, a methyl group, a methoxy group, —CF₃, or —OCF₃;
n represents an integer of 0 to 4;
although n₁, n₂, n₃, and n₄ each independently represent 0 or 1, n₁+n₂+n₃+n₄=1 to 4 holds; and
Cyclo each independently represent a cylcoalkane having 3 to 10 carbon atoms and may arbitrarily have a double bond).

15. The ferroelectric liquid crystal composition according to claim 1, wherein the ferroelectric liquid crystal composition contains as a compound having an asymmetric atom, an optically active compound represented by the following general 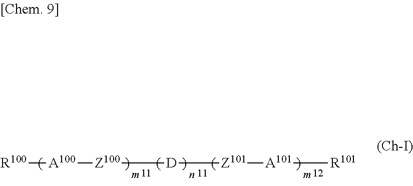
(in the formula, although R¹⁰⁰ and R¹⁰¹ each independently represent a hydrogen atom, a cyano group, NO₂, a halogen, OCN, SCN, SF₅, a chiral or an achiral alkyl group having 1 to 30 carbon atoms, or a chiral group having a polymerizable group or a cyclic structure, one CH₂ group or at least two CH₂ groups which are not adjacent to each other of the alkyl group each may be independently substituted by —O—, —S—, —NH—, —N(CH₃)—, —CO—, —COO—, —OCO—, —OCO—O—, —S—CO—, —CO—S—, —CH═CH—, —CF₂—, —CF═CH—, —CH═CF—, —CF═CF—, or —C≡C—, at least one hydrogen atom of the alkyl group each may be independently substituted by a halogen or a cyano group, and the alkyl group may have a linear, a branched, or a cyclic structure;
Z¹⁰⁰ and Z¹⁰¹ each independently represent —O—, —S—, —CO—, —COO—, —OCO—, —O—COO—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH—, or a single bond, and R^{a} of —CO—N(R^{a})— or —N(R^{a})—CO— represents a hydrogen atom or a linear or a branched alkyl group having 1 to 4 carbon atoms;
although A¹⁰⁰ and A¹⁰¹ each independently represent
(a) a trans-1,4-cyclohexylene group (one —CH₂— or at least two —CH₂— groups which are not adjacent to each other present in this group each may be independently substituted by —O— or —S),
(b) a 1,4-phenylene group (one —CH═ or at least two —CH═ groups which are not adjacent to each other present in this group may be substituted by a nitrogen atom), or
(c) a functional group selected from the group consisting of a 1,4-cyclohexenylene group, a 1,4-bicyclo[2,2,2]octylene group, indane-2,5-diyl, a naphthalene-2,6-diyl group, a decahydronaphthalene-2,6-diyl group, and a 1,2,3,4-tetrahydronaphthalene-2,6-diyl group (one —CH₂— or at least two —CH₂— groups which are not adjacent to each other present in the functional group of this group (c) each may be independently substituted by —O— or —S—, and one —CH═ or at least two —CH═ groups which are not adjacent to each other present in the functional group of this group (c) may be substituted by a nitrogen atom), all those groups may be unsubstituted or each may be substituted at least one position by a halogen, a cyano group, or NO₂ or by an alkyl having 1 to 7 carbon atoms, an alkoxy, an alkyl carbonyl, or an alkoxy carbonyl group, in each of which at least one hydrogen atom may be substituted by F or Cl;
n¹¹ represents 0 or 1, when n¹¹ represents 0, m¹2 represents 0, and m¹¹ represents 0, 1, 2, 3, 4, or 5, when n¹¹ represents 1, m¹¹ and m¹² each independently represent 0, 1, 2, 3, 4, or 5, and when n¹¹ represents 0, at least one of R¹⁰⁰ and R¹⁰¹ represent a chiral alkyl group or a chiral group having a polymerizable group or a cyclic structure; and
D is represented by formulas (D1) to (D8): 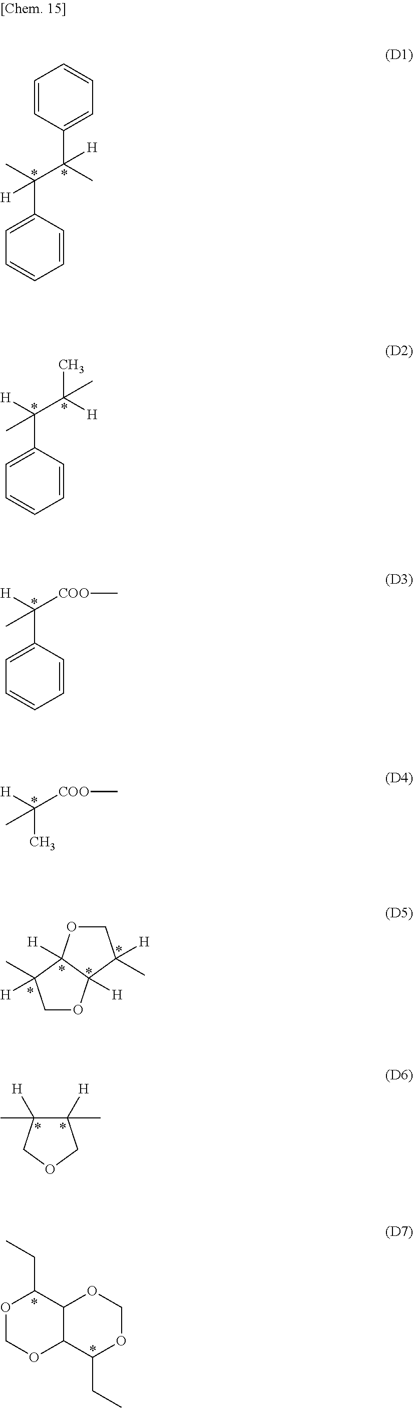 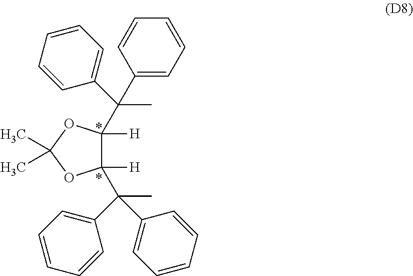 [SMILES: CC1(C)OC(C(C)(c2ccccc2)c2ccccc2)C(C(C)(c2ccccc2)c2ccccc2)O1]
(in the formulas, at least one arbitrary hydrogen atom of the benzene ring may be substituted by a halogen atom (F, Cl, Br, or I), an alkyl group having 1 to 20 carbon atoms, or an alkoxy group, a hydrogen atom of the alkyl group or the alkoxy group may be arbitrarily substituted by a fluorine atom, and a methylene group of the alkyl group or the alkoxy group may be substituted by —O—, —S—, —COO—, OCO—, CF₂—, —CF═CH—, —CH═CF—, —CF═CF—, or —C≡C— so that oxygen atoms or sulfur atoms are not directly bonded to each other)).

16. A ferroelectric liquid crystal display element comprising: a pair of pixel electrodes and a common electrode on at least one of a pair of substrates on which two polarizing plates are disposed so that polarizing surfaces thereof are orthogonal to each other; and the ferroelectric liquid crystal composition according to claim 1 provided between the pair of substrates, wherein the layer normal direction of the chiral smectic C phase of the ferroelectric liquid crystal composition is 80° to 90° with respect to the substrate surface.

17. The ferroelectric liquid crystal display element according to claim 16, wherein the pair of pixel electrodes and the common electrode are provided on each of the pair of substrates.

18. The ferroelectric liquid crystal display element according to claim 16, which has a display restoring ability against a pressure of 1 kg or less per 0.2 mm².

19. The ferroelectric liquid crystal display element according to claim 16, further comprising an alignment film which is one of a polyimide, a polyamide, a poly(amic acid), and an photoalignment layer.

20. The ferroelectric liquid crystal display element according to claim 16, which uses an LED as a light source.

21. The ferroelectric liquid crystal display element according to claim 16, which uses a retardation film.

22. The ferroelectric liquid crystal display element according to claim 16, which has a touch panel.

23. An optical element using the ferroelectric liquid crystal composition according to claim 1.

24. An optical path switching element using the ferroelectric liquid crystal composition according to claim 1.

25. A wavelength conversion element using the ferroelectric liquid crystal composition according to claim 1.

26. An energy conversion element using the ferroelectric liquid crystal composition according to claim 1.

27. An electronic material using the ferroelectric liquid crystal composition according to claim 1.
